(19) United States
(12) Patent Application Publication
(10) Pub. No.: US 2014/0244210 A1
(43) Pub. Date: Aug. 28, 2014

(54) SYSTEM AND METHOD FOR REAL TIME DETERMINATION OF 3 AXIS ORIENTATION FROM REFERENCE VECTORS WITH VECTOR MISALIGNMENT ESTIMATION

(71) Applicant: Philip Thomas Cobbin, Rimrock, AZ (US)

(72) Inventor: Philip Thomas Cobbin, Rimrock, AZ (US)

(21) Appl. No.: 13/780,739

(22) Filed: Feb. 28, 2013

(51) Int. Cl. G01B 21/16

(52) U.S. Cl. CPC G01B 21/16
USPC 702/151

(57) ABSTRACT

A computer implemented method, program and system for determining the attitude of a vehicle from two sets of local frame and body frame reference vectors utilizing solution equations for Euler sequence angles associated with rotation of a vehicle about a local frame reference vector. In particular, the method, computer program and system determines the attitude at a rate amenable for real time system use in conjunction with a wide array of sensor input sources such as star tracking devices, and provides estimators for the error in the reference vectors usable for surveillance of sensory input quality by flight management systems.

### FEDERALLY SPONSORED RESEARCH OR DEVELOPMENT

No Federally sponsored research and development is associated with this application.

### COMPUTER PROGRAM LISTING APPENDIX

A computer program listing appendix on compact disc is included as part of this application and incorporated herein by reference. Hereafter referred to as exemplar code.

### BACKGROUND OF THE INVENTION

The present invention relates in general to the determination of the attitude of an object in terms of its yaw, pitch and roll angle orientation. The invention relates in particular to the solution of Euler angles for an object to a high degree of precision using a pair of reference frame vectors and their associated body frames. The invention provides a means of detecting in a real time system errors between the reference vectors and their associated body frame vectors from sensor noise or other sources. The invention has determined orientation angles an accuracy of less than 10×⁻¹⁶ degrees associated with long double calculations on a 64 bit processor.

### BACKGROUND

Orientation of aircraft and satellites using Euler angles has been employed for some time and used in conjunction with inertial navigation systems to determine orientation as part of navigation system requirements. An overview of the use of Euler angles as part of kinematic modeling is provided in the NASA publication “A STANDARD KINEMATIC MODEL FOR FLIGHT SIMULATION AT NASA-AMES”, NASA CR-2497, 1975, incorporated herein by reference.

The Euler angle system described in the 1975 NASA paper uses the yaw-pitch-roll sequencing to translate from a reference frame to a body frame orientation. The body frame notation is the X_{b} axis passing through the nose of the aircraft, Y_{b} axis pointing toward the right wing, and the Z_{b} axis passing through the bottom of the vehicle. A local reference frame consists of a vector with components representing north: Lₙ, east: Lₑ and down: L_{d}. In the Euler angle system then the body vector relates to the local frame by the relationship:

$$[ \begin{matrix}B x \\ B y \\ B z\end{matrix} ] = [ {T}_{L 2 B} ] [ \begin{matrix}L n \\ L e \\ L e\end{matrix} ] . \qquad ( prior art eq . 1 )$$

Where T_{L2B} is the transformation matrix to convert from the local frame to the body frame. For a yaw→pitch→roll sequencing of the Euler angles the transform matrix is:

$${T}_{L 2 B} = [ \begin{matrix}cos ( θ ) cos ( ψ ) & cos ( θ ) sin ( ( ψ ) & - sin ( θ ) \\ [ sin ( φ ) sin ( θ ) cos ( ( ψ ) - cos ( φ ) sin ( ψ ) ] & [ sin ( φ ) sin ( θ ) sin ( ( ψ ) + cos ( φ ) cos ( ( ψ ) ] & sin ( φ ) cos ( θ ) \\ [ cos ( φ ) sin ( θ ) cos ( ( ψ ) + sin ( φ ) sin ( ( ψ ) ] & [ cos ( φ ) sin ( θ ) sin ( ( ψ ) - sin ( φ ) cos ( ( ψ ) ] & cos ( φ ) cos ( θ )\end{matrix} ] . \qquad ( prior art eq . 2 )$$

Where yaw=φ, pitch=θ and roll=φ.
Conversely, the body frame can be transformed back to the local frame with the transform:

$${T}_{B 2 L} = [ \begin{matrix}cos ( ψ ) cos ( θ ) & [ cos ( ψ ) sin ( θ ) sin ( ψ ) - sin ( ψ ) cos ( ψ ) ] & [ sin ( ψ ) sin ( ψ ) + cos ( ψ ) sin ( θ ) cos ( ψ ) ] \\ sin ( ψ ) cos ( θ ) & [ cos ( ψ ) cos ( ψ ) + sin ( ψ ) sin ( θ ) sin ( ψ ) ] & [ sin ( ψ ) sin ( θ ) cos ( ψ ) - cos ( ψ ) sin ( ψ ) ] \\ - sin ( θ ) & cos ( θ ) sin ( ψ ) & cos ( θ ) cos ( ψ )\end{matrix} ] . \qquad ( prior art eq . 3 )$$

So that:

$$[ \begin{matrix}L n \\ L e \\ L d\end{matrix} ] = [ {T}_{B 2 L} ] [ \begin{matrix}B x \\ B y \\ B z\end{matrix} ] . \qquad ( prior art eq . 4 )$$

Solutions to the orientation problem typically employ two or more local frame references with associated body frame sensor observations. The crux of the orientation problem is to determine the yaw-pitch-roll orientation of a vehicle given only at least two pairs of local frame and body frame reference vectors. Two algorithms typify prior art methods: Triad and Quest. These algorithms are discussed in some detail in the published papers: “Three-Axis Attitude Determination from Vector Observations”, M. D. Shuster, and S. D. Oh, J. Guidance and Control, Vol. 4, No. 1 pp 70-77, “The Quest for Better Attitudes”, M. D. Shuster, Journal of the Astronautical Sciences, Vol. 54, Nos. 3 & 4, July-December 2006, pp 657-683, “An Improvement to the QUEST Algorithm”, Yang Cheng, Malcomb D. Shuster, submitted to the Journal of the Astronautical Sciences, JAS 1290, 2008, “Robustness and Accuracy of the Quest Algorithm”, Yang Cheng, Malcomb D. Shuster AAS 07-102.

The Triad and Quest algorithms solve what is referred to in aeronautics literature as “Wahba's Problem” after Grace Wahba who proposed and solved a least squares method for attitude determination. “A Least Squares Estimate of Satellite Attitude”, SIAM Review, 8, 3, (1966) 384-386. Wahba's statement of the problem generally stated to minimize z where:

$$z = \frac{1}{2} {\sum }_{i = 1}^{n} {a}_{i} {‖ {B}_{i} - R \cdot {L}_{i} ‖}^{2} , \qquad ( prior art eq . 5 )$$

where n>=2, Bᵢ and Lᵢ are paired reference and body frame vectors and the 3×3 matrix R corresponds to the numeric values of a transform matrix T_{L2B}, and aᵢ are optional weighting terms. A detailed reference on the various methods of solving the numeric values for the transform matrix R can be found in the technical report prepared for NASA: Keat, J. “Analysis of Least-Squares Attitude Determination Routine DOAOP”, Computer Sciences Corp., Report CSC/TM-77/6034, February 1977. In general Wahba based methods solve the attitude problem by iterative methods to determine values of the transform matrix, from which then the angles can be deduced. The computational efficiency of Wahba based algorithms is attributed to the fact that the iterative methods do not require determination of sine or cosine values. Once the values of the transform matrix is determined then the Euler angles for a rotation sequence α→β→δ are:

$$\begin{matrix}α = {tan}^{- 1} ( \frac{{r}_{12}}{{r}_{11}} ) , & ( prior art eq . 6 ) \\ β = {tan}^{- 1} ( \frac{{r}_{31} sin ( α ) - {r}_{32} cos ( α )}{{r}_{22} cos ( α ) - {r}_{21} sin ( α )} ) , and & ( prior art eq . 7 ) \\ δ = {tan}^{- 1} ( \frac{{r}_{13}}{\sqrt{{r}_{11}^{2} + {r}_{12}^{2}}} ) . & ( prior art eq . 8 )\end{matrix}$$

Note that the resulting Euler angle computations are subject to numeric instability for tangents nearing |90°| degrees.

Accuracy of Wahba based methods with respect to a limited computational experiment associated with a star tracking configuration reported the Quest method to be of quite limited accuracy. In the reference “Robustness and Accuracy of The Quest Algorithm” the Quest algorithm was found to be limited to an accuracy of approximately 10 degrees in one axis and in the arc second range for the remaining two axis's. Another reference (“Attitude Determination Using Vector Observations: A Fast Optimal Matrix Algorithm” F. Landis Markey, The Journal of Astronautical Sciences Vol. 41. No. 2, April 1993 pp 261-280) computes error estimates based on cases associated with a single predefined true R matrix. The references do not report accuracy directly for a root mean square (RMS) of the error for the Euler angles. In the Marky reference the best RMS error appears to be on the order 1.22×10⁻⁶ radians for sensors with a white noise errors modeled with σ=10⁻⁶ radian.

### BRIEF SUMMARY OF THE INVENTION

The invention solves the orientation problem by a fundamentally different approach than the Wahba based methods. The invention uses a solution for the orientation of a body as a function of the Euler yaw angle when the body rotates around the reference vector. That is, as the yaw angle changes, the pitch and roll angles change such that when the local frame is transformed to the body frame, or vice-verse, neither the local or body frame vectors change. As an analogy, if an aircraft is facing wings level, with no pitch, pointing toward magnetic north, and then that aircraft is rotated about the local magnetic dip angle, then as the aircraft is rotated around the dip vector the pitch and roll angle will change with the yaw angle, but the state of a 3 axis magnetometer in the aircraft will remain stationary throughout the rotation. The invention takes the solution for the rotation about two separate reference vectors to solve for the yaw angle whereby both vector's rotation equations produce the same pitch and roll angles. Constants employed as terms of the rotation equations are derived from local and body frame unit vector components.

### BRIEF DESCRIPTION OF THE DRAWINGS

The foregoing features and other features of the disclosure will now be described with respect to the drawings of the various objects of the disclosure. The figures are intended to illustrate but not limit the disclosure of the invention.

FIG. 1 depicts an aircraft in two orientations with identical local to body frame relations.

FIG. 2 depicts the variation of the pitch/roll angle relationship associated with rotations of the vehicle depicted in FIG. 1 for various dip angles.

FIG. 3 depicts the pitch/roll angle relationship of a pair of reference vectors and the attendant solution points for the orientation of a vehicle.

FIG. 4 depicts the pitch and roll angles plotted as a function of the yaw angle for the pair of reference vectors associated with the vehicle orientation associated with FIG. 3.

FIG. 5 depicts the root mean square (RMS) error of the vehicle orientation associated with FIG. 3 with two zero error points depicted.

FIG. 6 depicts the roll and pitch angle error components which make up the RMS error depicted in FIG. 5.

FIG. 7 depicts C++ language typedef structures for variables used to capture reference frame, coefficient and auxiliary coefficient values.

FIG. 8 depicts C++ language typedef structures used for various angle and error values and to capture solution attributes.

FIG. 9 depicts the collection of class variables in a C++ class which computes a solution for vehicle attitude.

FIG. 10a is C++ listing of function declarations for methods used to make various angle conversions and transformations.

FIG. 10b is a C++ code listing of function declarations for a main executive method to solve vehicle orientation and three solution related methods.

FIG. 10c is a C++ code listing of function declarations for methods used to compute various forms of roll and pitch angles.

FIG. 10d is a C++ code listing of function declarations for methods used to develop coefficients and yaw limit lists.

FIG. 10e is a C++ code listing of function declarations for methods used to determine error crossings and error minimums.

FIG. 10f is a C++ code listing of function declarations for methods used to determine the state of various types of errors.

FIG. 11 depicts a C/C++ code listing for a method for computing the geometric differences between two angles.

FIG. 12 depicts a C/C++ code listing for a method to convert a set of Euler angles with absolute pitch values greater than a right angle to a set of Euler angles with absolute pitch value less than or equal to a right angle.

FIG. 13a depicts a C++ code listing for a method to compute roll and pitch angles for a given yaw angle with error checking associated with a specific root of a reference vector.

FIG. 13b depicts a C++ code listing for a method to compute roll and pitch angles for a given yaw angle for all reference vectors roots.

FIG. 14 depicts a C++ code listing for a method to compute various angles and errors for a given yaw angle.

FIG. 15a depicts a C++ code listing for a method to compute a vector_error associated with Euler sequence angles.

FIG. 15b depicts a C++ code listing for a method to compute the set of errors classified as RMS_ERROR, ROLL_ERROR, PITCH_ERROR and differences between the roll and pitch derivatives for a pair of reference vectors.

FIG. 15c depicts a C++ code listing for a method to compute an absolute_error estimator.

FIG. 15d depicts a C++ code listing for a method to compute an indicated_error estimator.

FIG. 16 depicts a C++ code listing for an executive method to analyze and return a solution for vehicle attitude.

FIG. 17 depicts a C++ code listing for a method to push a set of coefficients used to determine vehicle attitude.

FIG. 18 depicts a C++ code listing for a method to generate a composite yaw list from yaw limitations lists for two reference vectors.

FIG. 19 depicts a C++ code listing for a method to create a yaw limit list for a reference vector.

FIG. 20 depicts a C++ code listing for a method to determine whether there exists a yaw overlap between yaw limit list elements and to determine the range of the overlap.

FIG. 21 depicts a C++ code listing for a method to set a pitch flag for a yaw list element based on whether or not a set of equation coefficients are associated with absolute pitch values greater than a right angle.

FIG. 22a depicts a C++ a first code fragment listing for a solution method applicable when a composite yaw limit lists exists for a pair of reference vectors.

FIG. 22b depicts a C++ a second code fragment listing for a solution method applicable when a composite yaw limit lists exists for a pair of reference vectors.

FIG. 23 depicts a C++ code listing for a point solution method applicable when a composite yaw limit list does not exist for a pair of reference vectors.

FIG. 24a depicts a partial C++ code listing of a method to find the yaw angle at a roll or pitch error crossing point, where the complete method includes three phases embedded within a while loop.

FIG. 24b depicts a partial C++ code listing of a first phase for the method for finding a crossing point.

FIG. 24c depicts a partial C++ code listing of a second phase of a method for finding a crossing point.

FIG. 24d depicts a partial C++ code listing of a third phase of a method for finding a crossing point.

FIG. 25 depicts a C++ code listing for a method to find a yaw angle that minimizes an error.

FIG. 26 is a plot of results from a simulation of average error versus white noise error in percent of an arc second error scale.

FIG. 27 is a plot of results from a simulation of average error versus white noise error in percent of an arc minute error scale.

FIG. 28 is a plot of results from a simulation of average error versus white noise error in percent of an arc degree error scale.

FIG. 29a is a histogram of the estimated root mean square error for simulated local and body reference frames with no noise error (truth).

FIG. 29b is a histogram of the true root mean square error for simulated local and body reference frames with no noise errors (truth).

FIG. 29c is a histogram of the indicated_error root mean square error for simulated local and body reference frames with no noise error (truth).

FIG. 29d is a histogram of the difference between the true root mean square error and the indicated_error estimator for simulated local and body reference frames with no noise error (truth).

FIG. 30a is a histogram of the estimated root mean square error for simulated local and body reference frames with nominally ½ second of noise error.

FIG. 30b is a histogram of the true root mean square error for simulated local and body reference frames with nominally ½ second of noise error.

FIG. 30c is a histogram of the indicated_error root mean square error for simulated local and body reference frames with nominally ½ second of noise error.

FIG. 30d is a histogram of the difference between the true root mean square error and the indicated_error estimator for simulated local and body reference frames with nominally ½ arc second of noise error.

FIG. 31a is a histogram of the estimated root mean square error for simulated local and body reference frames with nominally ½ minute of noise error.

FIG. 31b is a histogram of the true root mean square error for simulated local and body reference frames with nominally ½ minute of noise error.

FIG. 31c is a histogram of the indicated_error root mean square error for simulated local and body reference frames with nominally ½ minute of noise error.

FIG. 31d is a histogram of the difference between the true root mean square error and the indicated_error estimator for simulated local and body reference frames with nominally ½ minute of noise error.

FIG. 32a is a histogram of the estimated root mean square error for simulated local and body reference frames with nominally ¼ degree of noise error.

FIG. 32b is a histogram of the true root mean square error for simulated local and body reference frames with nominally ¼ degree of noise error.

FIG. 32c is a histogram of the indicated_error root mean square error for simulated local and body reference frames with nominally ¼ degree of noise error.

FIG. 32d is a histogram of the difference between the true root mean square error and the indicated_error estimator for simulated local and body reference frames with nominally ¼ degree of noise error.

FIG. 33 is a block diagram of a computer architecture for a real time computing system employing attitude determination software.

### DETAILED DESCRIPTION OF THE INVENTION

In the following detailed description of the invention all angles are Euler angles, and are associated with the Euler sequencing yaw→pitch→roll. A pair of reference frame vectors called the local frame have corresponding body frame vectors. The invention uses two reference local frame vectors and their associated reference body frame vectors to determine the orientation Euler angles. As used below the subscript i will refer to the ith vector.

It being understood by those skilled in the art that the local frame for any object is dependent on the location of the vehicle with respect to some coordinate system. Not as a limitation, but as a means or illustration, a typical local reference frame is with respect to the orthogonal axis system north, east and down. To determine the local reference frame in such a system the location of the vehicle is required to set the local frame. For example, knowing the vehicle location on the earth the local frame can be determined from observable sources such as the local magnetic dip angle, stellar objects, satellites, radio transmission facilities and so forth. Some sources are accurate as a reference source than others, star tracking devices being inherently more accurate than radio direction finding, but only if the target stellar object is view able. In any event it is understood by those skilled in the art that various instrumentation means including global positioning devices (GPS) can be use to estimate the local frame for a vehicle. Likewise the body reference frame can be estimated by instrumentation on the vehicle, or inferred from the vehicles movements. On the body frame side of the reference system the vehicle itself can supply body frame measurements, again using observable source. For the body frame star tracking devices can supply the information to set a unit vector representing the body frame. Local and body frame references can also be determined by prior art methods through sensor fusion such as observing the motion of the vehicle with respect to the local frame to estimate the vehicle acceleration with respect to the local frame, and that reference used in conjunction with a reference body frame set using data from on board acceleration sensors. There are errors inherent in collection of data from sensor sources to fix the local and model frame estimate for a vehicle. One object of the present invention is to determine the orientation of the vehicle, and another is to provide an estimator of the expected error in the determined orientation in the form of one or more root mean square estimators of the angular errors associated with a set of Euler angles typically used to define vehicle orientation. The invention solves the determination of the orientation and associated error estimates from a supplied pair of unit reference vectors, two for the local frame and a corresponding pair of vectors for the body frame. The local and body frame reference vectors are determinable by a large body of prior art methods, the instant invention solves the orientation using the reference vectors in unit vector form with a side effect of the solution being the determination of estimators for the root mean square error among the Euler angles.

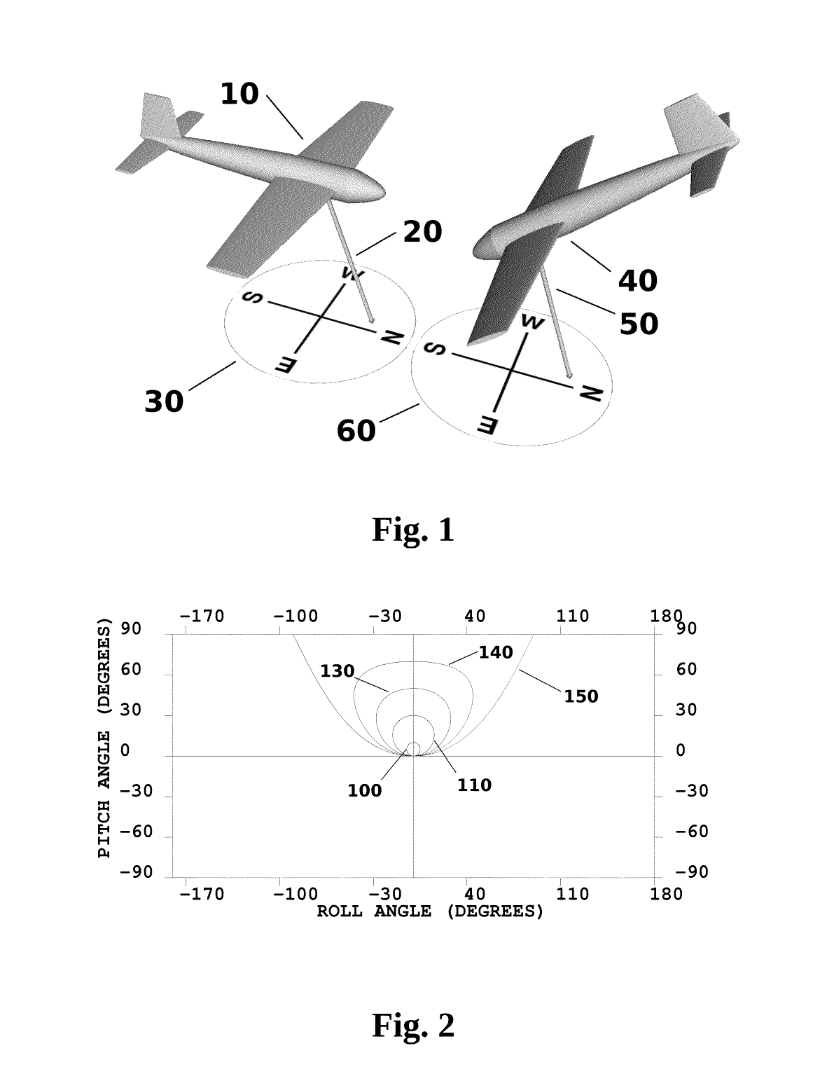

FIG. 1b depicts an airplane 10 situated over a vector 20 and a compass-rose 30. Vector 20 is pointing downward at an angle from the horizontal plane and otherwise points northward. If we call the downward angle of the vector D, then the angle D can be thought of as like a magnetic dip angle typically measured in aircraft using a 3 axis magnetometer. When airplane 10 is rotated about vector 20 until the aircraft points south, then aircraft 10 will be in the orientation depicted by aircraft 40 in the figure, vector 50 being in the same orientation with compass rose 60. Compass rose 60 having the same orientation as compass rose 10. Now then, from the perspective of both airplane 10 and 40, if the vectors represent the magnetic dip at the location of the compass rose, then both aircraft's 3 axis magnetometer readings would be identical. That is, both aircraft would have identical body frame measurements. Further, as this example is contrived the local reference frame will be equal to the body frame.

Thus, when the vehicle rotates about the reference vector for the local frame, there exist an infinite set of yaw→pitch→roll Euler angles whereby application of either (prior art eq. 1) or (prior art eq. 4) produces the identical body frame as the given body frame. In a general case, if we have a reference vector (the local frame) there is a corresponding body frame vector from the perspective of the vehicle oriented by a set of yaw, pitch and roll Euler angles. With a system of equations for the roll and pitch as a function of yaw we have the infinite set of angles where the transform by either (prior art eq. 1) or (prior art eq. 4) produces the identical body frame and local frame vectors as the original given vectors.

If we take two non-parallel reference vectors we have a pair of local and body frame vectors. Then for the non-parallel reference vectors there is a corresponding pair of solution equations for roll and pitch as a function of the yaw angle, from which we then determine a yaw angle for the two sets of equations whereby the roll and pitch angles respectively are the same. In practice, there are sensor errors in the measurements used to determine the local and body frame vectors, such that a solution to the orientation problem requires determining a root mean square error to estimate the best fitting combination for the yaw, pitch, and roll angles.

The invention solves the Euler angles which will produce the given body frame from a given local frame. The solution first solves for the roll angle as a function of the yaw angle, then the yaw and roll angle solutions are used to compute the pitch angle. The solution for the equations begin as follows.

### Equation Coefficients

Starting with a local frame we have the unit vector components Ln, Le, and Ld, representing the North, East, and Downward components of the reference frame. Using two reference vectors we have the vector components Lnᵢ, Leᵢ and Ldᵢ for vector i, where i=0.1. For the reference frames their associated effective dip angle D is

Dᵢ=arcsin(Ldᵢ). (eq. 1)

For each reference frame there is also a yaw coefficient which will center the roll angle range. For the reference frames the yaw centering coefficient yaw0 is:

$$yaw {0}_{i} = arctan ( \frac{L {e}_{i}}{L {n}_{i}} ) . \qquad ( eq . 2 )$$

Note that yaw0 is undefined for Lnᵢ=0 directly by applying (eq. 2). However, if Leᵢ>0 then

$$yaw {0}_{i} = \frac{π}{2}$$

radians. Similarly if Leᵢ<0 then

$$yaw {0}_{i} = - \frac{π}{2} .$$

In the case where Le_i=0 then yaw0ᵢ=∞, (undefined).

In the case where yaw0ᵢ is undefined the main methods of the instant invention are not applicable. In such case vector i points straight down in the local frame and thus is a perfect vector to determine the roll and pitch angles of the vehicle directly. The other reference vector then is applicable to determine the yaw angle given the thus determined roll and pitch angles, provided that yaw0 exists for the other reference vector.

For the body frames, there is a second centering coefficient. This one establishes the central roll angle. This coefficient, which I term roll0 is defined exclusively from the body frame where

$$roll {0}_{i} = arcsin [ \sqrt{\frac{B {y}_{i}^{2}}{B {y}_{i}^{2} + B {z}_{i}^{2}}} ] . \qquad ( eq . 3 )$$

Both the local and body frames are required to determine a centralizing characteristic of the pitch angle which I term pitch0. For the ith local/body frame pitch0ᵢ is defined as

$$pitch {0}_{i} = arccos ( L {d}_{i} ) - arctan [ \frac{L {n}_{i}}{cos ( roll {0}_{i} ) B {z}_{i} - sin ( roll {0}_{i} ) B {y}_{i}} ] . \qquad ( eq . 4 )$$

The first term in equation (eq. 4) being that of the complement of the effective dip angle given in (eq. 1). The roll angle is a scaled sine of the yaw angle. The coefficient which regulates the range of the roll angle with respect to the yaw angle I term as the coefficient K srᵢ. This coefficient is determined from the effective dip angle Dᵢ and the pitch0ᵢ coefficients by the equation:

$$K {sr}_{i} = \frac{cos ( {D}_{i} )}{sin ( {D}_{i} + pitch {0}_{i} )} . \qquad ( eq . 5 )$$

### Roll and Pitch Equations

From the coefficients Dᵢ, yaw0ᵢ, roll0ᵢ, pitch0ᵢ and K srᵢ, the roll angle as a function of the yaw angle is:

rollᵢ=arcsin [K srᵢ·sin(yaw−yaw0ᵢ)]+roll0ᵢ (eq. 6).

Note that when |K srᵢ|>1 then the yaw angle will be limited.
The pitch angle is a function of the yaw and roll angle from (eq. 6) where:

$${pitch}_{i} = arcsin [ \frac{\begin{matrix}( cos ( yaw ) L {n}_{i} + sin ( yaw ) L {e}_{i} ) \\ ( sin ( roll ) B {y}_{i} + cos ( roll ) B {z}_{i} ) - B {x}_{i} L {d}_{i}\end{matrix}}{{B}_{x}^{2} + {( sin ( roll ) B {y}_{i} + cos ( roll ) B {z}_{i} )}^{2}} ] . \qquad ( eq . 7 )$$

Solving a paired set of equations for two sets of local and body frame vectors utilizes the derivatives of the roll and pitch with respect to the yaw angle. This enables using the Newton-Raphson method to determine the yaw angle(s) at which point the difference between roll and pitch angle among the two vectors goes to zero. The derivative of the roll angle with respect to yaw from (eq. 10) is:

$$\frac{d {roll}_{i}}{d yaw} = \frac{1}{\sqrt{1 - {sin ( {roll}_{i} )}^{2}}} , \qquad ( eq . 8 )$$

and for the pitch angle, the derivative is

$$\frac{d {pitch}_{i}}{d yaw} = \frac{1}{\sqrt{1 - {sin ( {pitch}_{i} )}^{2}}} . \qquad ( eq . 9 )$$

Thus, for any two non-parallel vectors i=0, and i=1, there are two pairs of rollᵢ and pitchᵢequations, for which there exists some yaw angle where the roll₀=roll₁ and pitch₀=pitch₁. To find the yaw angle the invention requires that one first evaluate ambiguities in the coefficients. In practice, the invention finds a yaw angle that minimizes the root mean square difference between the roll and pitch angles to estimate the orientation from sensor observations which have inherent measurement errors. Due to measurement errors, the yaw angle at which point the roll error goes to zero may be different than the nearest pitch crossing, thus necessitating the search for an overall minimum root mean square error.

### Coefficient Ambiguities

The roll0ᵢ value computed by (eq. 2) is ambiguous due to the presence of the square root term, and the fact that the sine of the supplement of an angle is equal to the sine of the angle. The ambiguity then extends to the determination of pitch0ᵢ and K srᵢ coefficients. The number of coefficient possibilities is initially screened down to four combination by analyzing the error characteristics of the results produced by applying (eq. 6) for the roll angle and (eq. 7) for the pitch angle

### Error Estimators

There are four general error estimation methods used to solve the orientation. The four methods I term: vector_error, error, indicated_error, and absolute_error. The first method I term as being a vector_error. For a given set of yaw-pitch-roll angles a temporary body frame is created from the local reference frame by applying the transform (prior art eq. 2). The vector_error then has three components composed of the differences between the three axis of the temporary body frame and the reference body frame respectively with the scalar of the vector error being an absolute value that is the square root of the sum of the squares of the three vector_error axis components:

$$vector\_error = \sqrt{{vector\_error [ X ]}^{2} + {vector\_error [ Y ]}^{2} + {vector\_error [ Z ]}^{2}} \qquad ( eq . 10 )$$

The vector_error defines the numeric error between the reference body frame and the results obtained by applying the set of coefficients to (eq. 6) and (eq. 7) to estimate a roll and pitch angle for a given yaw angle. The vector_error method is used to screen out erroneous coefficient combinations which will be subsequently discussed in further detail in section “RESOLVING COEFFICIENT AMBIGUITIES”.

The second error method is a class of general error estimators which estimate the error associated with the difference between roll and pitch angles associated with the two reference vector sets. With the first set being V0, associated with a local reference frame vector, and reference body frame vector. The second set being V1, associated with the second reference vector pairings of a local and body frame reference unit vectors. For a given yaw angle the respective rollᵢ and pitchᵢ values can be computed using (eq. 6) and (eq. 7). The difference between the angle of roll₀ and roll₁ estimates the roll error, and the difference between pitch₀ and pitch₁ estimates the pitch error. Both the roll and the pitch error are signed. An estimator of the overall error is the absolute error that is the root mean square (RMS) error of roll and pitch errors. Thus, under the general classification of “error” the methods used to solve the orientation require computation of the pitch_error, roll_error, and rms_error. In practice all three error types are computed together by the function “error” in the exemplar code. The requested error is returned and all three errors are stored on a vector in addition to the differences between the derivatives for the roll and pitch angle.

An indicated_error uses an absolute error estimate to compute a relatively neutral estimator of true rms error of the orientation solution for attitudes associated with a |pitch|<=60 degrees. These two error estimates are not required to solve the attitude, but instead give estimators as to the accuracy of the results obtained and are of secondary use in tracking the degradation of sensor signal errors. For a solution to the attitude the indicated error is computed from the absolute value of the vector_error by axis for each vector. Adding the absolute_error values in pairs associated with the X, Y, and Z body axis. The indicated error then being two times the square root of the sum of the squares for the paired vector errors.

The absolute_error method employed to compute the indicated error first takes the absolute value of the vector_error argument:

error=|vector_error|,

then computes a value e:

$$e = \frac{error}{2} \sqrt{4 - {error}^{2}} , \qquad ( eq . 11 )$$

then if e<=\sqrt{2} the absolute_error=|sin(e)|, otherwise the absolute_error is:

absolute_error=supplement(|sin(e)|),

where supplement( ) refers to the geometric supplementary angle.

### Resolving Coefficient Ambiguities

For a given local and body frame associated with a reference vector V compute a first roll0 estimator roll0ₐ applying (eq. 3) to obtain what is the principle estimate, then a second roll0_{b}, where the second is the supplementary angle of rollₐ. Then there are two potential pitch0 estimators, where pitch0ₐ is computed by applying (eq. 4) using the principle roll0 estimator roll0ₐ and pitch0_{b} is computed by applying (eq. 4) using the supplementary estimator roll0_{b}.

With the four roll0 and pitch0, a and b variants computed there are two errors to consider. The first, is errorₐ, associated with the vector_error computed for vector i at the yaw=yaw0ᵢ, pitch=pitch0ₐ, and roll=roll0ₐ angles. The second, error_{b}, is computed for yaw=yaw0ᵢ, pitch=pitch0_{b}, and roll=roll0_{b} angles. Then if errorₐ<error_{b} the a set of roll0 and pitch0 coefficients form what I term a root_set and are “pushed” onto a list of root_set(s). If, on the other hand (errorₐ>=error_{b}) then the b set of coefficients are pushed onto the list.

When set a is pushed onto the root_set list, a second set is likewise pushed onto the list where the roll0_{b} coefficient is redefined as the supplementary angle of −roll0ₐ, and pitch0_{b} is recomputed using the revised roll0_{b} value applying (eq. 4). When set b is pushed onto the root_set list, a second set is likewise pushed onto the list where the roll0ₐ coefficient is redefined as the negative of the value obtained by applying (eq. 3) and pitch0ₐ is recomputed using the revised roll0ₐ value applying (eq. 4)

The end results is that for each vector i, there are two pairs of roll0 and pitch0 coefficients, each of which can be applied to compute yaw-pitch-roll sequences. I will use the notation for a root as roll0[i][j] to represent the ith root for the ith vector. Likewise for the pitch0 coefficient pitch0[i][j] and for the K sr coefficient: K sr[i][ ]. There are 2 jth roots for each vector i. Thus to solve for a yaw-pitch-roll combination for a given pair of local and corresponding body frame vectors there are up to four combinations of roots to evaluate. I term the member of a possible combinations a “root set”. Thus there are up to four “root set” combinations to test to find a solution to the orientation problem. When a root_set is “pushed”, that is, when a roll0 and pitch0 coefficient combination is determined, the corresponding K sr coefficient can be computed applying (eq. 5).

### Yaw Angle Limitations

The methods associated with the instant invention uses a pair of auxiliary coefficients to define the yaw limit range(s) over which to evaluate equations to solve the orientation. The first auxiliary coefficient is yaw_low[ ] and the second is yaw_high[ ]. Both are vectors with a dimension of 2. Thus yaw_low[0] refers to the lower yaw limit for vector i=0, and so forth.

When |K sr[i][j=0]|<=1, then the yaw range applicable to the root_set is unbounded. As a practical matter the methods of the instant invention set the range to ±π as the yaw angle is determined on this interval. That is, in the unbounded case:

yaw_low[i]=−π, (eq. 12)

yaw_high[i]=π. (eq. 13)

When |K sr[i][j=0]|>1 the yaw angle applicable to (eq. 3) and (eq. 4) for the roll and pitch angle is limited with

$$\begin{matrix}yaw\_low [ i ] = yaw {0}_{i} - arcsin [ \frac{1}{\vert {K}_{s} r [ i ] [ j = 0 ] \vert} ] , and & ( eq . 14 ) \\ yaw\_high [ i ] = yaw {0}_{i} + arcsin [ \frac{1}{\vert {K}_{s} r [ i ] [ j = 0 ] \vert} ] . & ( eq . 15 )\end{matrix}$$

In practice the yaw_low and yaw_high coefficients are used to define a yaw range list by vector. For the unlimited case, the list has the single element with the ±π values. Otherwise the list is developed with paired values which will numerically compute values for roll and pitch. The lists must be tested for out of bound errors on the trigonometric function calls and actual yaw ranges are adjusted by multiples of the machine precision EPSILON precision constant. The EPSILON constant is typically provided in a header file to comply with the Posix programming standard typically employed by C and C++ computer language compilers such as the gnu family of compilers.

When the root_set values are determined, including the attendant yaw limit lists, there remains one step prior to determination of the orientation. That step is the determination of a set of composite yaw limits for the two reference vectors. If both reference vectors are unbounded, then the composite limits for both vectors are ±π radians. If only one of the vectors is limited in yaw, the composite limits are the limits associated with the limited vector. If both vectors are limited then a composite list is developed containing all of the overlapping yaw ranges that exist over the ±π range.

Sensors can typically be classified has having white noise errors of either a 2 axis or 3 axis nature. In the case of a three axis magnetometer for instance there is typically a white noise error associated each of the 3 axis. Other types of sensors such as radio location, and star tracking sensors can have at least two error axis, one associated with yaw and the other associated with the devices measurement via an azimuth angle. As the white noise becomes very large σ>1° (degrees), then the error embedded in the body frame can be such that observed vectors will result in there being no yaw overlap range between the vectors. That is, the composite yaw list will not exist. When the composite yaw limit lists exists, the invention solves the orientation by one method, and another is employed to solve for the case where the composite limit list does not exist.

### Background on Solver Design Issues

For the vehicle depicted in FIG. 1, we can solve the rotation equations with roll and pitch functions of the yaw angle. For initial exposition purposes the example has a simple unit vector local frame with no east component, a north component that is the cosine of the dip angle and the down component equal to sine of the dip angle. The body frame components correspond as follows, the x component is equal to the north component, the y axis component is equal to the east component, and the z component is equal to the local frame's down component. Thus contrived, one set of coefficients for yaw0, roll0, and pitch0 are zero an

$$Ksr = \frac{1}{tan ( D )} .$$

D=0, K sr goes to infinity, that is there is no yaw rotation about the vector. For D=90 degrees, then K sr converges to zero, meaning the roll and pitch angles are fixed for any yaw rotation angle, that is, we have what I term a perfect orientation vector to determine the roll and pitch angle. FIG. 2 depicts the results for dip angles of −85, −75, −65, −55, and −45 respectively. For all cases yaw is unlimited. As the yaw angle goes through the interval −π to +π the figure is the result of plotting the roll and pitch angles. As the effective dip angles approaches −90 degrees, the roll/pitch plot becomes more circular, and for a dip angle of −90 degrees would converge upon a point. The point of convergence being that dip angle where the vector becomes a perfect determinant of the roll and pitch angles, but is undefined as to yaw. In the figure the −85 effective dip angle plot is at 100, and is circular in nature. The result for −75 degrees at 110 is circular, but with the beginning of a pronounced stretching of roll and pitch axis at the upper left and right areas of the curve. This stretching is greater for the −65 case at 120 and greater still at 130, the case for −55 degrees. Finally, for the effective dip angle of −55 degrees at 140 the curve opens up to pitch terminus of 90 degrees.

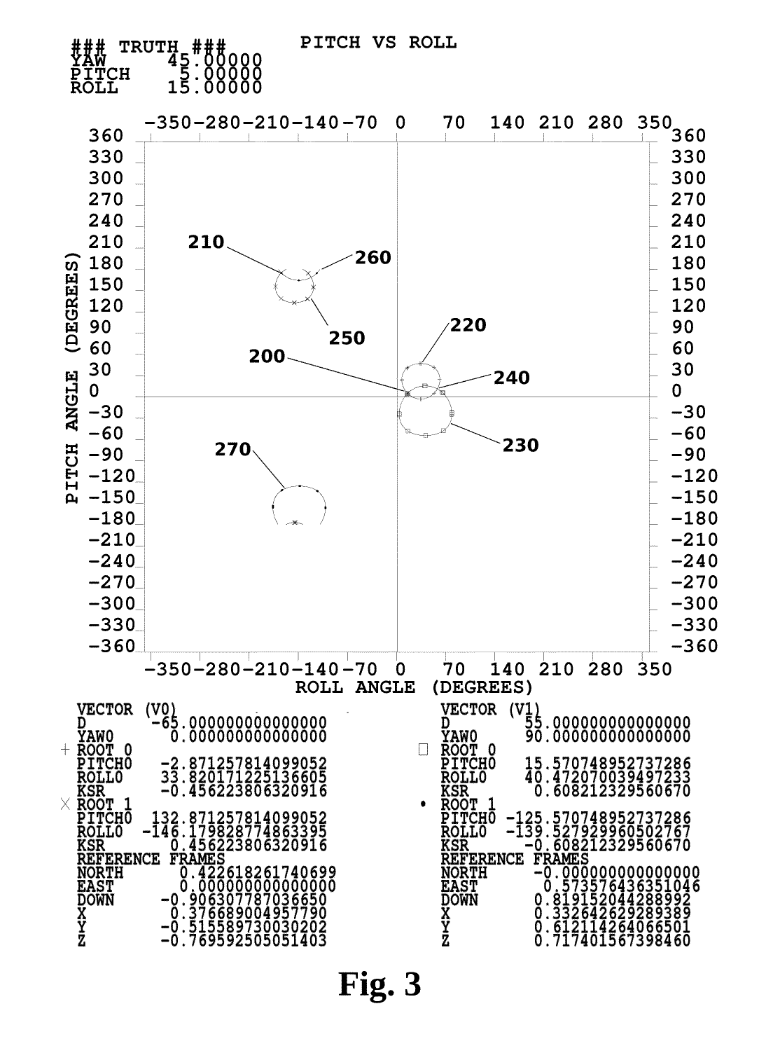

FIG. 3 depicts the pitch and roll angles where the vehicle has the orientation yaw=45 degrees, pitch=5 degrees and roll=15 degrees. The dip angles are −65 degrees and +55 degrees respectively. The local frame vector components are included at the legend at the bottom of the figure. There are essentially four curves in the plot. The solution pitch and roll angle is located at point 200 in the figure at one of the two points where curved line 220 cuts curved line 230. The curves cut at 240, however, the yaw angles associated with the roll/pitch points are different for each of the roots. Here the curved line 220 is associated with root 0 of vector 0, and curve 230 is associated with root 0 of vector 1. The curved line 260 is a continuation of the curved line at 270 and the section of the line shown at 250 cuts the curved line 250 at the point 210. The point 260 is at the roll angle −165 degrees, and pitch angle of 175 degrees. This point is associated with what I term a high pitched solution in that the absolute value of the pitch is greater than a right angle. High pitched solutions are convertible to a low pitch solution by adding or subtracting π to the roll and yaw angle and taking the supplement of the pitch angle.

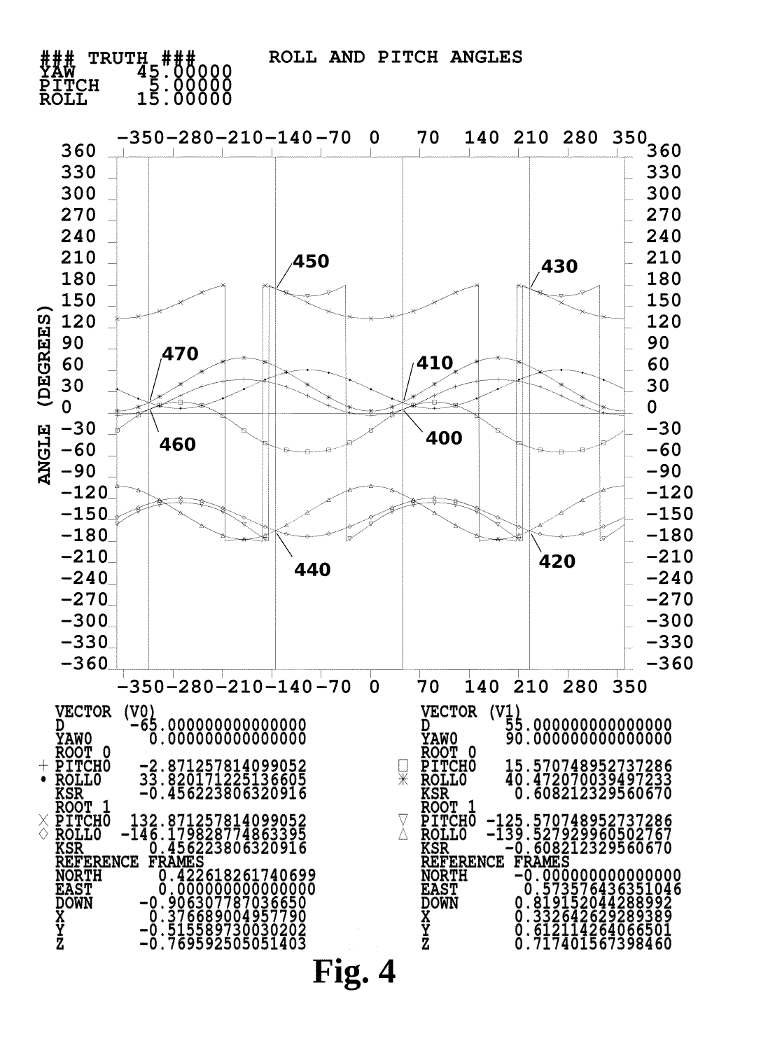

FIG. 4 illustrates the pitch and roll angles as a function of the yaw angle for the example depicted in FIG. 3. From FIG. 4 the points 400 and 410 are at the yaw angle of 45 degrees at the points where there is equality of the roll and pitch angles associated with roots of the two reference vectors. The pitch point is 400 and that where the roll angles coincide is at 410. A second solution is at −325 degrees at the pitch angle of 5 degrees and roll angle of 15 degrees located at points 470 for the roll angle and 460 for the pitch angle. There are two high pitch solutions at the yaw angles −135, and 225 degrees. These have a roll angle of −165 degrees at points 420 and 440, and a pitch angle solution of 175 degrees at points 430 and 450. In designing a solver to determine the attitude of a vehicle only one 2π interval for the yaw angle is required and the exemplar solver code solves for the yaw angle on the interval −π to +π, which can be readily converted to any desired interval.

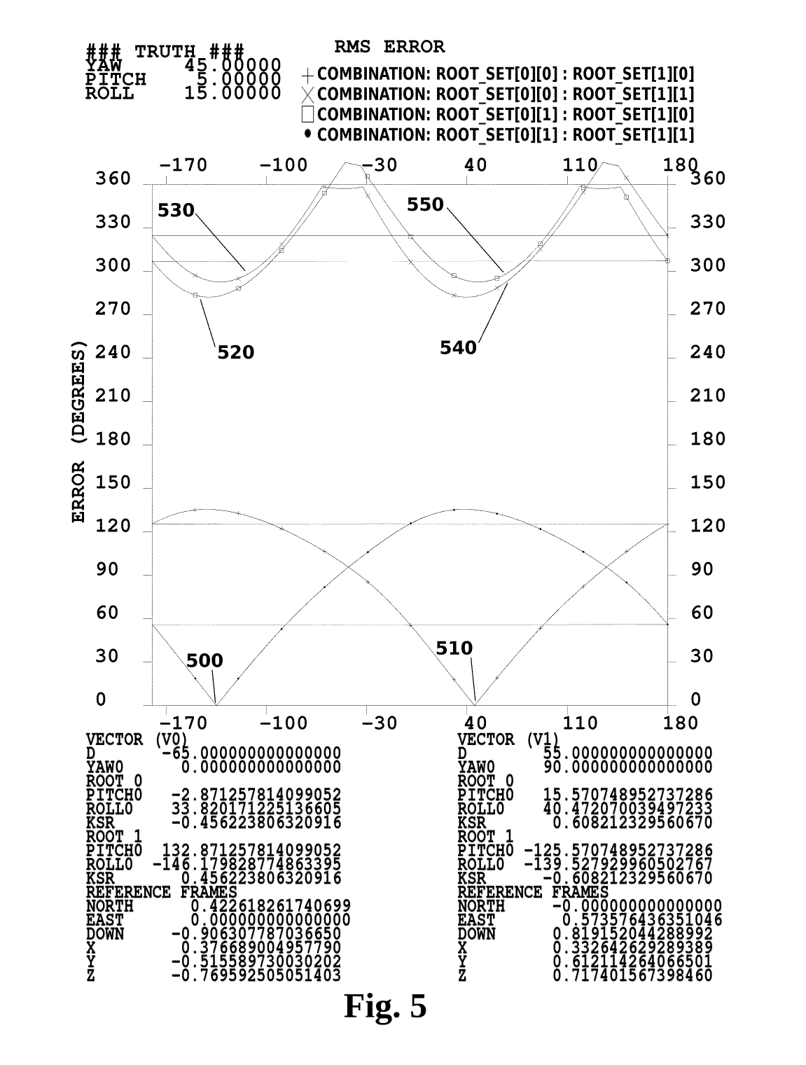

FIG. 5 illustrates the root mean square error (RMS Error) for the four root combinations. From the figure the RMS Error for two of the root combinations goes to zero at the yaw angle of 45 at 500 and −135 degrees at 510 respectively. The other two roots have minimum points at 520 and 540, but do not converge on zero. In general when a composite yaw limit list exists, then two of the four root combinations defined using the earlier described methods to resolve the coefficient ambiguities will be associated with the minimum RMS Error, and two combinations will not. Of the two combinations associated with the minimum RMS error, one will be a high pitch solution and the other will produce a low pitch solution in a form of angles familiar to aircraft attitude orientation such as used in flight deck displays. The two combinations which do not converge on zero illustrate a problem with a conventional usage of the so called Newton-Raphson methods. For example, using Newton-Raphson methods one would expect to stop at the local minimum 530, yet the overall minimum value is at 550. For sensor values with very small errors, such as having a white nose error with σ=1 arcs second, the RMS error cannot be expected to converge on zero. Also the components of the RMS error are the relative roll and pitch errors. These errors likewise are not always well behaved in the Newton-Raphson sense.

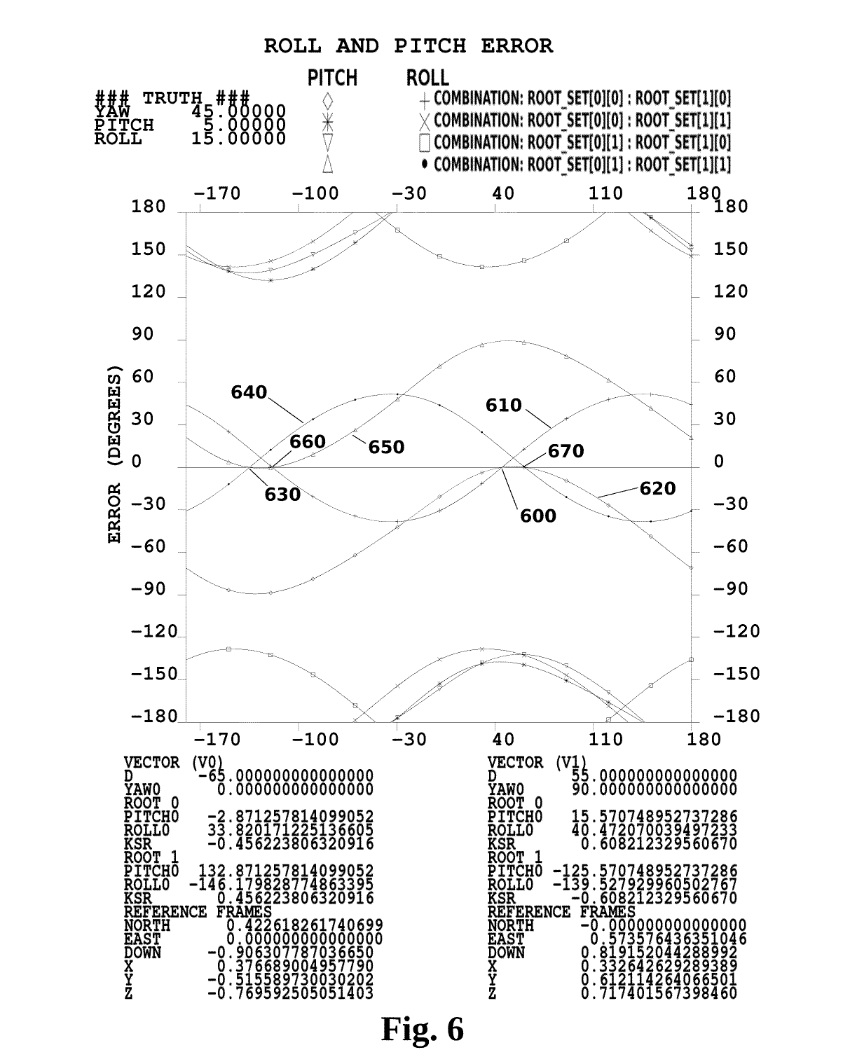

FIG. 6 illustrates the individual roll and pitch error components of the four root_set combinations. The low pitch solution is at 600 and a high pitch solution is at 660. For the low pitch solution the roll angle converges to zero for curve 610, at point 600, and the pitch angle converges to zero for curve 620 at point 600. The high pitch roll solution is associated with curve 640 and the pitch solution curve is at 650. Both the low and high pitch solution points have points near them where the pitch error again converges to zero. To the right of solution point 600 is point 670 where the pitch error again goes to zero, but the roll error is increasing. Likewise the point 660 near the high pitch solution point 630 exhibits the same characteristics. When evaluating orientations across the full spectrum of potential unit reference vectors by Monte Carlo simulation sampling examples can be encountered where both roll and pitch errors cross the zero error boundary, one or the other only cross the boundary, and cases where neither the roll error or pitch error cross the zero error boundary. Lack of error crossings can be due to the inherent error in the unit vectors associated with noise errors, or, the errors converge on zero, but do not cross the zero boundary.

### Overview of the Solver Method

The exemplar code is a general solver for the orientation of a vehicle. It is classifiable as a single pass solver in the sense that one pass through the composite yaw limit list is made to evaluate the four root_set combinations. The single pass method in a general view divides a yaw range into discrete segments akin to a picket fence, and evaluates the equations to detect roll and or pitch error crossing points. When crossings are detected the crossing point is determined using a modified Newton-Raphson method. At the end of the single pass the minimum crossing RMS error point is estimated as is the minimum RMS Error from the picket search points. The solution is at the overall minimum determined at the end of the single pass method.

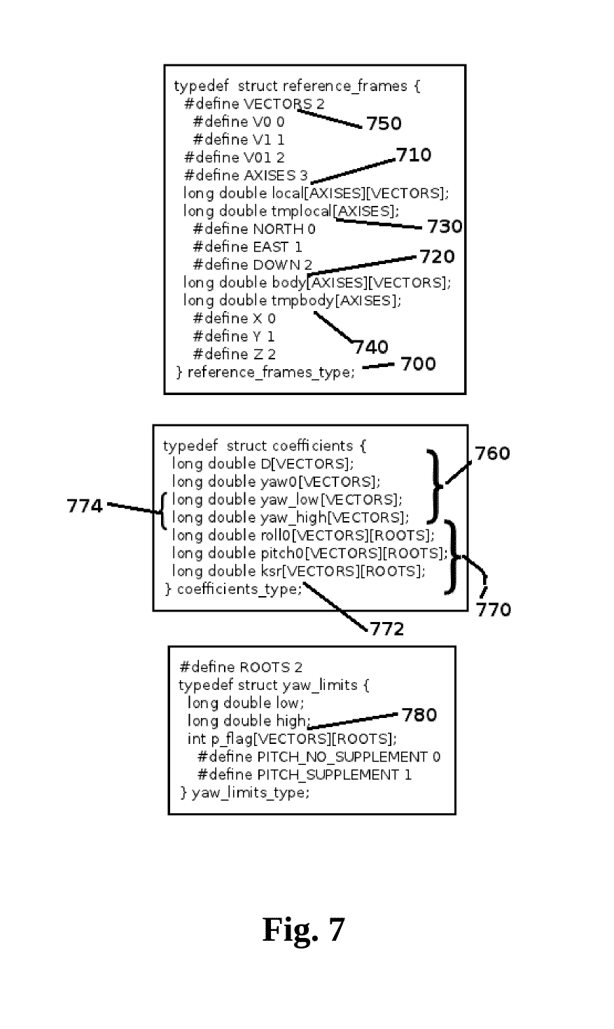

FIG. 7 depicts C/C++ language typedef programming structures used to capture the reference frame, and coefficients used to solve the orientation. These typedef structures are written for a C++ implementation of the method, but other equivalent means of scoping variables can be readily employed in any of the other common programming languages used for real-time computations.

The reference_frame_type typedef at 700 stores the local frame 710 and body frame 720 values for the two unit vectors from which the attitude is to be determined. A pair of temporary frames, one for the local frame at 730, and one for the body frame 740 are used for intermediate computations so as to not overwrite the original references. As part of the typedef code the define statements such as the one at 750 are used as a programming convenience for reference and self-documentation. For example local[NORTH][V0] references the north component of the first reference vectors, and body[Z][V1] references the z axis component of the second reference vector.

The coefficients_type is used to store the coefficients. The D, yaw0 and auxiliary yaw_low, yaw_high coefficients are maintained as vectors 760. The roll0, pitch0, and K sr 772 coefficients are stored as matrices 770 to collect all root combinations.

The yaw_limits_type is used to store specific yaw limit list elements such as the composite limit list for the yaw angle. This structure includes a p_flag[ ][ ] matrix 780 to store for each combination flag value. A flag value is set to PITCH_SUPPLEMENT indicating that the actual pitch for a vector is the supplement of the pitch computed using (eq. 7). Thus the flag, when set to PITCH_SUPPLEMENT will determine when a pitch for a vector's root will be a high pitch value.

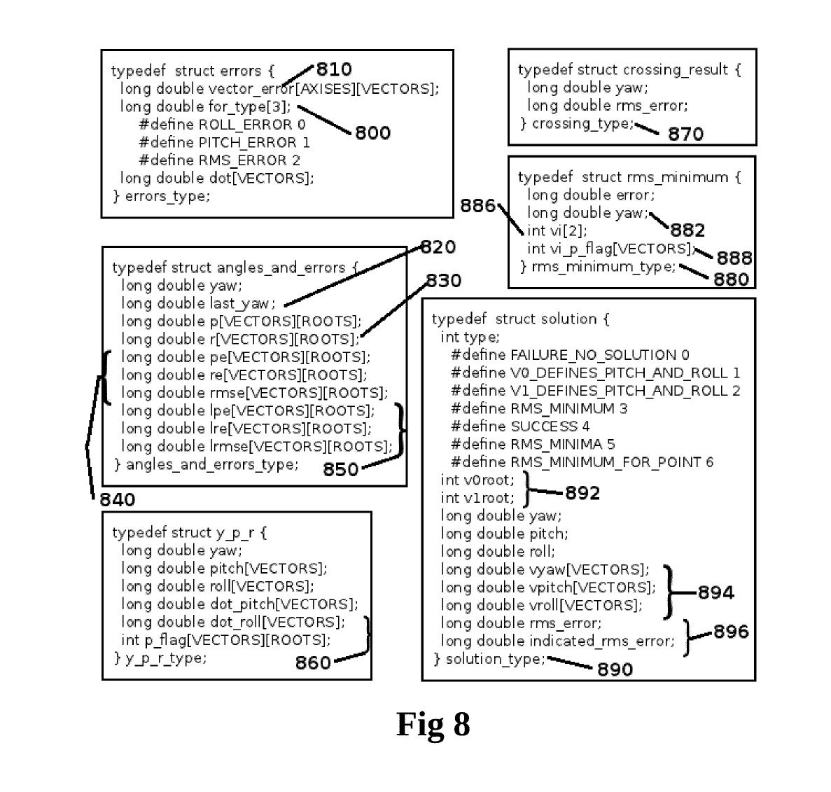

In FIG. 8 a C++ typedef statement is used to capture various errors, intermediate results, and the orientation solution. The errors_type is used to store error computations for the types: ROLL_ERROR, PITCH_ERROR, and RMS_ERROR. These errors are stored in a for_type[ ] vector 800 with the individual vector_error[ ][ ] components 810 stored by axis for each vector. As a side effect, the derivatives for the rate of change for roll and pitch errors are stored in the dot[ ] vector.

The solver, being a one pass solver, evaluations all four combinations of coefficients. The angles_and_errors_type is used to collect the values of the pitch 820 and roll 830 angles by vector for each of the vector's two roots. Also the errors associated with the pitch and roll combinations are stored 840. Last state values 850 are maintained as they are used to detect the existence of crossing points for roll and pitch errors.

The y_p_r_type 862 is used by a find_yaw_at_crossing method, which finds the yaw crossing points for the roll and pitch errors. The derivative state by vector for the rate of change of the roll and pitch error rates are stored with variables 860. They are required for use in application of the Newton-Raphson method to find the zero error crossing point(s).

The crossing_type 870 is used to capture the yaw 872 angle and the rms_error 874 for a roll or pitch error crossing the zero boundary.

The rms_minimum_type 880 is used to capture yaw angle 882, error (RMS), root indexes 886 and pitch flags 888. The structure is used to track the minimum error from the picket scan of the yaw range across all four root combinations as well as the minimum error state from the isolation of the roll and pitch error crossings. The minimum is for a specific set of root indexes and the pitch flags record the flag state for which the minimum occurs.

The solution_type 890 is used to gather the results for an orientation solution. In addition to the obvious requirement to estimate the three Euler angles, a return code in the form of the type 892 variable is used to document the solution method or error state. If the solver returns with the defined type value V0_DEFINES_PITCH_AND_ROLL, then the unit vector for vector V0 can be used to determine the roll and pitch angle directly using prior art methods with a non-parallel V1 vector used to determine the yaw angle, again using prior art methods. The indexes for the roots of the two vectors are stored in 892. The vyaw[ ], vpitch[ ] and vroll[ ] vectors 894 store the solution values for the Euler angles by vector. The error results returned 896 are the overall rms_error and the indicated_rms_error. The indicated_rms_error is returned to provide an indicator as to the error performance of the sensors used to measure attitude from the vehicle's perspective. Shifts over time in the mean performance of this error estimator provide an indicator of a change in the error characteristics of the sensors.

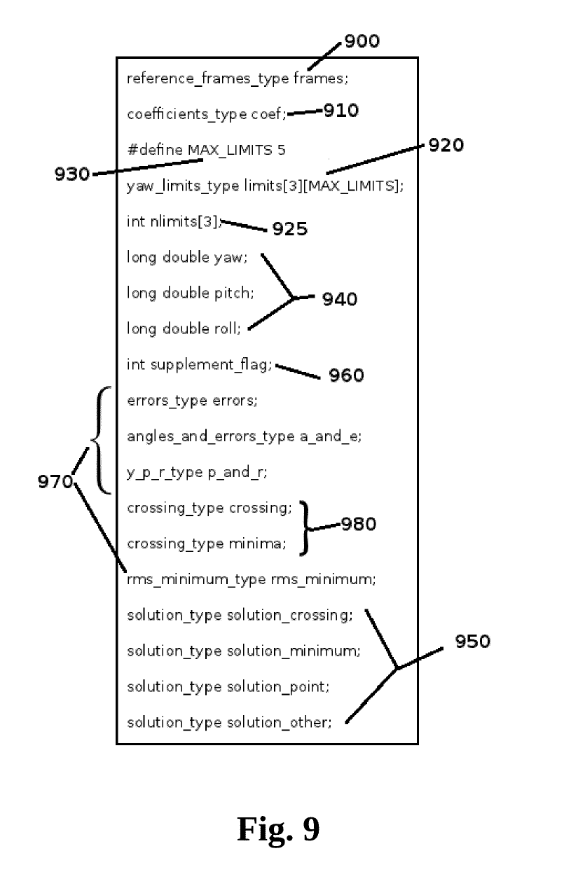

FIG. 9 illustrates the main variables in the exemplar C++ class used to solve the orientation. The frames variable 900 collectively stores the reference frame type values with the coef variable 910 storing the main coefficients with the matrix limits 920 used to store up to three yaw limits lists with nlimits[ ] vector 925 used to maintain the size of the individual lists. A static storage approach is used for the exemplar code. A dynamic memory allocation approach can likewise be employed. The maximum list size 930 has been found to cover all cases sampling the full range of yaw, pitch, roll orientation angles randomly sampling across the universe of D and yaw0 combinations with error sampling white noise levels ranging from zero to 1 arc degree standard deviation, for both two axis and three axis error models. The yaw, pitch, and roll variables 940 are used for intermediate calculations, with the four separate solution_type variables 950 used to gather and return solution results. The supplement_flag 960 is used to pass supplemental pitch information as the method set_roll_and_pitch to be described in further detail sets the flag but the method itself returns a Boolean true/false value as the methods primary purpose is to test yaw limits list elements to insure the sine function calls remain withing range. The variable types error_type, angles_and_errors_type, y_p_r_type and rms_minimum_type are associated with single, non-vector variables 970. The crossing_type structures 980 are used to record crossing and minimum encountered values during the initial scanning of potential attitude solutions.

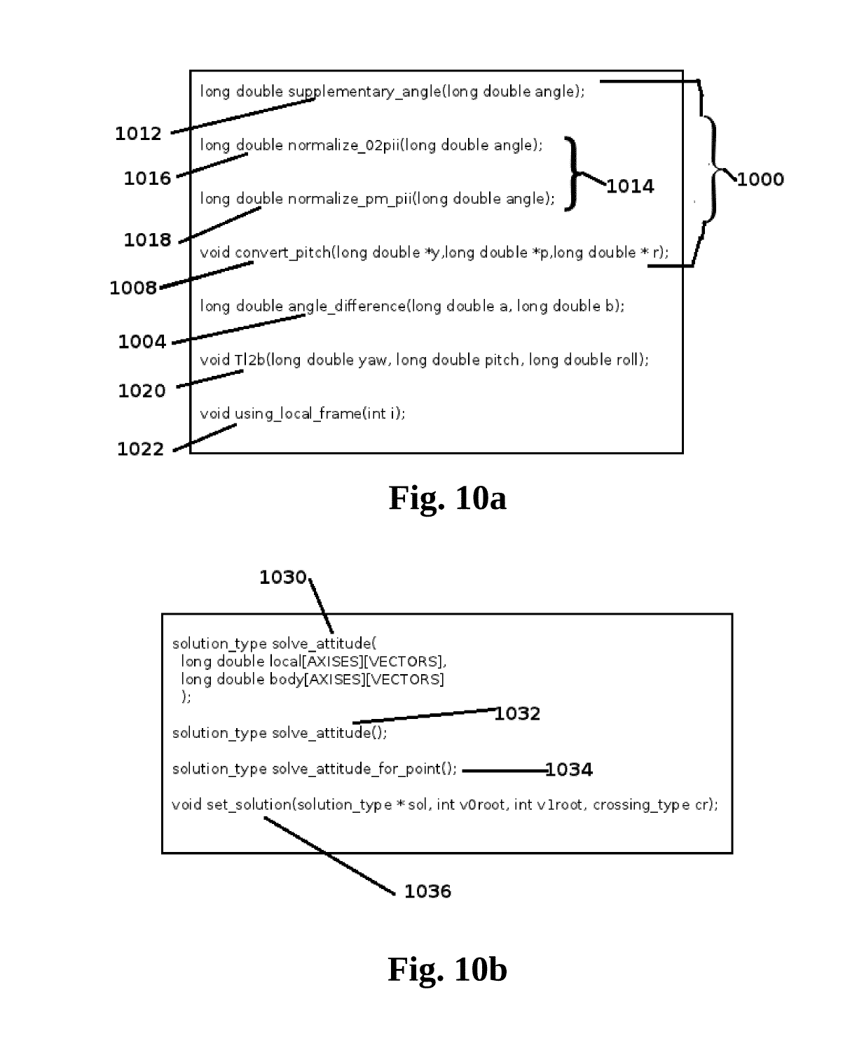

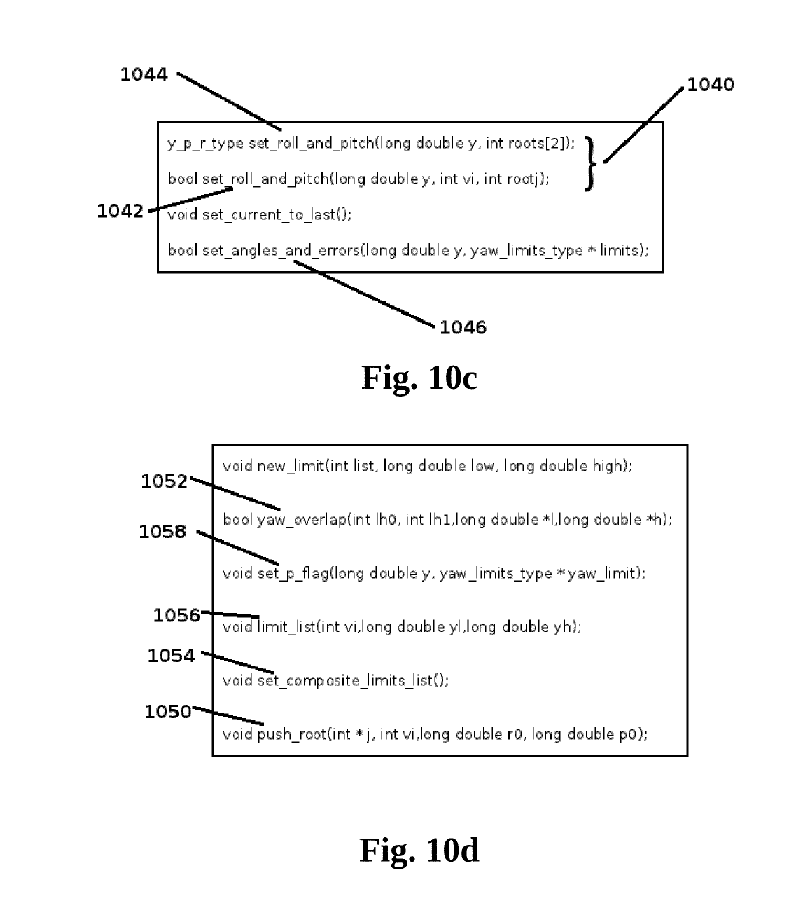

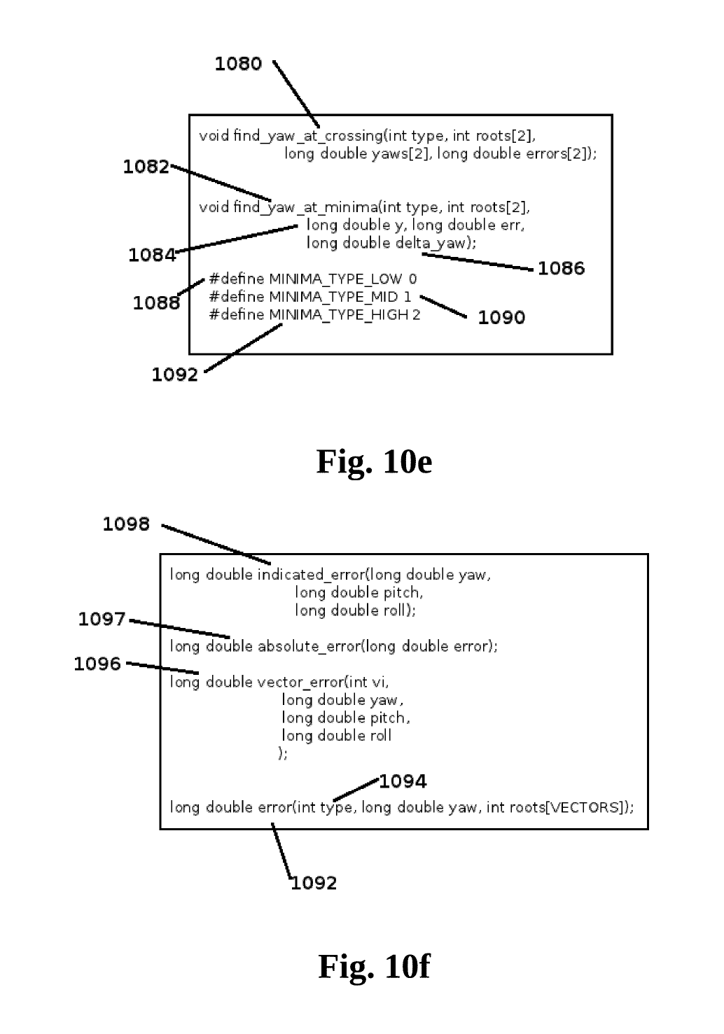

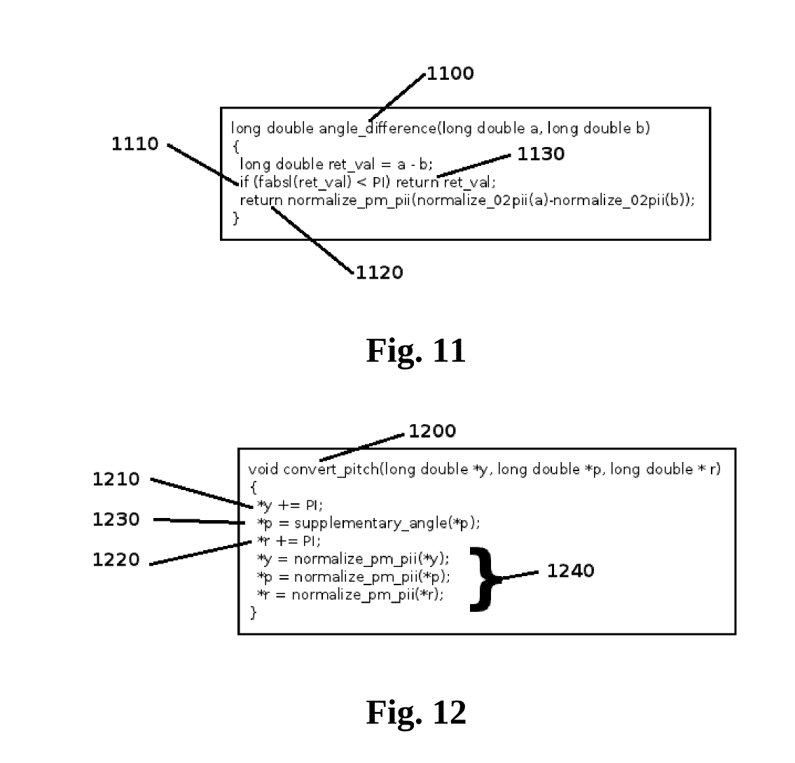

FIG. 10a is a listing of the function declarations for exemplar methods associated with a C++ attitude class. A first group of methods 1000 primarily are used to perform angle conversions. The angle_difference 1004 and convert_pitch 1008 methods are reproduced in FIG. 11 and FIG. 12 respectively and will be described in further detail. The supplementary_angle method 1012 returns the geometry supplement for an angle. That is if the argument is ½ a right angle the return value is 3/2 of a right angle. Two normalizing methods 1014 are to keep the computed angles for yaw, pitch or roll on the interval zero to 2π radians 1016 and on the interval −π to π radians 1018.

A local to body frame transform method 1020 is used in conjunction with method 1022 to make intermediate calculations with method 1022 setting the value of temporary local frame (730 in FIG. 7) using values stored for the reference local frame 710. The transform method 1020 performs the local to body frame transform calculations per (prior art eq. 2) resulting in storing the result on the temporary body frame variable 740.

FIG. 10b is a listing of function declarations for exemplar methods that are in the nature of solution executive methods. A first solve_attitude method 1030 is the solution executive method which is called to solve a vehicle's attitude with two matrices passed in the call containing the axis elements of the local and body frame references for two pairs of vectors, with the method returning a solution_type structure for the result. The executive returns both complete solutions, and the partial solution information for cases where one of the vectors is a perfect vector for determining the roll and pitch angle by prior art means those skilled in the art can readily compute with the perfect vector, with the yaw angle obtained readily then from a second non-parallel vector.

As described earlier the composite list for a pair of reference vectors may or may not exist. When the called method of 1030 determines such a list exits the subsidiary method 1032 is used to solve this, the predominate case. When the list does not exist the secondary method 1034 is used to solve what I term a point solution. That is the end yaw points for each vector's limit list are used to estimate a minimum error point. When the composite limit list does not exist, then the reference vectors are significantly in error. Such cases typically occur when the noise level on sensor data is very large with a standard deviation of the noise level at a high level such as 1 degree. It is to be noted the instant invention described handles cases with noise levels ranging from zero on upward to extreme values. Both method 1032 and 1034 use method 1036 to complete the returned solution_type structure.

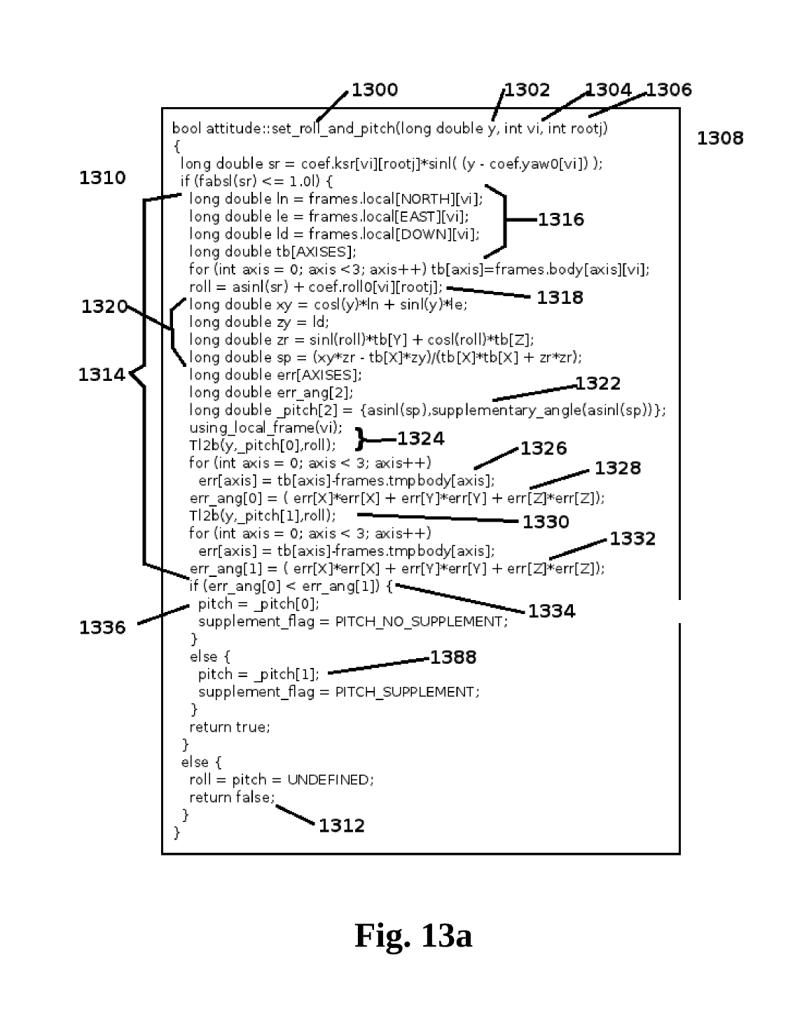

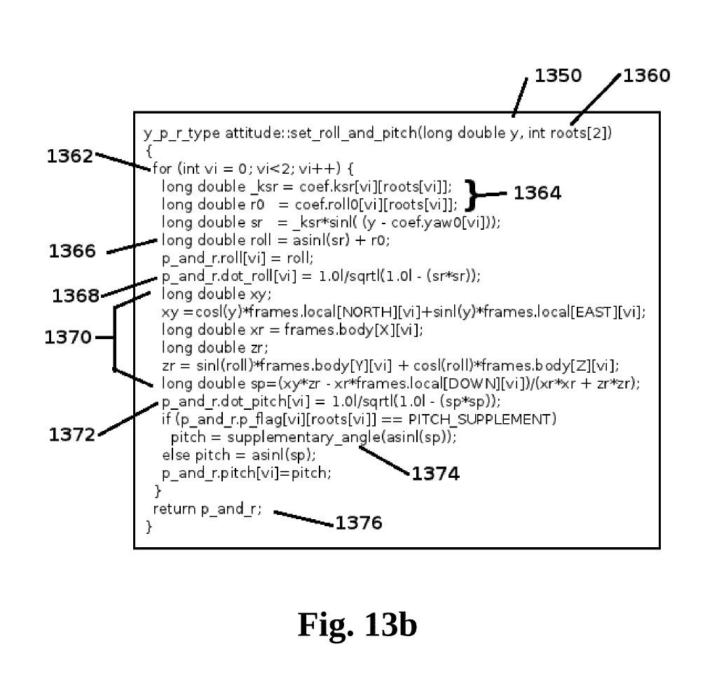

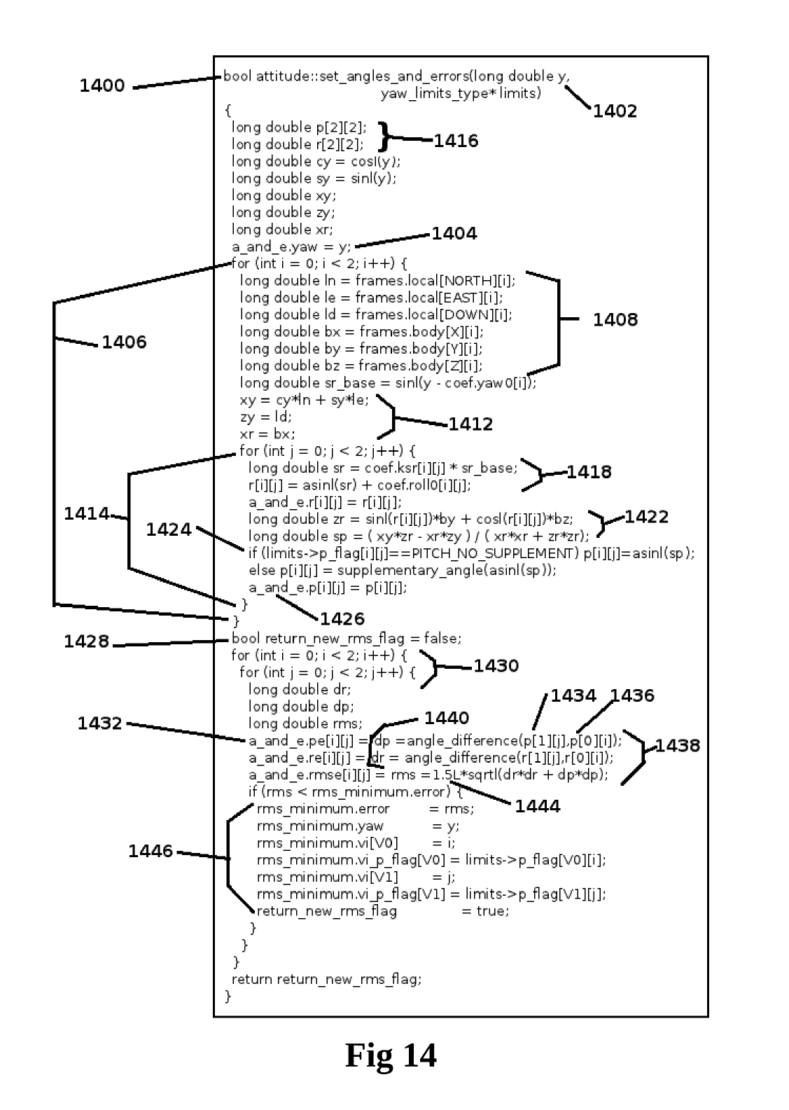

FIG. 10c is a listing of function declarations for exemplar methods to compute various types of roll and pitch angles and errors. The C++ language includes a concept of overloading of variable designations and is the polymorphic property of the language. The set_roll_and_pitch methods 1040 utilize this property of the C++ language, but it is understood in the programming art that one can easily implement the methods from the exemplar code by using different names for each method. The methods 1040 are each used for different purposes while performing the function of computing a roll and pitch angles associated with a vector. The method 1042 is primarily used during the coefficient determination phase of solving the attitude to numerically isolate the yaw limits so that calls to the method 1044 do not require error checking to insure calls to library functions for the sine do not have an out of bound error where the absolute value of the sine argument exceeds one. With long double computations the EPSILON value is an indicator of the decimal precision limits of real values, here about 18 digits, (for a 64-bit AMD based computers running Linux™ utilizing the gcc family of compilers). Round off numerical errors are known to be a problem with the yaw limit calculations. Method 1046 is described in detail with respect to FIG. 14 and the vectored version of method 1044 is described in further detail with respect to the code illustration in FIG. 13b.

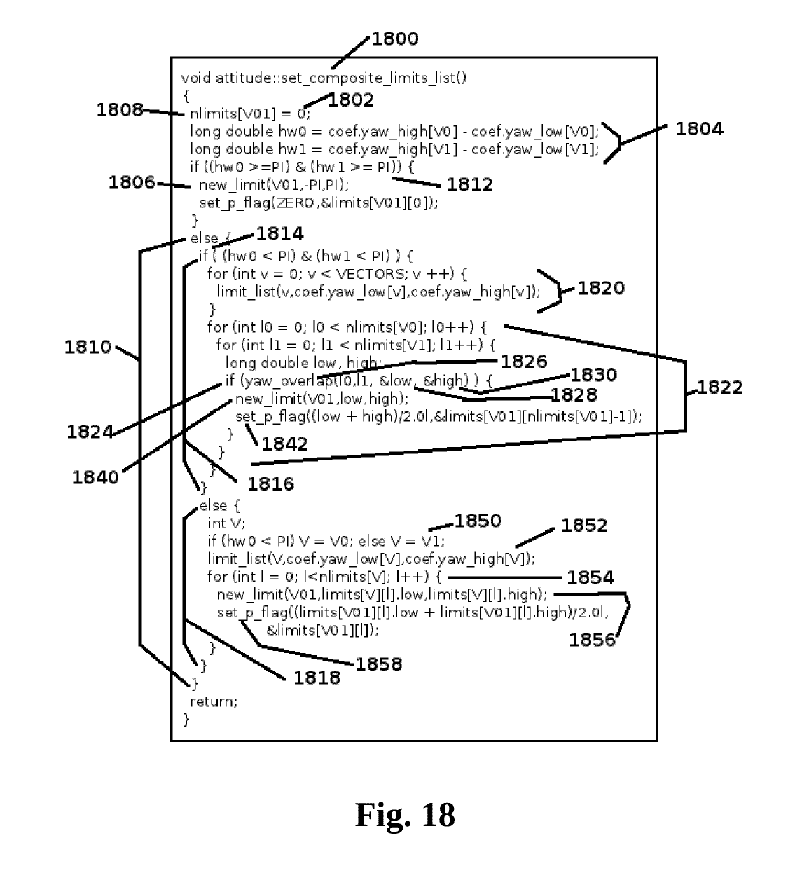

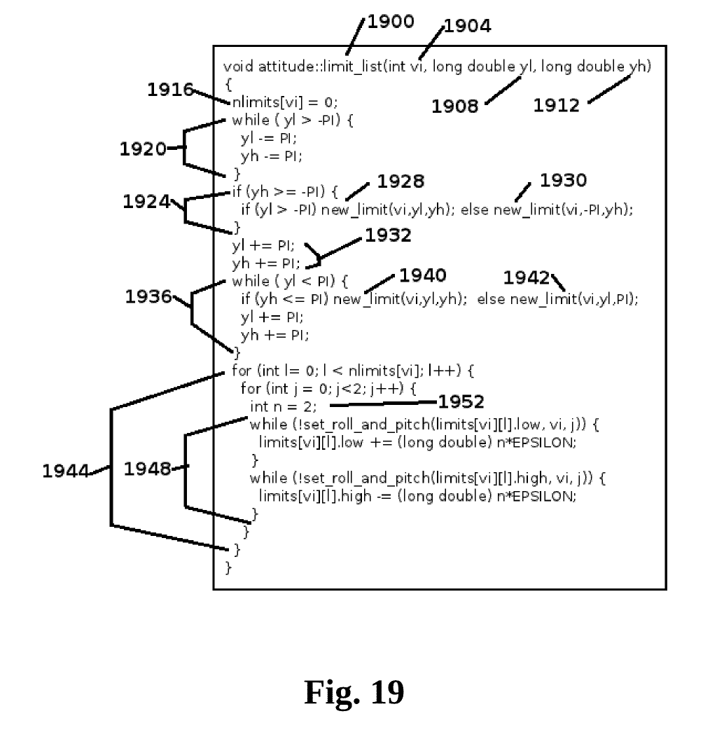

FIG. 10d is a listing of function declarations for exemplar methods to create yaw limit lists and finalize coefficient settings. The method push_root 1050 stores root combination information, computes the K sr coefficient (772 FIG. 7) and the auxiliary yaw limit coefficients 774 used to develop yaw limit lists. The yaw_overlap method 1052 takes a low and high yaw limit range for a first vector, and a low and high yaw limit range for a second vector and determines the existence of an overlap region, and setting the low and high limit range for that overlap. The method 1054 uses limit_list method 1056 in conjunction with method 1052 to develop the composite limit list, if one exits. An exemplar of the limit_list method is depicted in FIG. 19, and for the composite_limits_list is depicted in FIG. 18. The composite limits method 1054 sets the pitch supplement flag state using method 1058 for each of the yaw_limits_type structure 780 for the composite limits list to enable computation of pitch angles without having to make excessive Boolean logic tests. 1070 are employed directly or indirectly by method 1074 which is used to test for the existence of a composite yaw limit list and development of the composite list.

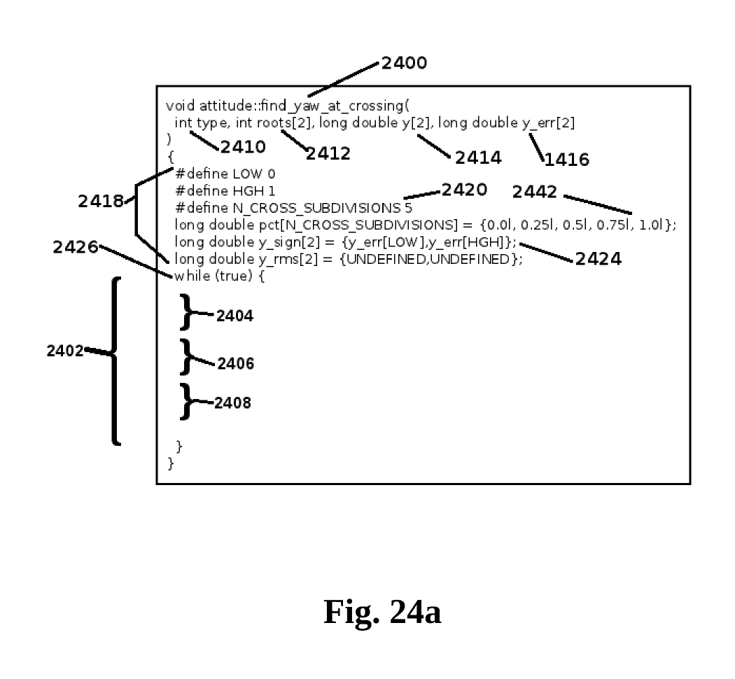

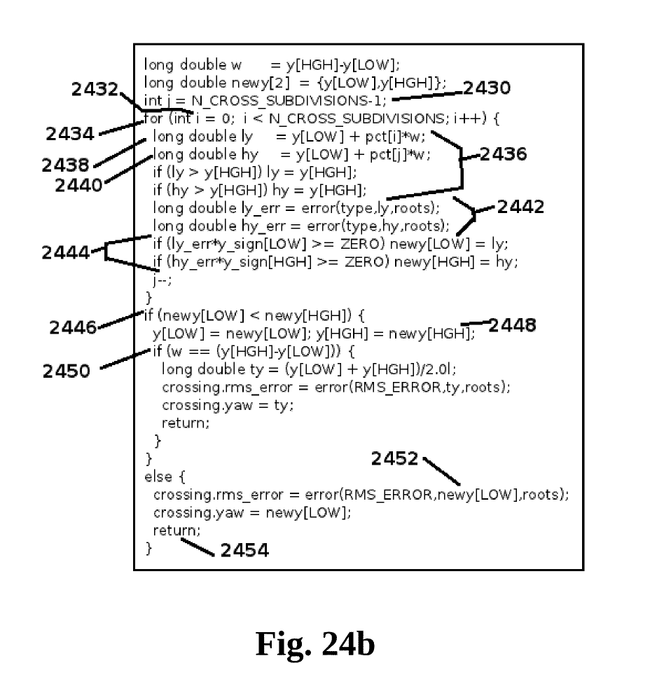

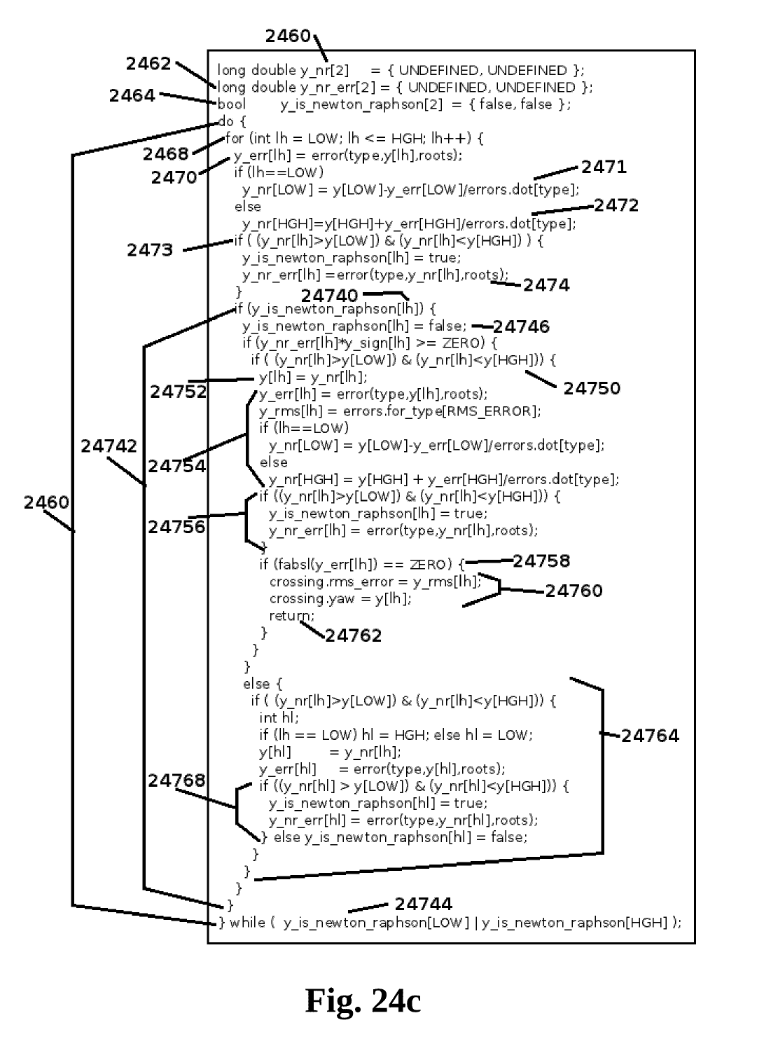

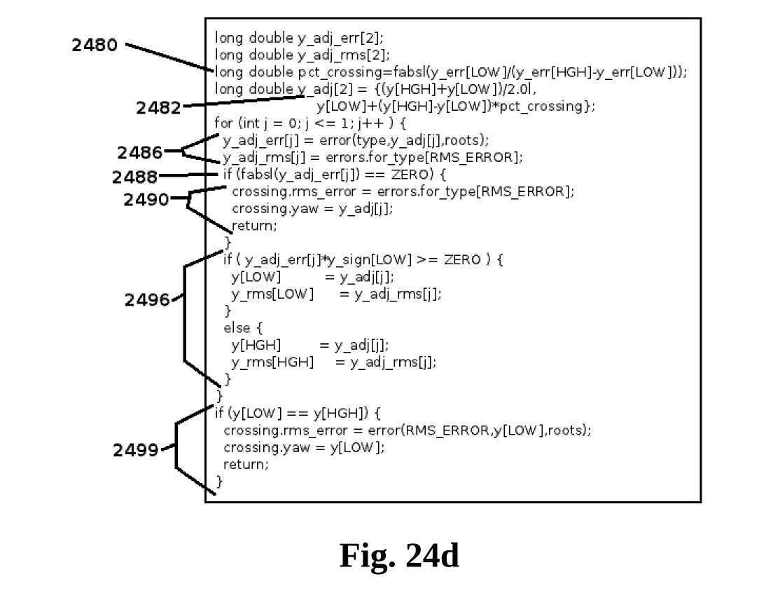

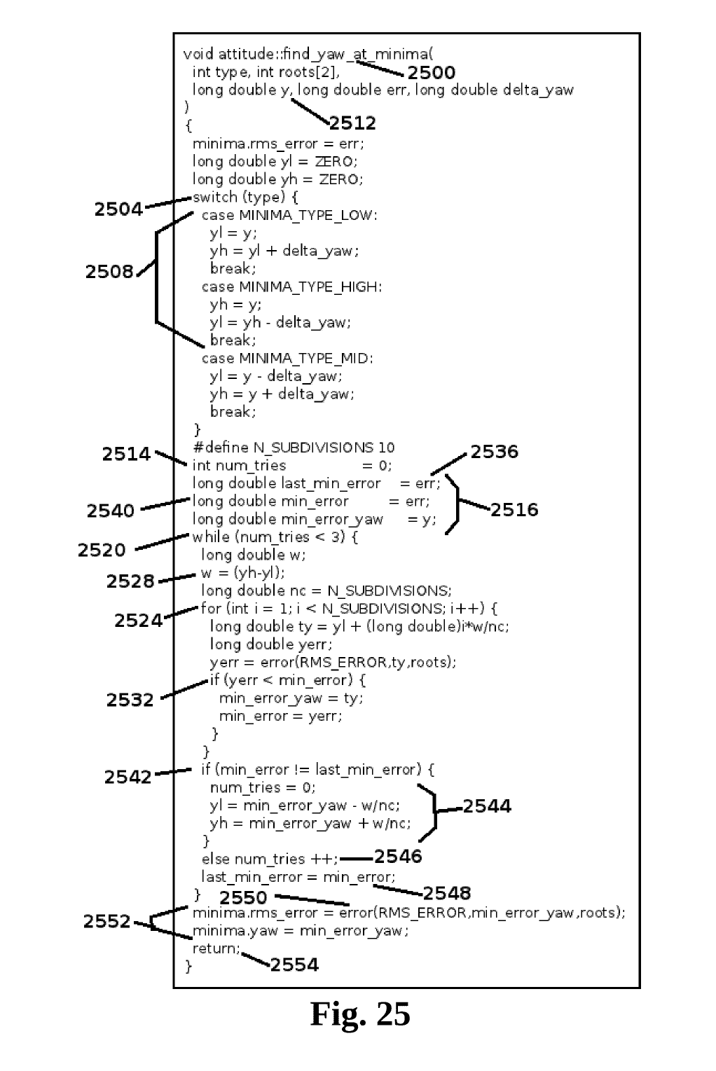

FIG. 10e is a listing of function declarations for exemplar methods used to isolate minimums, with method find_yaw_at_crossing 1080 used to find the yaw angle at which point the roll error, or the pitch error associated with a pair of vector roots goes go zero. Method 1080 is a key numeric method to generally solve root finding for functions which will not universally solve directly using purely Newton-Raphson methods. An exemplar for method 1080 is depicted in FIG. 24a and will be described in detail in the disclosure associated with that figure. The find_yaw_at_minima method 1082 on the other hand searches over a yaw range to isolate a yaw angle associated with a minimum RMS error for a specific set of vector roots. The seeking strategy used for finding a minimum RMS point from a known point y 1084 on some interval delta_yaw 1086 has three starting types of conditions, MINIMA_TYPE_LOW 1088 if known point 1084 is on the low end of a 1086 interval, MINIMA_TYPE_MID 1090 if somewhere in the interval, and MINIMA_TYPE_HIGH 1092 if known to be the high end of the interval 1086. An exemplar for method 1082 is depicted in FIG. 25 and will be discussed in further detail associated with that figure.

FIG. 10f is a listing of function declarations for exemplar methods to determine various error states. Three error methods are employed with the error method 1092 used to isolate zero crossing errors by method 1080. This method returns the specified type made in the call through the type 1094 argument, and stores the three error types using vector (800 FIG. 8). The vector_error 1094 computes the difference between the reference body frame and a computed body frame applying the yaw, pitch and roll angles with the transform method 1020. The vector_error 1096 and absolute_error 1097 are the methods used to compute the indicated_error statistic 1098 for the attitude solution.

FIG. 11 is a listing of an exemplar function for the angle_difference method for determining the difference between two angles as they relate to the solution of Euler angles. Differences between two angles in a trigonometric sense are not necessarily the same as the difference between angle values. The exemplar method 1100 distinguishes angle differences as they relate to solution of Euler sequence angles. When the absolute difference between to angles is greater than or equal to π, as tested by the function at 1110, then the difference of interest is the smaller angle produced by normalizing the both angles on the interval zero to π and taking the difference of the normalized values as exemplified in the return statement 1120. Otherwise the numeric difference is the angle difference of interest and returned at 1130. For example if for a give yaw angle the coefficients for one vector produce a roll angle of −π radians and the coefficients for another produce the angle π radians, then the difference is zero in the sense that both angles produce the same Euler vehicle orientation. This is so because Euler angles are sequencing angle for the order of operations in the linear algebra used to construct the transform matrix and are not directly related to state to state changes in vehicle maneuvering.

FIG. 12 is a listing of an exemplar function for a convert_pitch method to convert a high pitch Euler angle sequence to a conventionally angled sequence. So called “high pitch” solutions are converted to the more recognizable form of yaw-pitch-roll sequence angles using method 1200. The method adds π to both the yaw and roll angles 1210 and 1220 respectively, and re-assigns the pitch angle to the it's supplementary value 1230, then making a final re-assignment of the sequence angles normalized on the −π to π interval 1240.

FIG. 13a is a listing of an exemplar function for a set_roll_and_pitch method 1300 which performs an error checking function. For a specific yaw angle 1302, vector 1304 and root 1306 the function first computes a sine for the roll angle 1308. The next step 1310 tests the absolute value of the sine computed at 1308 to test if the value of the sine is less than or equal to 1. If the absolute value of the sine is greater than one, then any call to a sine library function will fail. For values tested at step 1310 which are greater than 1 the roll and pitch angles are undefined and Boolean false is returned 1312. The false returned at 1312 is utilized to test yaw limit lists to isolate and eliminate numerical errors in the yaw list creation phase. This is the key reason for this version of a method to compute roll and pitch angles with error checking. Turning back to the code at 1310, when the test indicates a sine value computed for the roll angle will return a valid angle, then the body of code 1314 will be executed.

Starting with copying the values of the local and body frame for a vector 1316, the roll angle is computed at 1318. The 1318 computation completes an implementation of (eq. 6) using the sine computed at 1308. The sine of the pitch is computed by the code segment 1320. With two forms of the pitch computed and stored by code segment 1322. The first form being the direct arc sine result for the sine of the pitch and the second being the supplement of the first. The local frame is used in conjunction with the transform function (1020 in FIG. 10) using 1302 as the yaw argument, the first pitch element of the vector_pitch[0] associated with code segment 1322 as the pitch argument, and the roll angle computed by 1318 as the roll angle, to compute a temporary body frame. The difference between the computed body frame values and those set by 1316 define an error by axis 1326 with the mean square error for all three axis defining a first vector error err_ang[0] 1328. The error computation steps are repeated using the transform 1020 function with arguments as before with the exception of the pitch argument which is set to the vector element_pitch[1] associated with code segment 1322 to produce a second error, err_ang[1] 1322. A comparison is next made of the values of err_ang[0] and err_ang[1] and if err_ang[0] is the less, then the pitch is assigned the value of_pitch[0] 1336 and the supplement_flag 960 is assigned the value PITCH_NO_SUPPLEMENT. Otherwise the pitch is assigned the value of_pitch[1] 1338 and the supplement_flag (960 FIG. 9) is assigned the value PITCH_SUPPLEMENT. In either case the function will return true as there has been established a roll and pitch angle for the given yaw angle 1302, for vector 1304, and root 1306.

FIG. 13b is a listing of an exemplar function for a set_roll_and_pitch method which computes roll and pitch angles for a specified pair of roots associated with both reference vectors. This function returns y_p_r_type (862 in FIG. 8) with the values of the Euler angles, derivatives for the roll and pitch and pitch flag for the called value for the yaw 1350 and roots 1360 where roots[V0] is the root index for vector V0 and roots[V1] the index for vector V1. A for loop structure 1362 is used to iterate for both roots to first compute the K sr, and roll0 coefficients 1364, the roll angle 1366, and the derivative associated with the roll angle 1368. The sine of the pitch is computed 1370 and from it the derivative of the pitch 1372. If the pitch flag is set to PITCH_SUPPLEMENT then the pitch is assigned to the supplement of the return from the arcsine function 1374, otherwise the pitch is assigned the arcsine of the sine computation 1370. With the pitch assigned the completed y_p_r_type structure is returned at 1376.

FIG. 14 is a listing of an exemplar method to compute roll and pitch angles and their associated errors for all combinations of vectors and their roots for a given yaw angle. The function 1046 returning a Boolean true/false value 1400 as to whether or not a new minimum root mean square (RMS) error value was determined. This function stores the main results using the a_and_e variable (971 in FIG. 9) of the angles_and errors_type type (862 in FIG. 8). The yaw angle argument 1402 is stored on variable 971 first at 1404. A first loop structure 1406 begins the process of computing pitch and roll angle combinations. Temporary local and body frame values 1408 are established along with a base portion of the roll angle 1410. Said base portion 1410 being those computations which are common to all vector/root combinations for implementation of (eq. 6) for the roll angle. Terms common to computation of the pitch associated with all vector/root combinations are computed at 1412 with a second loop structure 1414 used to compute temporary roll[ ][ ] and pitch[ ][ ] values 1416. With the temporary roll [i][j] value established 1418, the roll angle for vector i's j'th root is stored at 1420. Next the sine for the pitch is established 1422 with the pitch supplement flag of the current yaw_limit structure 1424 used to assign the pitch[i][j] value correctly for storage on variable 1426. It is to be noted the coding practice of using the temporary roll and pitch variables to calculate the pitch and roll values to be assigned to the angles and errors structure is intended for disclosure purposes, with actual code implementations using code practices seeking to minimize either memory requirements or execution time.

Next, beginning by assuming the value of the variable 1428 which will be returned by the function will be set to false, two loop structures 1430 are used to iterate all vector root combinations to compute the state of the roll, pitch and RMS errors for the specified yaw angle 1402. The pitch error 1432 being then established by a call to the angle_difference method 1100 with one angle being the pitch with the i'th index of 1 (V1) and the j'th index of j 1434, and the other angle being the pitch with the i'th index of 0 (V0) and the j'th index equal to i 1436. The loop structure 1430 then resulting in computing for each vector V0 the difference between V0's two root combinations to those of vector V1. Likewise the roll error is set 1438 and from the roll and pitch errors 1440 an RMS error 1442 is computed.

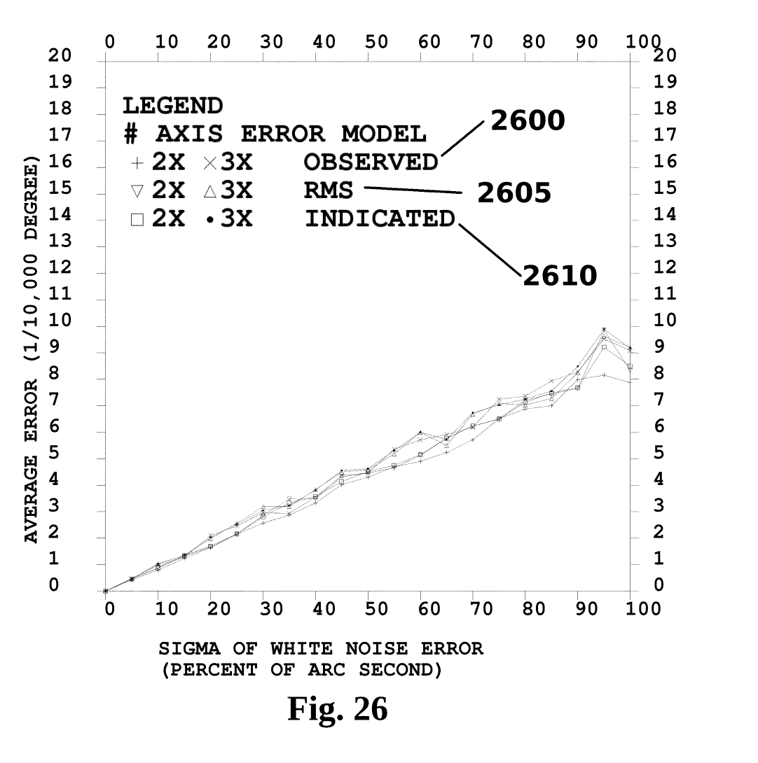

The RMS statistic 1442 is computed as the square root of the sum of the squares for the pitch and roll errors, with the addition of a square root result being multiplied by the coefficient 1444 with a value of 1.5 which is the fraction 3/2. If the roll and pitch errors are differences between of the roll and pitch angles for the two reference vectors. These differences for a specific yaw angle at the overall minimum are an indicator of the actual attitude error, but the associated yaw angle error is confounded with the roll and pitch error. As the raw square root is an indicator for primarily two of a three axis system, the ad hoc coefficient is used to produce and overall estimator error associated with the final Euler sequence angles. It's justification is based on the idea of compensating for a missing degree of freedom in the error estimates, hence the fraction 3/2 for the coefficient. The mean performance of this estimator is shown in FIGS. 26 through 28 for simulations of two and three axis white noise errors in the arc second, arc minute and arc angle ranges. When a new minimum RMS error estimate is encountered the value of the statistic, yaw angle and vector indexes and so forth are collected 1446 for either further refinement by other methods or for use in completion of the attributes of solution returned by the executive function (1030 in FIG. 10b).

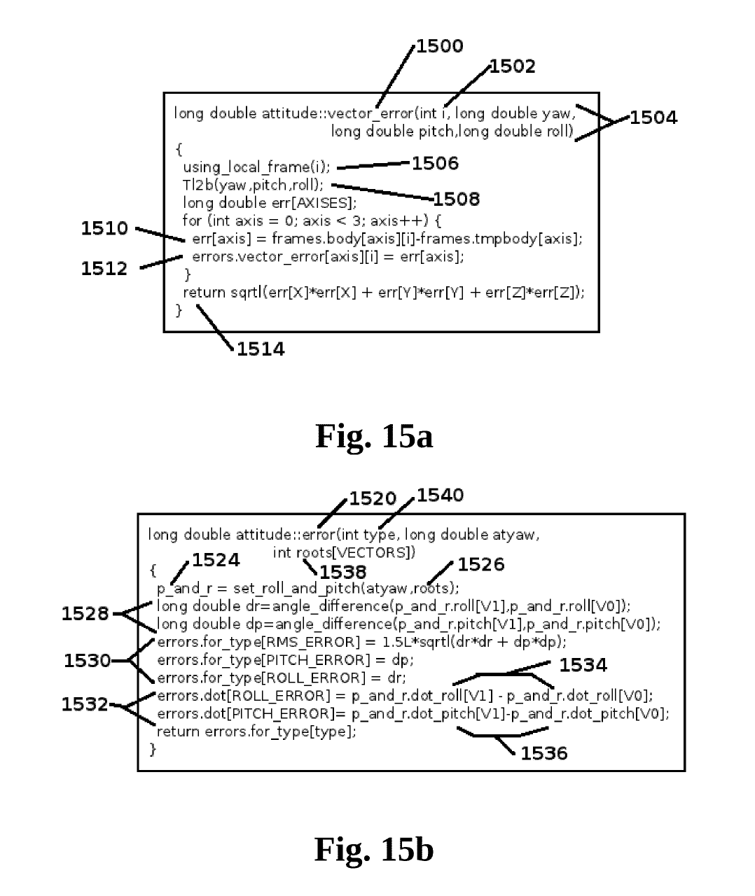

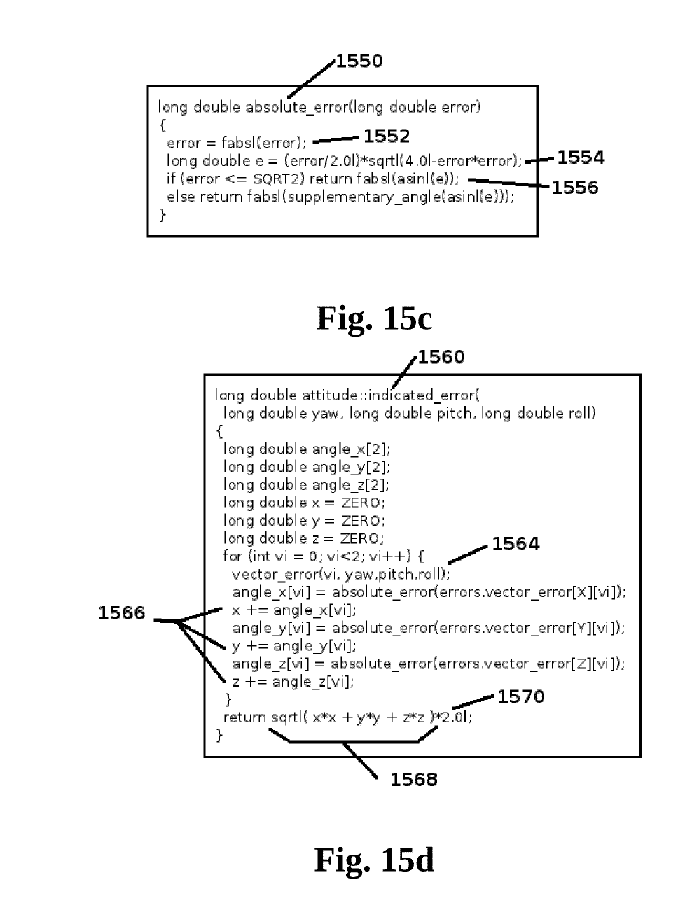

FIG. 15a is a listing of an exemplar function 1500 to compute the vector_error 1096. The error is calculated for the vector 1502 for the Euler sequence angles, yaw, pitch and roll 1504. Using a copy of the local frame 1506 the local to body transform is computed using the Euler sequence angles 1508 with the results stored using the temporary body frame 740. The error by body frame 1510 is then the difference between reference body frame and the temporary body frame computed by the step at 1508, with the error 1510 stored as the vector_error by axis on the errors structure 1512. The function returns the scalar of the vector_error for all three axis as the root mean square of the three axis errors 1514.

FIG. 15b is a listing of an exemplar function 1520 to compute various types of error 1092 associated with the differences between roll and pitch angles and the derivatives for the roll and pitch error. The angle difference computations are akin to those of (1440 FIG. 14) computed by function 1520 using the y_p_r_type structure at step 1524 to store the pitch and roll angles set by set_roll_and_pitch method variant (1044 in FIG. 10c) at 1526. The difference computations here performed at 1528 with the three error types RMS_ERROR, PITCH_ERROR and ROLL_ERROR computed by code segment 1530. As a side effect of the call to function 1440 at 1526 the roll and pitch derivatives for roots of both reference vectors are computed and stored with the results used in the code segment 1532 to set the derivative of the errors for roll and pitch defined by the differences 1534 and 1536 for the roll and pitch derivatives associated with the two reference vectors. With the error and derivative state associated for a root combination 1538 established the function 1520 returns error type 1540 requested in the function call.

FIG. 15c is a listing of an exemplar function 1550 to compute the absolute_error. The absolute error is based on the law of cosines, which in turn is based on the original Euclid Proposition 13, of Book II of the Elements, being applied to create an indicator of the angular difference between the end points of two unit vectors. From the original Euclid proposition 13 of Book II of the Elements the analytic geometry formula for the projection distance e in an acute angle triangle is typically written in the form:

$$e = \frac{{c}^{2} + {b}^{2} - {a}^{2}}{2} ,$$

where b, and c, are 1 for unit vectors and a is the vector_error from which the error as an angle is the arc whose cosine is e. If a>\sqrt{2} then the error is the supplement of the |arccos(e)|. But, in this form the error is numerically unstable with the small errors associated with high precision angular measurements. Rewriting the law of cosines in the sine form results in a more stable form:

$$e = arcsin ( \frac{a}{2} \sqrt{4 - {a}^{2}} ) . \qquad ( eq . 16 )$$

It is this form of the e equation that is used to compute an absolute error metric for the difference between two unit vectors utilized in function 1550. The first step in establishing the value of the absolute_error being to convert the signed scalar vector_error into an absolute value at 1552. The resulting value is used as the term a in (eq. 16) to compute the value of the temporary variable e at 1554. The final returned value is the result of the logic test 1556 to determine if the supplement of the angle is to be returned.

FIG. 15d is a listing of an exemplar function 1560 to compute an indicated_error for an estimate of the overall root mean square RMS error associated with the Euler angle sequence returned by the solution executive function (1030 in FIG. 10b). The first step in the computation of this error is the establishment of the vector_error at 1564 for each vector associated with the sequence angles yaw, pitch and roll passed to function 1560 in the call. The vector_error by axis are summed 1566 and the indicated_error is assigned the value of the root mean square of the squares of the sum for each axis 1568 multiplied by a scaling coefficient 1570 equal to 2.

Like the RMS statistic 1442 in FIG. 14, the performance of the indicated_error statistic is shown in FIGS. 26 through 28 for simulations of two and three axis white noise errors in the arc second, arc minute and arc angle ranges. When the absolute value of the true pitch angle is less than or equal to 60 degrees the coefficient 1570 with a value of two has a mean performance which tracks the true error based on simulation studies associated with the spectrum of errors indicated in FIGS. 26-28. The coefficient 1570 can be treated as a variable or converted into a table of values to adjust the indicated_error statistic for arbitrary pitch ranges. There is known to be some slight variation in central tendencies associated with the type of white noise model that is applicable, such as two or three axis error models as illustrated in the plots of the mean performance of the statistic from simulation studies represented in FIGS. 26-28.

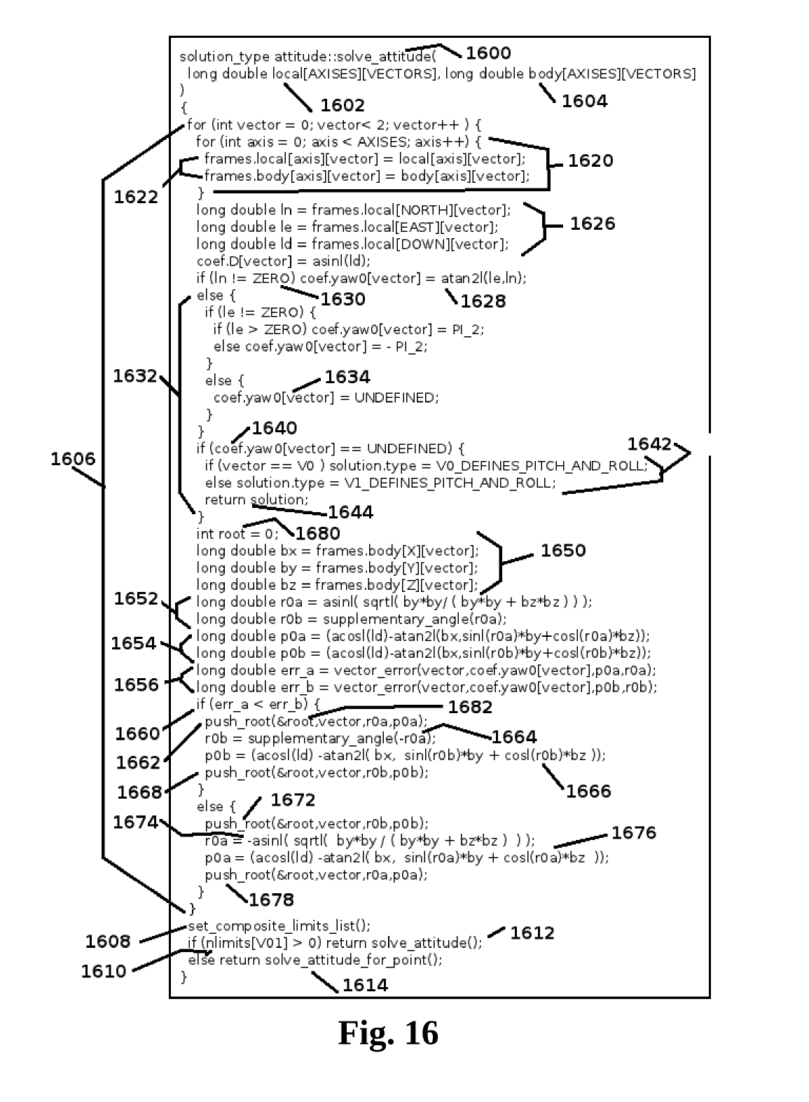

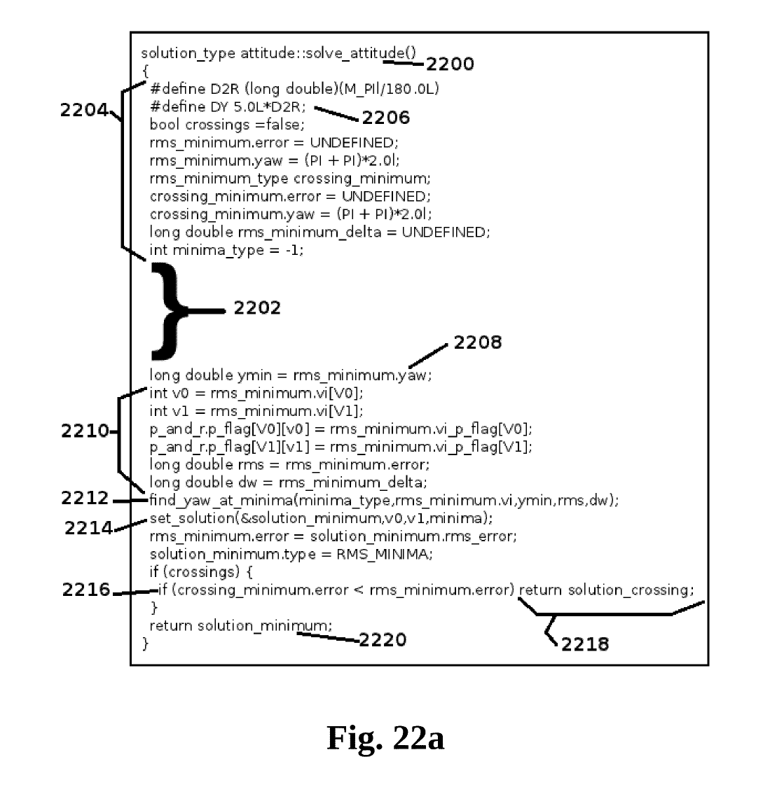

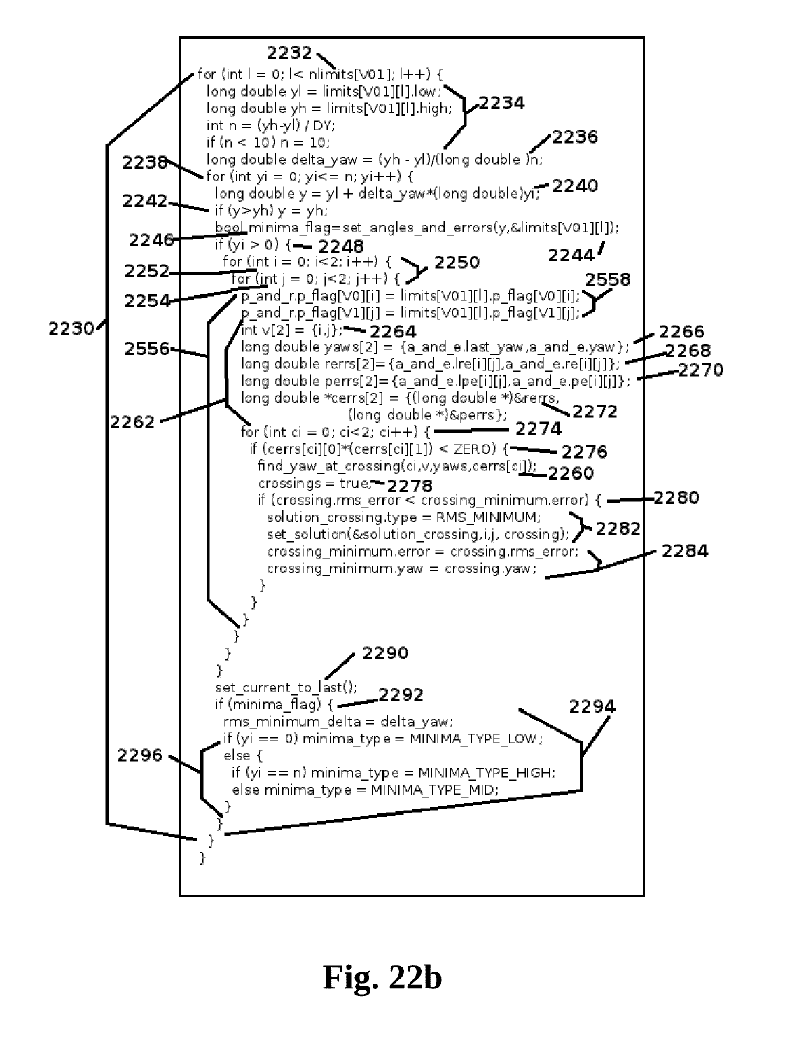

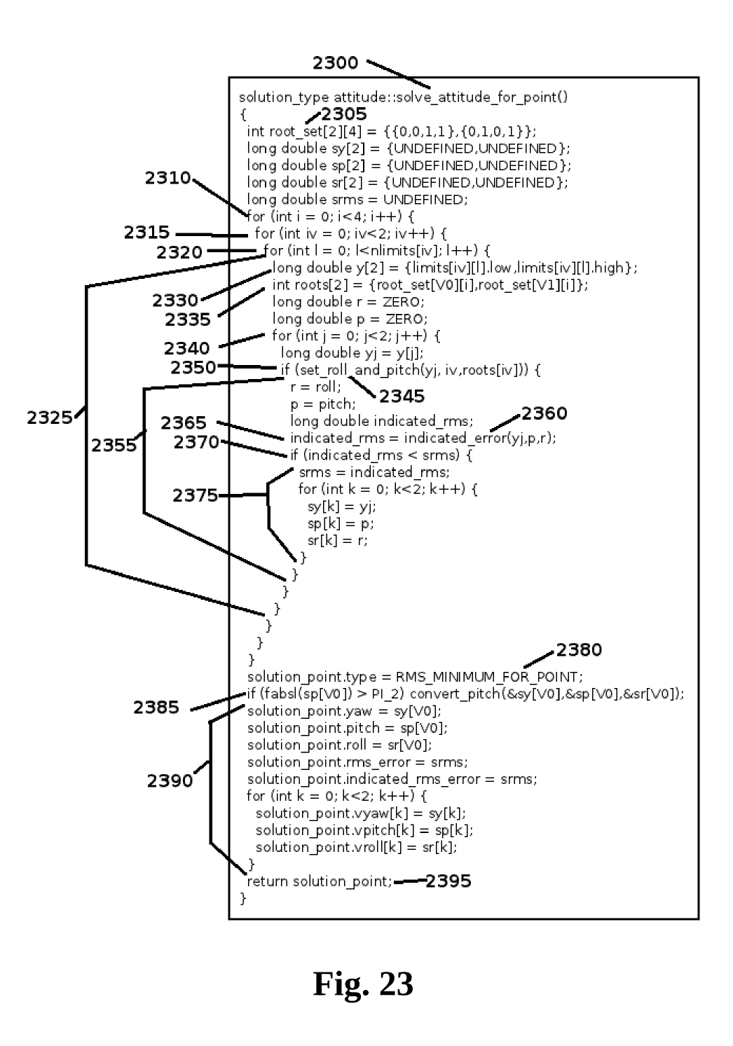

FIG. 16 is a listing of an exemplar function 1600 implementation of the executive method 1030 which returns the solution for a pairing of local frame 1602 and body frame vectors 1604 with the attributes of the solution returned using a type solution_type (890 FIG. 8) variable. The method uses a main outer loop for statement 1606 to determine coefficients for both reference vectors 1602 and 1604. Once the coefficients have been determined within the body of 1606 the development of the composite list is attempted at step 1608. The vector (925 in FIG. 9) stores the results from the call to the composite_limits_list method at 1608 with respect to the size of the yaw limit list(s) created. For example, the call at 1608 will results in creation of a yaw limit list for the first reference vector V0, and the number of elements or nodes in the list will be assigned to nlimits[V0]. For vector V1 nlimits[V1] will assigned the length of the list associated with vector V1. The nlimits[V01] vector element, referenced at 1610, is the length of the composite list of yaw limits for both reference vectors 1602 and 1604. The composite list exists if the value of nlimits[V01] for the if statement at 1610 is greater than zero, in which case the subsidiary solver method 1612 will be called to determine and return the solution stored using an 890 type variable structure. If the if statement at 1610 resolves to a false logic state, then the solver method 1614 will be called to return a solution, again using an 890 type variable structure for what will be a point type of solution. FIG. 22a and FIG. 22b disclose the implementation details of method 1612 and FIG. 23 implementation details for method 1614.

Returning to the outer loop 1606, The for loop block begins with an inner axis floor loop block 1620 to assign the unit reference vector values 1602 and 1604 to the reference frame variable 1622. Strictly for readability purposes, (such as coding without the subscripts) copies of the reference frame variables are made at 1624 so as to make the calculations of the local frame based coefficients such as the D coefficient 1626 for each vector.

With the D coefficient 1626 established, the yaw0 coefficient is computed implementing equation (eq. 2) at 1628 when the value of the downward component of the local reference frame 1602 is not zero. The logic test being performed at 1630, When the downward component 1602 is zero, then the series of if statements 1632 are evaluated to determine the yaw0 coefficient, including whether it is assigned a value to indicated it is undefined. Note the atan 2 math library function typically uses the signs of both arguments to determine the quadrant of the return value. However, if both arguments are zero then a domain error will occur. The series of if statements 1632 avoid causing any errors in library calls on the one hand while isolating the existence of an undefined yaw0 condition at 1634.

With the value of the yaw0 coefficient determined, the value is tested at 1640 to test if the yaw0 coefficient is assigned a value representing an undefined state. If the yaw0 coefficient is undefined then the identity of the vector is determined and the appropriate solution type is assigned 1642, and the solution executive 1600 returns which vector can be used to establish the roll and pitch angles 1644.

With the local frame based coefficients determined, the body frame coefficients, and mixed local and body frame based coefficients are determined. Again, for readability purposes copies of the body frame are taken at 1650 and used to compute two variants of prospective roll0 coefficient values using an r0a and r0b variable at 1652. The first prospective value being computed according to (eq. 3) and the second being the supplementary angle of the first. Next, two variants of prospective pitch0 coefficient values, designated p0a and p0b are computed 1654 applying the corresponding r0a and r0b values for (eq. 4), and with corresponding err_a and err_b values assigned to represent the vector_error for the a/b variants 1656.

Next the if statement 1660 is used to evaluate the relative difference between the a/b errors computed at 1656.

If err_a is the less, then a root_set is pushed by the push_root method (1050 FIG. 10) call 1662 passing the values of r0a and p0a values for the vector. Then the r0b and p0b variables are re-assigned, with r0b taking the value of the negative of the supplementary angle of the pushed r0a value 1664. The p0b value is recomputed applying (eq. 4) with the redefined r0b value 1666. Next the revised r0b and p0b values are pushed to create the second root for the vector 1668. Note that the root variable is initialized to zero at 1680, and the address passed as the first argument in the call(s) to the push_root method 1050 such as the call at 1662. The implementation of method 1050 indexes the value of the root variable to maintain an index associated with the coefficient variants for a vector.

If err_a is not the less, then a root_set is pushed by call 1672 passing the values of r0b and p0b values for the vector. Then the r0a and p0a variables are re-assigned, with r0a taking the value of the negative of (eq. 3) 1674. The p0a value is recomputed applying (eq. 4) with the redefined r0a value 1676. Next the revised r0a and p0a values are pushed to create the second root for the vector 1678.

Once coefficients are determined in the body of for loop 1606, without encountering the return at 1644, then the executive continues processing by proceeding to the earlier described steps 1608 through 1614.

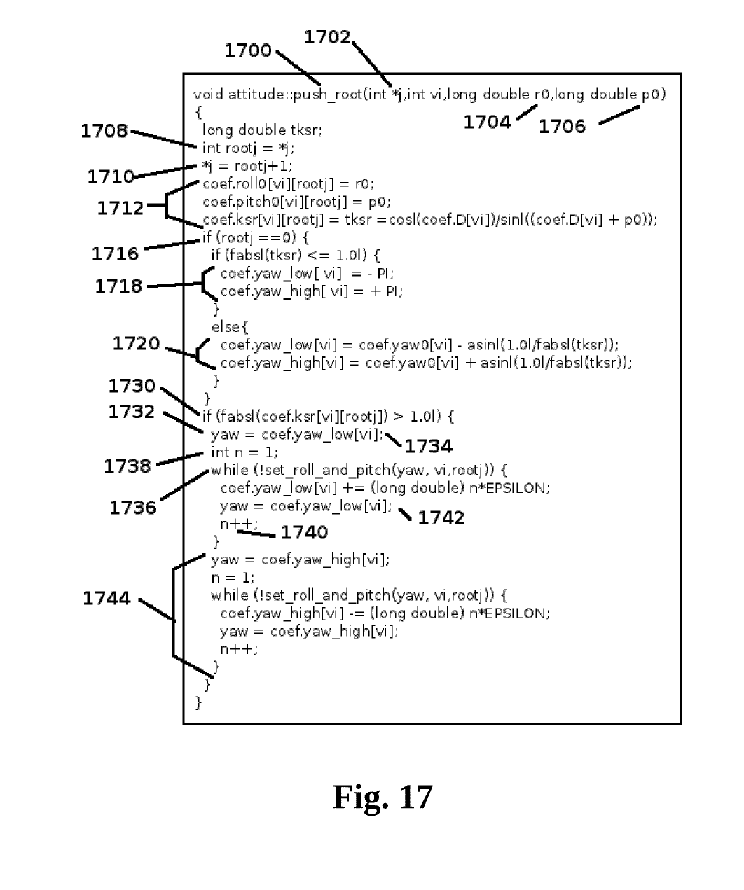

FIG. 17 is a listing of an exemplar function 1700 implementation of the push_root method (1050 in FIG. 10d) referenced at 1662 and 1672 by in the FIG. 16 solution executive 1600. The address of the root index variable is passed as part of the call to the method 1702, with the values of the roll0 and pitch0 coefficients passed by value in the call at 1704 and 1706 respectively. A root index is set 1708 and then indexed 1710 with the revised indexed value then representing the number of root elements for a vector that will have been established by the end of the push_root method 1700 processing. The coefficients are set 1712 for the roll0, pitch0 and K sr coefficients for vector 1702 for the root index value assigned at 1708, with a temporary copy K sr coefficient value taken at 1714 for possible use in determining yaw limits for the vector 1702.

If the root value 1708 is zero, then the call is to push the initial root_set group of coefficients for vector 1702. In which case the if statement 1716 will evaluate true and, furthermore, if the absolute value of the temporary K sr coefficient 1714 is less then or equal to one, then the yaw is unlimited for all vector 1702 roots. As a convention the yaw limits are then set to plus and minus π according to (eq. 12) and (eq. 13) to indicate the roots for the vector 1702 can be evaluated over a full 2π range of radian values 1718. If, on the other hand, the yaw limits associated with vector 1702 are limited, then the low and high range limits are set 1720 with the low range according to (eq. 14) and the high range according to (eq. 15).

Further processing is necessary to test the low and high range limits when the yaw angle for vector 1702 are limited. The necessity of the processing is tested by the if statement at 1730 and if true a temporary yaw angle 1732 for testing purposes is established with the value assigned to the value at 1734, that is, the yaw_low value established by 1720. Next, a while loop 1736 is used in conjunction with an integer multiplier 1738 to test whether the yaw limit is numerically stable.

The while loop 1738 calls the set_roll_and_pitch method (1300 in FIG. 13), which is the variant of the set_roll_and_pitch method with error checking. If the current value of the yaw angle 1732 results in method 1300 returning false, then the roll and pitch angles cannot be computed at the yaw angle because the absolute value of the sine for the roll angle is greater than 1. This occurs from round off errors in computations with the boundary error associated with small error magnitudes. Accordingly, when method 1300 returns false, the coefficient for the yaw_low limit is adjusted by an addition of the multiplier 1738 number of the computer EPSILON constant values (using the long double version LDBL_EPSILON used in the exemplar code). The EPSILON constant being the smallest value that can be added to 1.0 to give a distinct number. In practice the multiple 1738 in some cases must be larger than 1 to force an actual change in the incremented yaw_low value, hence the ++ operator use at 1740 to index the multiplier 1738 after the yaw angle 1732 has been reassigned to the revised yaw_low value at 1742. When the while loop 1738 terminates a lower yaw limit for vector 1702 which is numerically stable has been established.

With the stability of the lower yaw limit established, the stability of the upper yaw limit is established at 1794 by a suitable differences in variable references used in the to establish the stability of the lower yaw limit. Establishing the stability of the upper and lower yaw limits is critical to the solution of the orientation of the vehicle.

FIG. 18 is a listing of an exemplar function 1800 implementation of the set_composite_limits_list method (1054 in FIG. 10d) referenced at (1608 in FIG. 16) for solution executive 1600. Beginning with an assumption the composite list will not exist, the length of the list is set to zero 1802 and the yaw ranges for both reference vectors are established 1804. If both yaw ranges are greater than π radians the composite list is initialized at 1806 with the yaw range set to −π to +π. As a side effect to the call at 1806 the new_limit method indexes the value of the nlimits[ ] vector 1808 for the V01 index value, that is the length of the composite list will be one.

If the yaw range is limited for one or both vectors the else block 1810 of if statement 1812 is executed starting with an if statement 1814 to determine if the yaw range of both vectors are limited. If both yaw ranges are limited then block 1816 is executed, otherwise the else block 1818 is executed. When both vectors are yaw limited block 1816 begins by creation of yaw limit lists for both vectors using the limit_list (1056 in FIG. 10d) method using a for loop structure 1820 to make the necessary calls. The lists created will have yaw limits that cover the −π to +π radian angle range. Then a double for loop structure 1822 is used to compare each combination of yaw ranges between the two vectors to determine if any yaw over lap range exists. The test is performed with the if statement 1824 which makes a call 1826 to the yaw_overlap (1052) method. If an overlap exists then the low and high values for the range are returned for the low 1828 and high 1830 parameters passed to the (1052 in FIG. 10d) method call. These values are then passed to a call to add the yaw range to the composite list 1840 and then a call 1842 to a set_p_flag (1058 in FIG. 10d) method to set the pitch supplement flag for the list element. The call 1842 to the set_p_flag (1058) method uses a yaw angle argument set to the average of the yaw limit range for said element 1844.

At the completion of block 1816, a yaw limit list may, or may not exist, with the existence indicated by the value of the nlimits[ ] variable at the index V01.

When only one of the vectors has a yaw limitation, then block 1818 is executed. The identity of which vector is limited is established first 1850, then a list of limits for that vector are established 1852, from which a copy is make to form the composite list using the for loop 1854 to copy each element of the list 1850 with the calls for a new limit to the composite list 1856 and setting the pitch flag 1858.

FIG. 19 is a listing of an exemplar function 1900 implementation of the limit_list method (1056 in FIG. 10d). For a vector 1902 with a yaw range nominally ranging from 1908 to 1912 the function will create a list of all the ranges that can be made on π intervals of the 1908 and 1912 limits. Starting with initialization of the list for vector 1904 at a length of zero, the while loop 1920 is used to increment the passed yaw limits by −π until the lower limit is equal to or less than −π. Then, if the thus incremented high yaw limit is ≧π and the lower limit is now>−π, the limit from the low to high limit is added as an element to the list for vector vi 1928, but if not, then the range −π to the high limit is added as an element to the vi list 1930. Next, the lower and upper yaw limit is incremented by π radians 1932. This is followed by a second while loop 1936 with a test for the high limit being≦π, for which case an element is added to the vi list with the current value of the low and high yaw limits 1940, otherwise an element is added to the list with the limit interval being the low value and the high value of π 1942.

After while loop 1936 completes the yaw limit list is complete as to the number of elements in the list for vector vi, what remains to be done is to test the limits and adjust them as necessary to make all of the yaw ranges in the list numerically stable. This is accomplished by a double for loop structure 1944 where two while loop structures 1948 are used test the upper and lower yaw limits for stability using the multiple of the EPSILON constant method employed by the push_root method with the exception that here, the multiplier on EPSILON is fixed at 2, 1952. The fixed value 1952 set at 2 is an ad hoc setting to guarantee the value changes. On a 64 bit AMD™ based machine running the gcc compiler and the Linux™ operating system the EPSILON value for the long double is for a nominally 18 digit decimal portion for double values. Hence the EPSILON adjustment methods used for the methods described relating to FIG. 17 and FIG. 19 make adjustments beginning nominally on the 18th decimal digit.

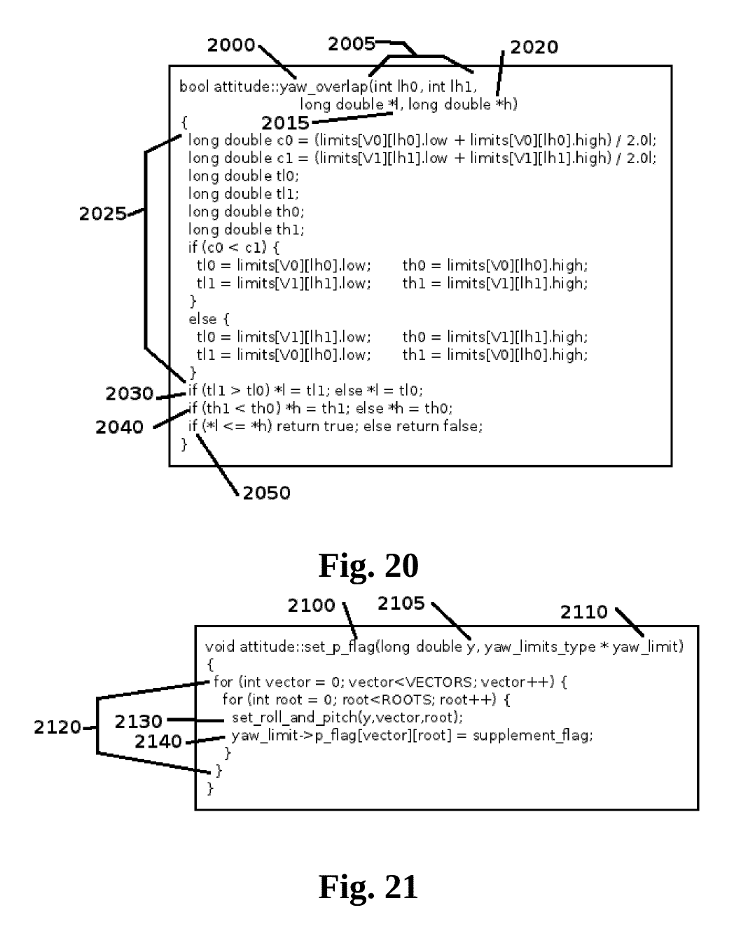

FIG. 20 is a listing of an exemplar function 2000 implementation of the yaw_overlap method (1052 in FIG. 10d). The method 2000 takes four arguments. The first two, 2005 and 2010 are indexes for the root to test for the vector V0 and V1, that is the yaw limits are passed indirectly. Upon return the function returns a low yaw limit in passed by address variable 2015 with the high limit likewise returned on 2020. The function 2000 itself formally passes a Boolean which is set true if there was a yaw overlap and false otherwise. The setup for a test of the overlap 2025 is followed by a test 2030 to set the a low limit and one at 2040 to set a high limit. These limits are tested 2050, and if the low limit is still less than equal to the high limit, then a yaw overlap exists, on the range held by the state of the 2015, and 2020 passed variables, and the function returns true. Otherwise the function returns false indicating no overlap existed between the two tested pairs of limits.

FIG. 21 is a listing of an exemplar function 2100 implementation of the set_p_flag method (1058 in FIG. 10d). The method 2100 takes an argument for the yaw angle 2105 and a pointer to a yaw limit list structure element 2110. A double for loop structure 2120 is used to compute values for both roots of both reference vectors. This is accomplished by first setting the roll and pitch for the yaw angle 2105 for each vector/root combination 2130. As a side effect of the call the supplement_flag is set and the value is assigned to the passed yaw limit structure 2110 by the assignment statement 2140. Thus on return from method 2100 the pitch flag settings are established for the vector root combinations thus enabling usage of means to compute pitch and roll for a given yaw angle within the limit range which do not require testing the sine of the roll angle for domain errors.

FIG. 22a is a listing of an exemplar of a partial coding for a function 2200 implementation of the solve_attitude method (1032 in FIG. 10b). The method 2200 depicted in FIG. 22a has an extensive main segment removed from the FIG. 2200. The removed segment is exemplified to complete the function in FIG. 22b. The method employed to solve the attitude begins with what I term a picket search. A picket search will be made of the one or more yaw limit elements of the composite limit list to identify roll and pitch characteristics at discrete yaw points for the various vector root combinations. Hence as the yaw angle goes from a low to a high range the differences between roll angles may go from positive to negative in value indicating the existence an initially unknown yaw angle where the difference in a pair of roll angles goes to zero. Hence discrete points are like the tops of a picket fence, and the crossing point is somewhere between adjacent tops of the fence so to speak, thus the term picket search.

Prior to conducting a picket search in the segment 2202 referenced in FIG. 22a, the initial conditions for searching are set 2204. A delta yaw angle of 5 degrees 2206 will be used as the nominal yaw interval between points in the picket search. The final yaw interval will be adjusted later. The completion of the picket search referenced at 2202 will result in the identification of a minimum RMS error associated with the yaw angle on the structure 2208. The other attributes which identify the root combination and other characteristics isolated for the minimum by 2202 are copied to local variables 2210 for use in a call to the find_yaw_at_minimum method 2212. As side effect of the call to the minimum finding method 2212 sets up the results for a call to the method 2214 to fill out the solution structure for possible use as the return value.

If the picket search routine as part of 2202 found crossing points, then a test is made 2216 to ascertain whether the crossing minimum error (an RMS error), is less than the minimum isolated by call 2212, in which case the solution associated with the crossing is returned for the orientation 2218, otherwise the earlier minimum associated with the 2212 call is returned 2220.

Turning to FIG. 22b, the main segment 2202 in FIG. 22a is a for loop block 2230 with this outer loop indexing across the length of the composite limits list as indicated by the loop limit 2232. For each yaw range in the composite limits list each limit is used to compute an initial number of segments to divide the low and high limit into based upon the delta yaw 2206. This division of the yaw range into segments at 2234 completes by clamping the number of segments to at least 10. With the number of segments n established 2234, next the delta yaw to use for the picket search is finalized 2236 based on the number of segments n. The minimum number of segments set to 10 in conjunction with the nominal starting delta yaw of 5 degrees has been found to work across simulation sampling of the universe of possible unit local and body frame vectors. Less number of segments or wider yaw ranges negatively affect precision and more segments and smaller delta yaw settings do not make any significant improvements in accuracy while increasing execution time.

The picket search is conducted using the low yaw limit of the limit list in combination with the delta yaw and an index to compute yaw angles for the search 2240, where the index is set by the for loop structure 2238 with the yi index of 2238 serving as a yaw index for the search. A test is made 2242 to clamp the yaw angle computation 2240 to clamp the yaw angle if needed to the upper yaw limit for the list element associated with the picket search. The clamping test 2242 is necessary to insure that the yaw angles used in the search do not go out of bounds which would result in a failure to compute roll and pitch angles from sine of the roll computations exceeding |1|.

With an indexed yaw angle established, the angles and errors associated with the vector combinations for the yaw angle are computed 2244 with the Boolean minima_flag 2246 used to store the resulting indicator as to whether or not a new minimum root mean square (RMS) error was encountered.

There are across n subdivisions of a yaw range n−1 potential crossing points where either or both the roll angle or pitch angle associated with a combination of roots for the two reference vectors can cross such that the difference between the relevant angles goes to zero. Using the picket fence analogy again, the crossing points, if they occur, happen at points interspersed between two adjacent picket points (the values computed 2240). They are detectable by comparing the current set of values for the angular difference between roll and pitch angles for one pairing of vector/root combinations against the values calculated for the last yaw index. Then if say the last roll error associated with say vector V0 and the root 0, (roll[V0][0]) and vector V1 and it's root 1, (roll[V1][1]) is −0.001, and the value of the difference for the current yaw index is +0.04, then somewhere between the yaw computed for the current index, and the yaw computed for the last index, there exists a crossing point. The if statement 2248 tests the yaw index to determine when to test whether one or more crossing points exist associated with the current and last yaw indexes.

When there are potential crossing points, a double for loop structure 2250 is used to test both roots of vector V0 using an i index 2252, and both roots of vector V1 using the j index 2254. The code block 2256 associated with loop structure 2250 starts with an assignment of pitch supplement flag values 2258 where the assigned values will be used by a find_yaw_at_crossing method called at 2260 to find the crossing point associated with either the roll or pitch. Next, temporary variables for the formal parameters for the method called at 2260 are established 2262, starting with indexes for the roots of the two vectors are stored on a vector 2264, the current and last yaw angles 2266, current and last roll 2268 as well as for the pitch errors 2270. The reference vector 2272 is used for indexing the referencing between roll and pitch errors, as the find_yaw_at_crossing method called at 2260 is a generalized method for isolating both pitch and roll error crossing points.

It being understood by those familiar with the art that the initialization of the temporary variables for the 2260 calls is premature in the sense that if no call is required, then the initialization for the call is unnecessary. They are located as indicated to group them for exposition purposes to teach a method whereby the equations key to the invention can be used to solve the attitude problem with the numerical methods demonstrated by the exemplar functions teaching how to solve the equations from the input of two pairs of reference vectors.

A for loop 2272 is to test for both pitch and roll crossings. The reference vector 2272 provides an abstracted reference to both the roll and pitch error vectors using the index from associated with the 2274 for loop. Thus, in the if statement 2276 the product computation of the 2274 elements multiplies the error for the last error and the current error. When this computation is negative then there has been a change in the sign of the errors indicating a crossing. When a crossing is thus indicated the 2260 call is made followed by setting the Boolean variable 2278 to true. The truth variable 2278 being the Boolean variable tested by the if statement (2222 in FIG. 22a) to determine when to test whether to make the return (2218 in FIG. 22a) using the yaw angle from the crossing with the smallest error. As smaller crossing RMS errors occur they are detected by an if statement 2280 with the code block executed when the statement evaluates true setting the solution attributes 2282 and updating the attributes of the new minimum crossing error 2284.

After execution of the if statement 2250 is completed the current values for the picket search are caused to be copied to variables storing the last values for use in the next search iteration. This copying is performed by the method call 2290. Then the flag set at 2246 to indicate whether an RMS minimum value was identified associated with the picket yaw angle is tested 2292 and if found true, the attributes of the minimum are collected 2294. The location of the minimum with respect the upper or lower yaw range boundary regulates the method to be described in the discussion associated with FIG. 25. The location relative to the beginning, end, or interior to the picket search range associated with the 2246 flag is collected 2294 for later use in the call to the method (2212 in FIG. 22a).

FIG. 23 is a listing of an exemplar of a function 2300 implementation of the solve_attitude_for_point method (1034 in FIG. 10b). There are essentially four distinct sets of root combinations associated with the two reference vectors. Using the notion root_set[v][r] where v=1, 2 to for vector V0 and V1, and r=1, 2, 3, 4 for the each of the roots set combinations, then root_set[v][r] for a specified v and r index is used to store the index for the specific equation coefficients for each vector. Such a reference variable is used in method 2300 with the matrix 2305. Thus, using a first for loop 2310 for the four root_set combinations, a second for loop 2315 vector index and a third for loop 2320 for the yaw limits for each vector, code block 2325 is used to isolate the yaw point among the end points in the lists for both vectors that is associated with the smallest indicated RMS error.

A vector 2330 is used to store the low and high yaw limits for the current index values for the vector index set by for loop 2315 and the limit index set by for loop 2320 and the root indexes for specific roots associated with the first loop index 2310 are set on a vector 2335. Next a fourth for loop 2340 is used to index the low and high yaw limits stored on vector 2330 to compute a set of roll and pitch angles. The roll and pitch angles for each yaw are computed by the call to the method 2345. The method 2345 call is to the error checking method described earlier with respect to FIG. 13a (1300). If the method called at 2345 returns a Boolean true then if statement 2350 will execute block 2355 in order to determine the indicated_error associated with the Euler sequence angles passed in the 2345 method call. The indicated_error is determined by the method call 2360. The returned error is assigned to a variable 2365. The variable value is tested against the variable 2370 (which is initialized to indicate an undefined state which is a suitably very large value). The test of variable 2365 against the reference 2370 in the if statement 2370 will result in updating the reference to the 2365 variable's value if the value of 2365 is less than the reference 2370. This updating as well as storing the Euler angles for both vectors is performed by code block 2375.

At the completion of the for loops 2310, 2315, and 2320, the 2325 code block will have isolated a minimum indicated error. The solution type will be that for a point solution stored for the eventual return variable 2380. If the pitch for the point solution is for a high pitch solution, the solution is converted to a conventionally angled solution 2385 with the attributes of the solution assigned by code block 2390 and the point solution returned to the calling solution executive 2395.

FIG. 24a is a listing of an exemplar of a partial coding for a function 2400 implementation of the find_yaw_crossing method (1080 in FIG. 10e). The method 2400 depicted in FIG. 24a has three segments 2402 (hereinafter sub-methods) removed from the figure at 2404, 2406, and 2408. The removed sub-methods are exemplified to complete the method in FIG. 22b for 2404, FIG. 22c for 2406 and FIG. 22d for 2508.

Turning to FIG. 24a, the call to the method has four parameters. The first, 2410 sets the type of crossing, that for a roll or a pitch crossing. The second is vector 2412 which is set to the root indexes for the vector combination, with the third 2414 a vector storing the yaw angles identified by the picket search which have the called 2410 type of crossing. The fourth argument is vector 2416 storing the errors associated with the yaw angles 2410.

Next, initialization of search parameters is performed in code block 2418. In this block a number of subdivisions is specified 2320 as 5. Number of subdivisions can be configured for 3 which will produce essentially the same results, and using subdivision configurations larger than 5 slow the execution speed. The range of the yaw angles 2410 will be divided into percentages stored on the vector 2322 for use by the first sub-method which will be described in FIG. 24b. Copies of the errors passed in the call 2416 are assigned to vector 2224 for referencing the sign of the passed values with vector 2224 relied on by the first sub-method.

All three sub-methods are contained within the body of while loop 2426 configured to loop continuously. The return from the call to function 2400 may occur in any of the three sub-methods 2404, 2406 or 2408.

FIG. 24b is a listing of an the exemplar sub-method (2404) for FIG. 24a. The call to method 2400 (in FIG. 24a) uses the call by value method for passing arguments. The variables referenced in the call such as the vector 2414 for the yaw, are used in the first sub-method as temporary variables which are refined during while loop 2426 iterations. Turning attention to FIG. 24b, two indexes will be used to revise the low and high yaw limits, with the j index initialized at 2430 and an i index 2432 being also the index for loop 2436 Two test yaw angles are computed and clamped as necessary to insure they are within the current 2414 boundaries by code block 2432 with a low yaw angle 2438 set using the i index 2432, and a high yaw angle 2440 set using the j index 2332. The errors associated with the test angles are determined 2442 and the errors are tested against the original signed error values 2444. If the error associated with the low yaw angle 2438 is the same sign as the original low yaw error passed in the method call, temporary yaw vector 2446 is re-assigned to the value of for the low yaw angle 2438. The error associated with the upper yaw angle 2440 in a similar fashion is used to update temporary yaw vector 2446 for the high yaw angle. At the completion of for loop 2434 temporary yaw vector 2446 stores limits which may differ in value from the current values of vector 2414.

With the completion of for loop 2434 the temporary yaw vector 2446 can be evaluated to update the state of the search. If the lower yaw limit of 2446 is less than the upper yaw limit of 2446 then the 2414 vector can be revised. If not, then the yaw limits in 2446 will equal each other (because of the sign test 2440), and since equal, then the upper and lower limits have converged.

The test to revise the yaw limits is done by if statement 2446. If the limits are to be revised then vector 2414 is reassigned using the temporary yaw vector 2446 values 2448. The width of the revised limits can become numerically indistinguishable. Subdivision attempts can fail due to the EPSILON limitations of the computer word size and associated math libraries. A test 2450 is made to trap the numerically indistinguishable yaw limits, resulting in capturing the yaw angle as the average of the two yaw limits as the crossing yaw and performing the 2400 method call return.

As discussed earlier, if the 2446 if statement finds a false condition, then the angles stored in the temporary vector 2446 will be equal to each other. In which case the attributes of the crossing are collected using the low yaw value of 2452 and the 2400 method call returns 2454.

Thus, at the completion of processing for the sub-method depicted in FIG. 24b a return for the function 2400 may or may not occur during the course of an iteration of the outer while loop 2426 (in FIG. 24a).

FIG. 24c is a listing of an exemplar sub-method (2406) for FIG. 24a. The sub-method depicted in FIG. 24c performs a search using a modified Newton-Raphson method to identify the crossing point. The upper and lower yaw angles associated with the search are stored using vector 2460. The errors corresponding pitch or roll angle error associated with the vector 2460 are stored using vector 2462. These two vectors and a third, a Boolean valued vector 2464 all have a dimension of 2 with the Boolean vector 2464 elements initialized to a Boolean false. The modified Newton-Raphson searching occurs within a do-while block 2466. If by the end of an iteration of block 2466 both elements of Boolean vector 2464 are false, the sub-method will complete and code block 2402 (in FIG. 24a) will proceed to the (2408 in FIG. 24a) sub-method.

The modified Newton-Raphson method used has two distinguishing characteristics. First convergence on the zero error point is attempted from both the high and low directions on each iteration of the 2466 do-while code block. Second, to be considered Newton-Raphson an estimated crossing point by the Newton-Raphson method must lay within the yaw search range, if not, for the purposes of the sub-method the estimator is not considered Newton-Raphson. The rejection of Newton-Raphson estimates outside the current yaw range avoids unstable convergence problems which can occur. When the Newton-Raphson sub-method ends without a solution the third sub-method described later associated with FIG. 24d handles revised estimation of the yaw convergence point.

Turning to code block 2466 in FIG. 24c, A for loop 2468 is used to attempt Newton-Raphson revision of the yaw limits for first the low end, and then the high end of the yaw range. For each loop iteration, the error associated with the yaw is determined 2470. If this error is for the low range the Newton-Raphson estimate for convergence from the low side is set 2471 and if the error is for the high range the estimate is set for the high end 2472. The if statement 2473 accepts or rejects the estimate referenced by the index of for loop 2468. If statement 2473 accepts an estimator only if it is interior to the current yaw limits. When accepted the appropriate element of the Boolean vector 2464 is set true and the error associated with the estimator are determined 2474.

Next, the Boolean status of the appropriate 2464 element is tested and if true code block 24742 is executed, otherwise the or logic 24744 at the bottom of the do-while 2466 is evaluated. When block 24742 is executed the 2464 element is reset to false 24746. The sign of the error for the estimator is tested by if statement 24748 against the appropriate original low or high end error. This test is performed using the product multiplication method such that test 24748 will be true if the error is the same sign as the appropriate end, or zero. The yaw estimate is next tested to see if it is distinguishable as being in the interior of the current limits 24750 and if true the appropriate yaw limit is revised 24752. The errors are updated for the revised yaw limit and a new Newton-Raphson is computed 24754. Then the revised estimate is again tested to see if it is distinguishable as being within the interior of the current yaw limits and if so the appropriate Boolean element of 2464 is set to true and the error for the estimator is updated 24756. Next, the error associated with the estimator is tested against zero and if true the crossing has been found 14758. If the crossing has been found the attributes of the crossing are collected 24760 and the return 244762 results in the function 2400 (in FIG. 24a) returning the crossing result.

When the 24748 if statement determines the logic condition to be false the code block 24764 is executed. This occurs when the estimator calculated using a low range yaw value sets a value that has crossed the zero boundary in the high yaw angle side or vice-verse. When 24764 executes the appropriate opposite side yaw limit is updated along with the error. The code block then completes execution 24768 by testing the estimator to see if it is still distinguishable from the yaw limits, and if so the opposite sided Boolean element 2464 is set true, otherwise it is set false.

FIG. 24d is a listing of an the exemplar sub-method (2408) for FIG. 24a. The sub-method depicted in FIG. 24d attempts to make two adjustments at the bottom of the 2426 while loop (FIG. 24a). To potential yaw limit estimators are computed, with one estimate being the midpoint between the current low and high search ranges and the other based on a percentage statistic calculated based on the high and low error states. The percent statistic 2480 being the absolute value of the proportion of error at the current low yaw limit to the range of the errors between the low and high yaw limit. Prospective revised yaw limit estimators are initialized and stored using vector 2482. With the first element of vector storing the mid point and the second storing the percentage based estimate with this latter value calculated by adding to the lower yaw limit the yaw range times the percentage statistic 2480.

A for loop structure 2484 is used to test both of the two prospective 2482 yaw estimators. First the errors for an estimator is set 2486. Then, the crossing error for the estimator is tested 2488, and if zero, the crossing attributes are collected 2490 and the function will return. If the function does not return, then a product of the error and the original error is tested 2494 to determine whether the low or the high yaw limit and corresponding errors are to be set to the estimator and associated values 2496. Lastly a test 2498 is made to see if the upper and lower yaw limits are now equal, and if so the attributes of the crossing are collected 2499 and the function will return.

FIG. 25 is a listing of an exemplar function 2500 implementation of the find_yaw_at_minima method (1082 in FIG. 10e). Depending on the type of error in the 2500 call, a switch statement 2504 is used to configure the initial low and high yaw ranges over which to search. If the search is associated with either the low or high picket search end points 2508, the search width is set to the delta_yaw parameter in the 2500 call, and for interior searches the search is ± the delta_yaw parameter in the 2500 call about the yaw minimum 2512 in the 2500 call.

With the initial search range established by switch statement 2504 a variable representing the number of search attempts 2514 is initialized to zero and temporary variables 2516 are initialized to the yaw angle and associated errors from the 2500 call. The a sub interval search is performed within the body of while loop 2520 which will iterate the code block for the loop when the number of search attempts indicated by the value of variable 2512 is less than three. The code block associated with while loop 2520 performs a sub-interval search of the yaw range with a for loop structure 2524. The for loop 2524 used to compute yawn angles and errors on increments of the yaw range interior to the range 2528. If a new minimum error point is found 2532 the minimum tracking variables 2516 are updated with the exception of the last_min_error 2536. as necessary. Upon completion of for loop 2524 if statement 2542 tests to see if the min_err 2540 is now not equal to the last_min_error 2536. If they are not equal then we have a revised minimum and code block 2544 reset variable num_tries 2514 back to zero and the search range is set to the minimum error yaw divided by ±the number of subdivisions times the current yaw value of the yaw range 2528. If 2542 evaluates false because there has been no change in the minimum error state of the search then variable num_tries 2514 is incremented 2546.

At the bottom of while loop 2520 the last minimum error state is equal to the current 2548 error state. The while loop 2520 eventually will fail when the variable num_tries 2514 value at the bottom of the loop has taken the value of 3. The reason multiple attempts must be made to obtain a smaller error state before loop termination is that it is known that more than one, but a small number of passes can find a new minimum value.

Upon completion of while loop 2520 the RMS error for the minimum yaw point is computed 2550 with the error value as well as the yaw angle associated with the minimum assigned to the variables of the minimum error structure 2552. As a side effect of the function return 2554 the minimum error structure 2552 persist for use by the calling function.

### Performance

The exemplar code was compiled on a 64 bit AMD Phenom™ II X4 810 processor running version 2.6.43.8-1.fc15.x86_{—}64 of the Linux™ kernel using version gcc (GCC) 4.6.3 20120306 (Red Hat 4.6.3-2) of the compiler. The exemplar code will nominally solve orientations at the rate of a approximately ½ kilohertz on what is now an outdated AMD processor.

Simulation studies of the performance for the method has been conducted using two axis and three axis error models. For the three axis modeling a normally distributed random error with a mean of zero and standard deviation σ is added to the true Euler sequence angles to generate a body reference to simulate sensors having white noise errors associated with each axis. Three axis magnetometer sensors being a typical example of sensor which exhibits this type of white noise error. For two axis error modeling, a randomly selected D and yaw0 angle are sampled and a white noise error is added to each with the true Eular sequence angles used to transform the thus malformed local frame to a body frame using prior art transform (eq. 1). For both cases the reference frame call has the true local frame and the errors are on the elements of the body frame.

The two and three axis error models have been used to explore the performance from zero errors out to 1 degree o for the standard deviation for the normally distributed error sampling. Results were obtained for three ranges of error sampled in 5 percent increments: one second of arc, one minute of arc, and one degree. In all cases the initial sampling error is set to zero to sample the case where no errors are added to synthetically generated cases. The sampling is further configured to sample a full D and yaw0 range of the local unit vector. The results illustrated in the following discussion of the figures are for simulations where the Euler sequence angles were randomly sampled on the ±π range for yaw and roll and ±60 degrees for the pitch. The coefficient in FIG. 15d (1570) (set at 2.0), can be adjusted for pitch ranges less then 60 degrees and will be somewhat lower. Above 60 degrees the coefficient should be keyed to specific high pitch ranges through testing. Generally, as the pitch approaches the right angle sensor errors will have a more pronounced negative impact on indicated errors, this is suspected to be due to the error on one reference makes the reference act like it is associated with a pitch of say 88 degrees and the other say is more akin to a pitch of say 92 degrees.

The results for a simulated sampling of 2500 randomly generated reference problems for each 5 percent increment for the arc second simulations is illustrated in FIG. 26 with the legend in the figure denoting the markings for 2 and 3 axis results with the observed (true error) 2600, and the RMS error 2605 and indicated_error 2610 obtained using the exemplar code. By RMS and indicated_error is meant the rms_error returned in the solution_type structure (896 in FIG. 8) by the return from the call to the executive solver method (1600 in FIG. 16).

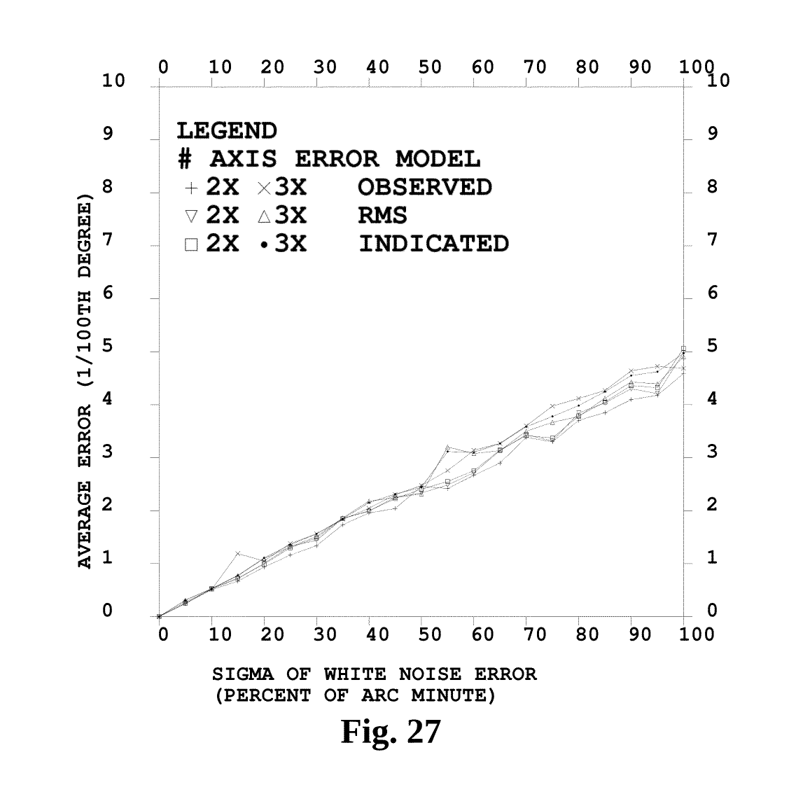

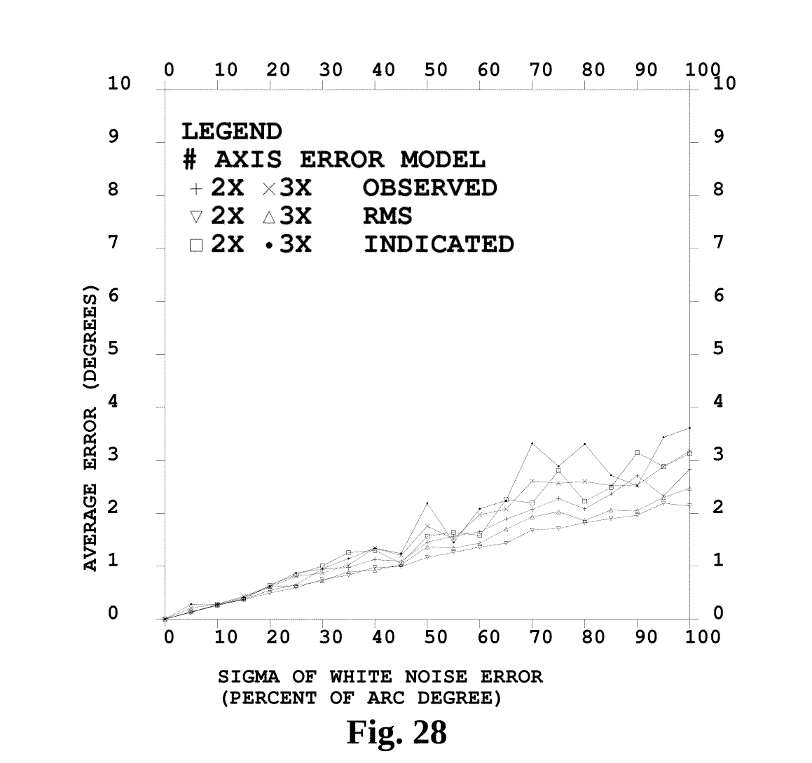

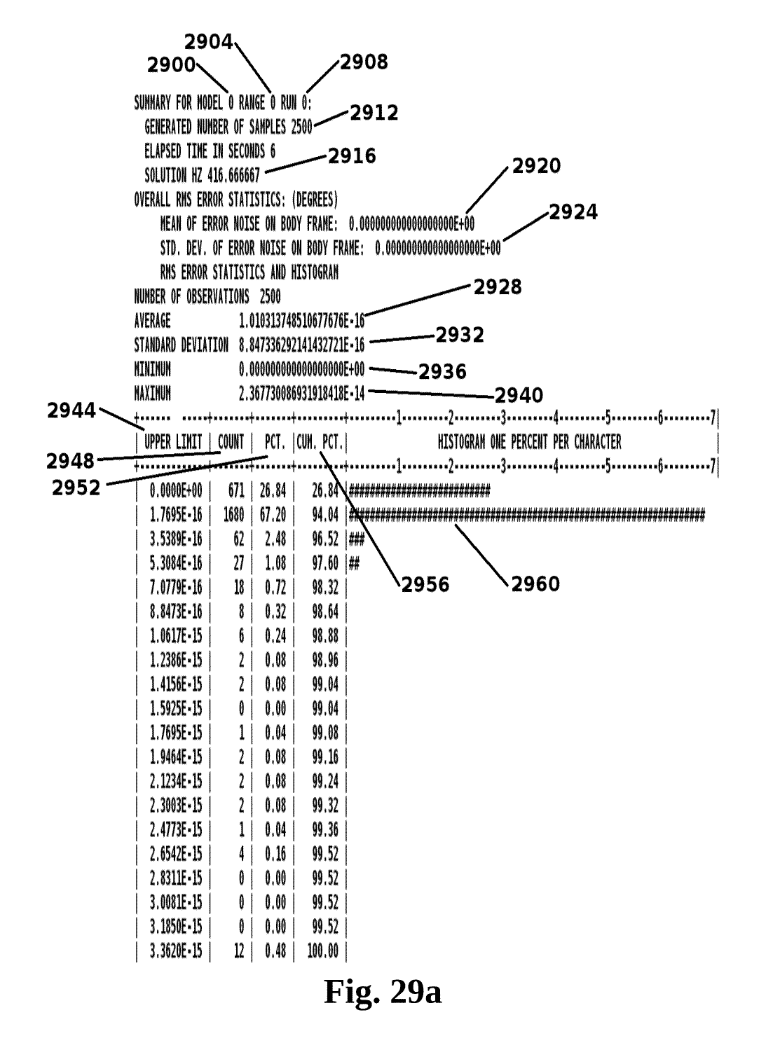

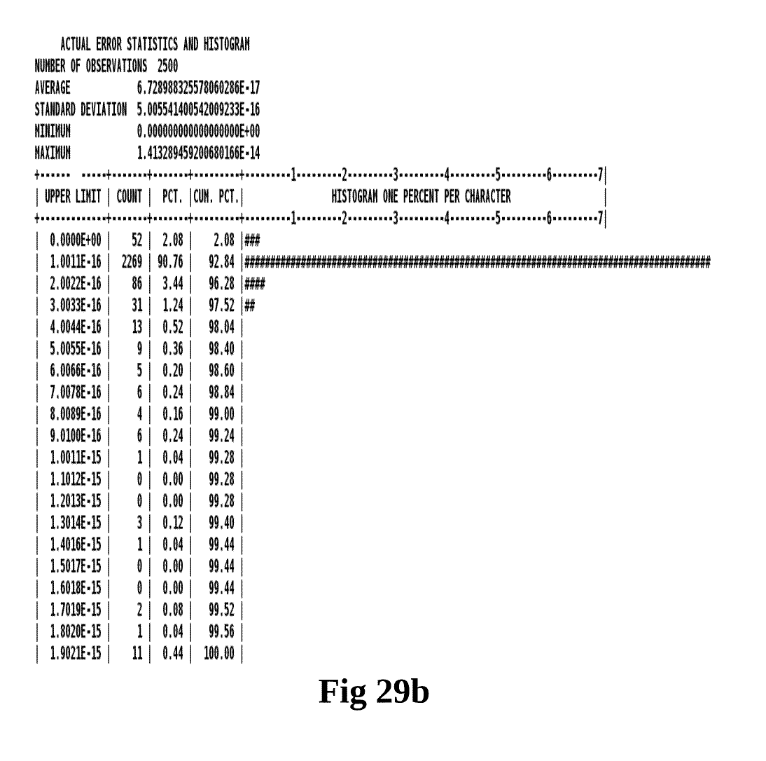

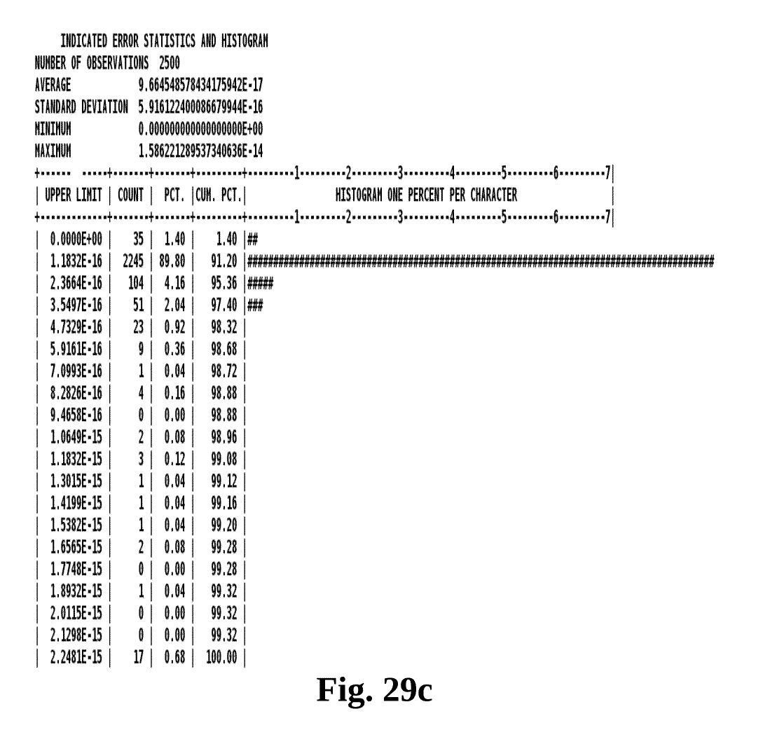

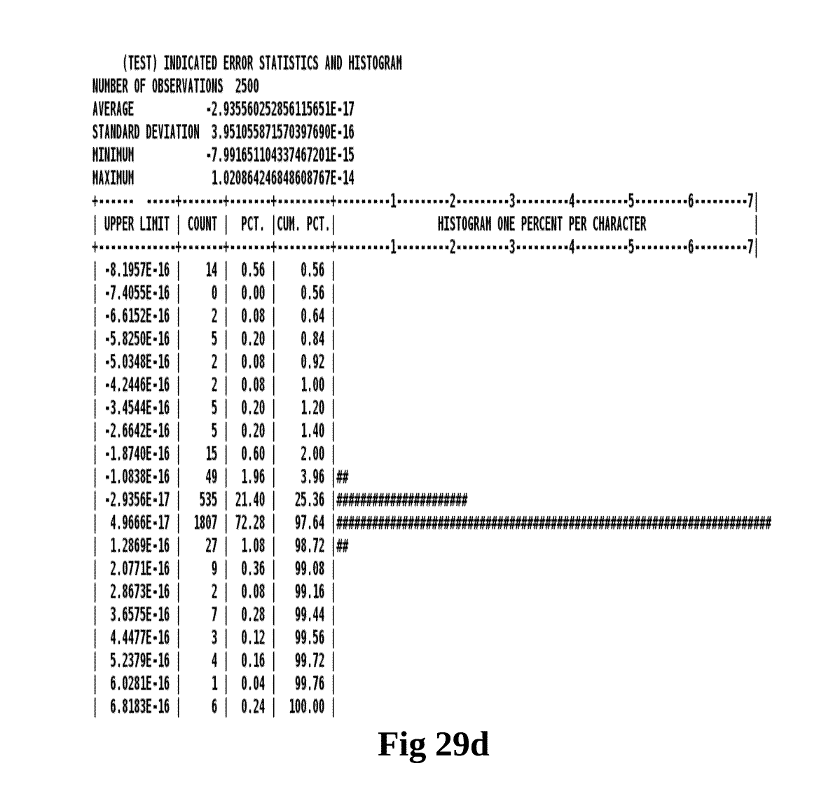

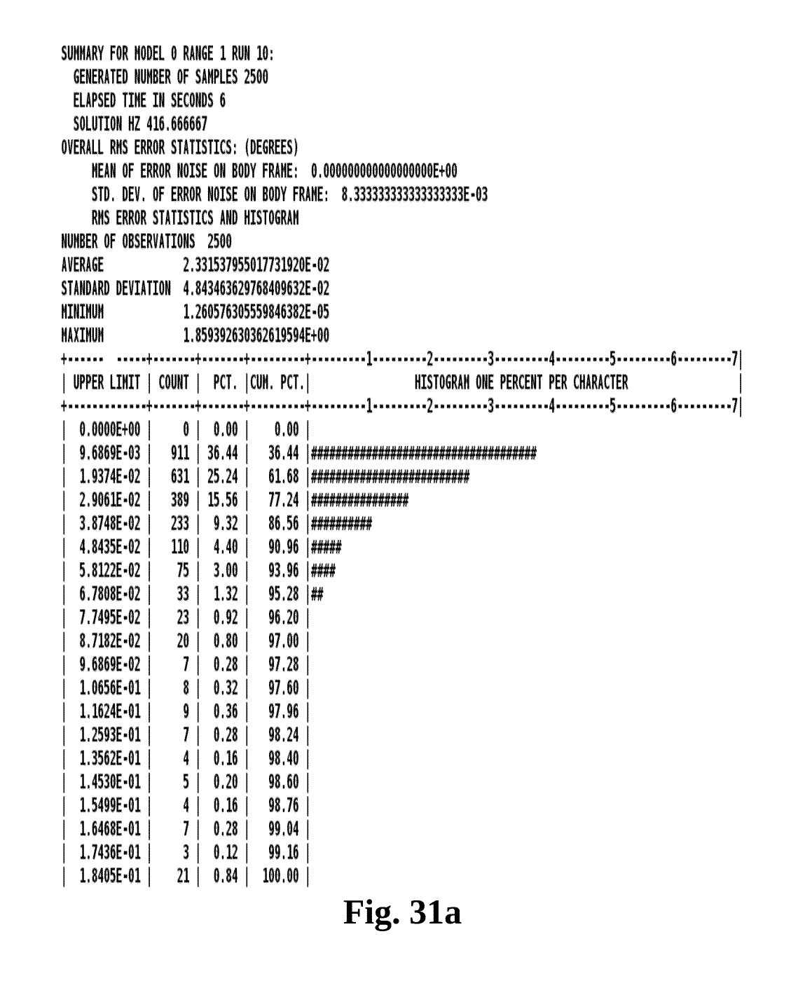

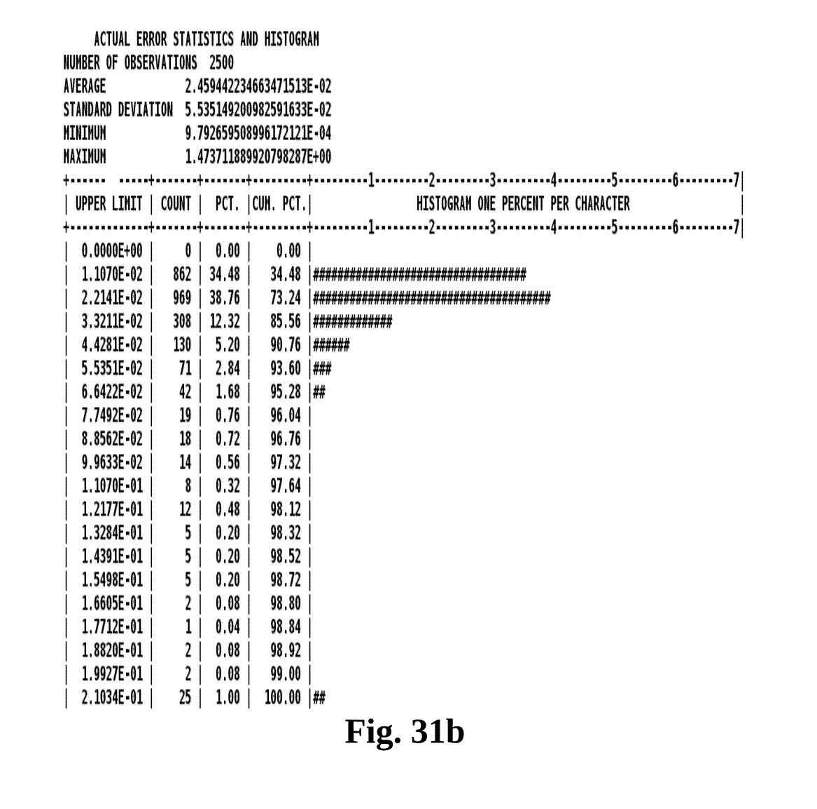

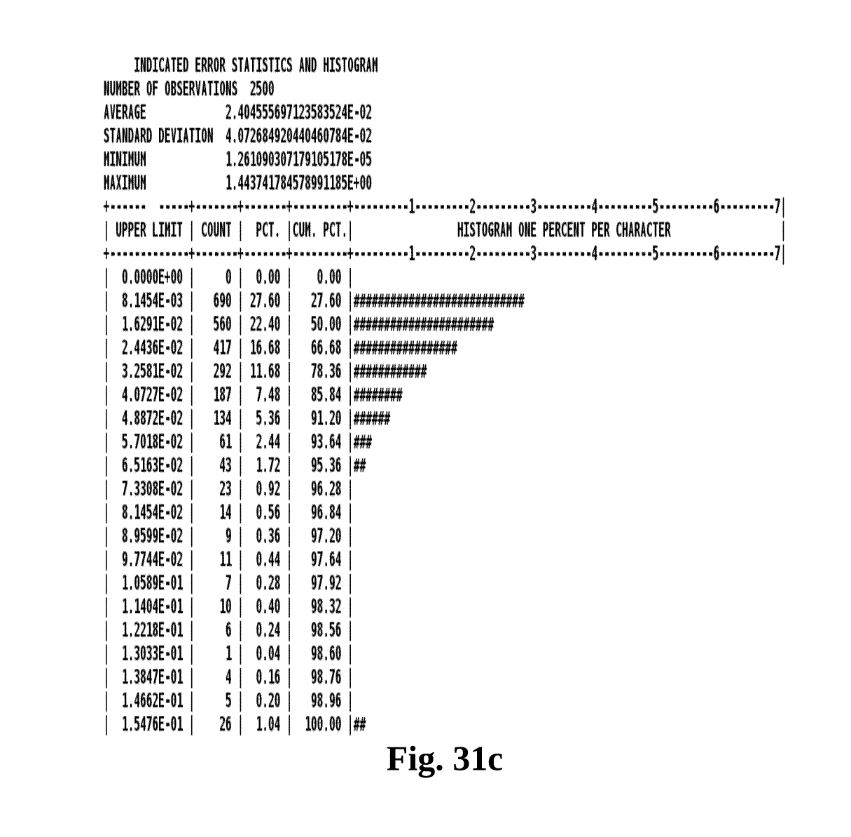

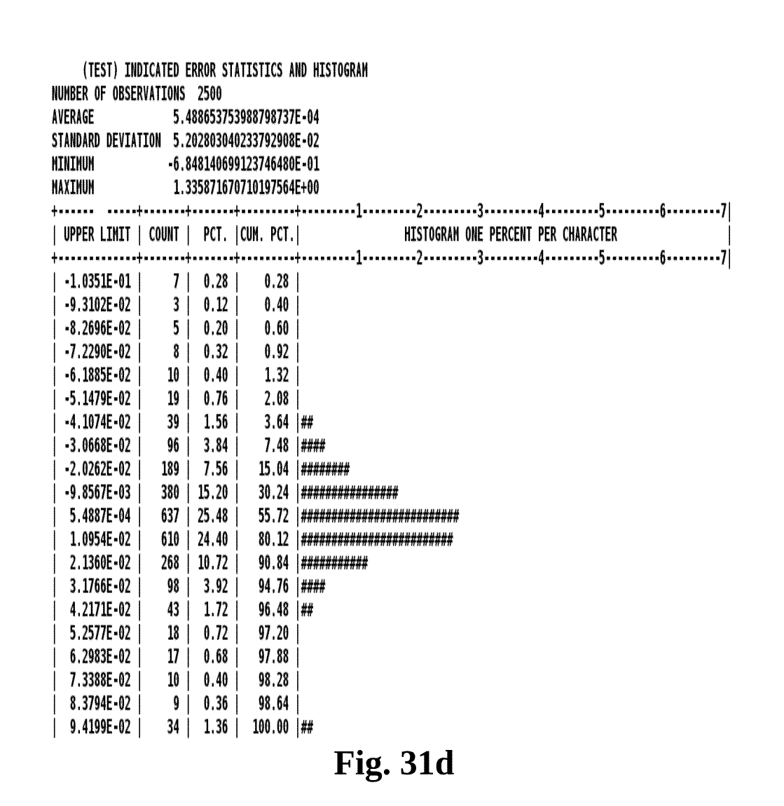

Turning to FIG. 26, the 896 error estimators correlate with the true error for both 2 and 3 axis error models. This correlation of the estimators with the true error is exhibited for higher error ranges, as shown for the arc minute range in FIG. 27, and for one degree in FIG. 28. The points plotted in FIG. 26-28 are for 2500 samples each of randomly generated problems. The standard deviation of the errors: true 2600, and the method estimators (2605 and 2610), are typically an order of magnitude greater than the mean. The distributions of errors for specific cases are shown in FIGS. 29a-31d.

Starting with FIGS. 29a-29d. The figures illustrate histograms for the results for the RMS, true, indicated_error and an test statistic that is the difference between the true error and the indicated_error, with all four histograms associated with randomly sampling orientations where no error noise is added to the reference vectors. In the histograms all angles are reported using degrees, not radians. Typical to this figure as well as the other histogram figures is a model reference 2900 where a zero is for the two axis error results and a 1 for three axis results. A range code 2904 indicates which noise level the results are for with 0 being the code for arc second, 1 for arc minute and 2 for the degree a range. A run code 2908 references which sampling interval is being reported with a code of zero being the results for the no a error case (truth), with codes 1 through 20 used to designate the twenty 5 percent intervals to sample between zero and 100 percent of the σ range, that is a run code of 10 would report the results for the 50 percent case and 5 would report for the 25 percent case. The number of observations 2812 is the number of samples for the histogram. Note that all of the simulated points illustrated in FIG. 26, 27, and 28 are all averages associated with 2500 samples. The hertz 2916 rate repoted is the average solution rate associated with the sampled observations. For each histogram the mean of the noise level 2920 is reported (they are universally zero across all figures) and the standard deviation of the σ noise level 2924. For each histogram the average of the observations 2928, standard deviation 2932, minimum 2936 and maximum 2940 observations are reported. The upper cell limit 2944 count 2848 of the number of observations per cell limit, the percentage 2952 for each cell and the cumulative percentage 2956 across all intervals are used to sort data into a graphical histogram 2960, representative of the data distribution.

Considering first the case where the results for FIG. 29a, 29b, 29c, and 29d are all for a zero a error, that is simulation results for true reference frames: FIG. 29a should in theory have 100 percent of the observations as zero for the RMS error. The histogram shows an indication of the numeric precision limit of the method. The results associated with the machine EPSILON constant indicating there are nominally 18 decimal digits in a floating point value. The average performance error of nominally 10⁻¹⁶ 2928 degrees with a maximum observed error of nominally 2.4×10⁻¹⁴ degrees 2940. From the figure the error is significantly skewed toward the small error end of the scale.

FIG. 29b is the histogram for the actual error, where the actual error is the root mean square of the difference between the Euler angles used to generate the sample and the results reported by the executive. For the truth/no error scenario the average error is less than the RMS error reported by the executive with the average nominally 6.7×10⁻¹⁷ degrees with over 95 percent of the observations less than nominally 2×10⁻¹⁶ degrees with nominally 2 percent of the solutions having a zero error discernible as a 18 decimal place long double.

For reference the histogram of the indicated_error is illustrated in FIG. 29c, the more useful histogram is shown in FIG. 29d where the relative difference between the indicated_error and the true error is considered. Attention is drawn to the fact that the standard deviation of the test statistic in FIG. 29c is approximately that of the true error (see FIG. 29b). More significant is the fact the standard deviation of the indicated_error (FIG. 29c) is approximately the same as the standard deviation for the actual error, (5.0 vs 5.9×10⁻¹⁶).

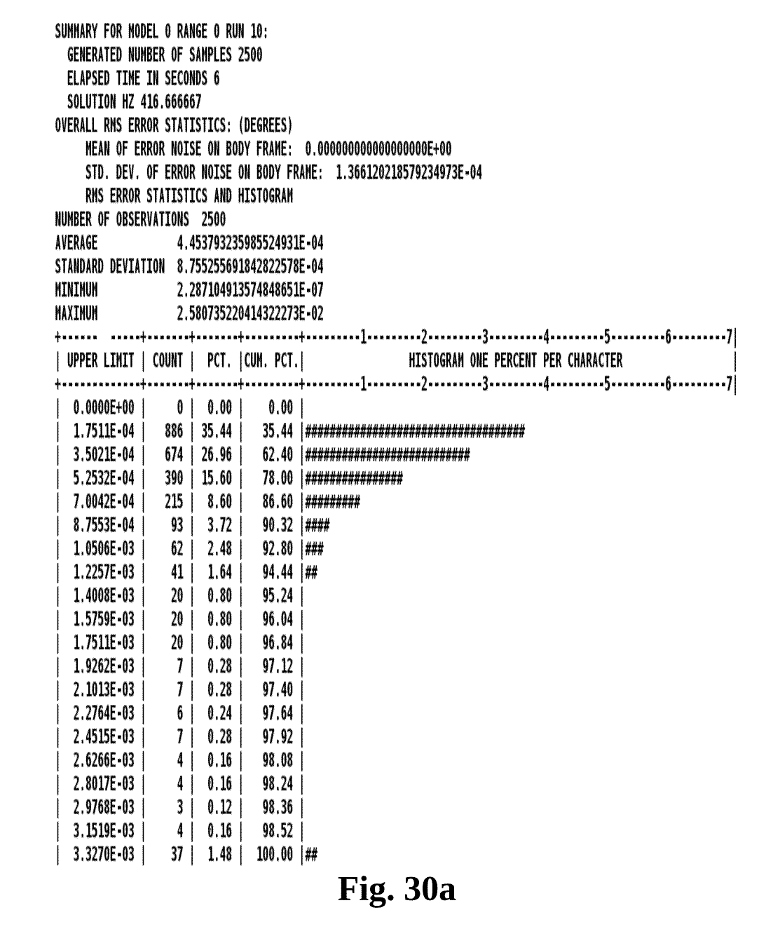

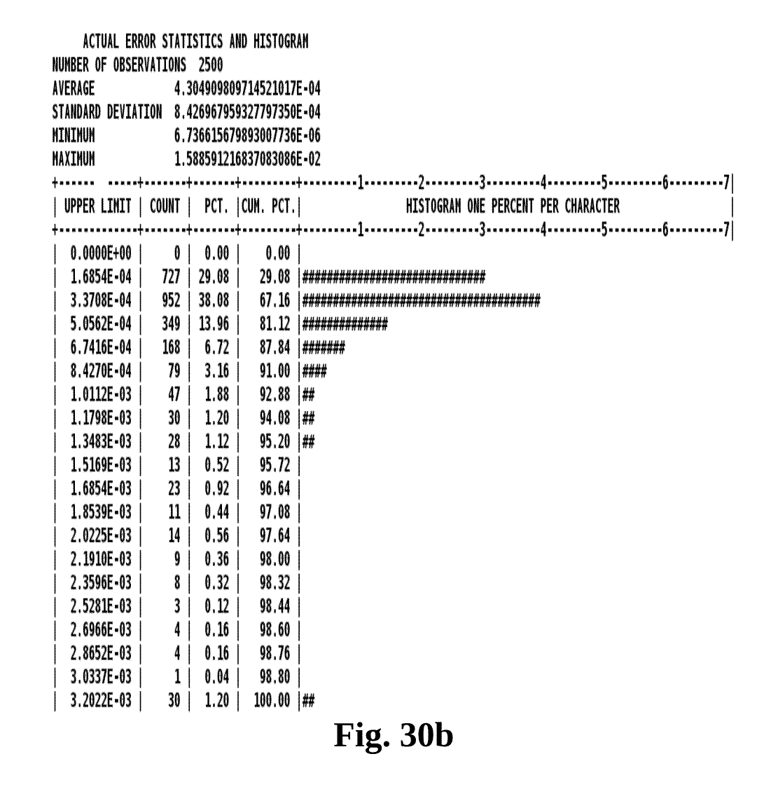

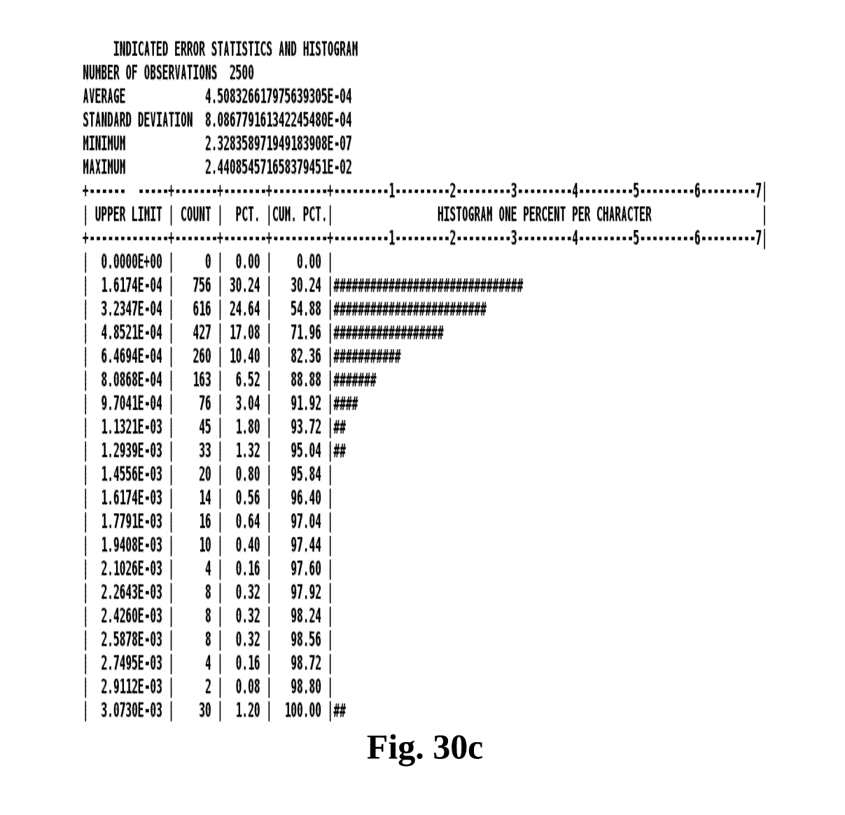

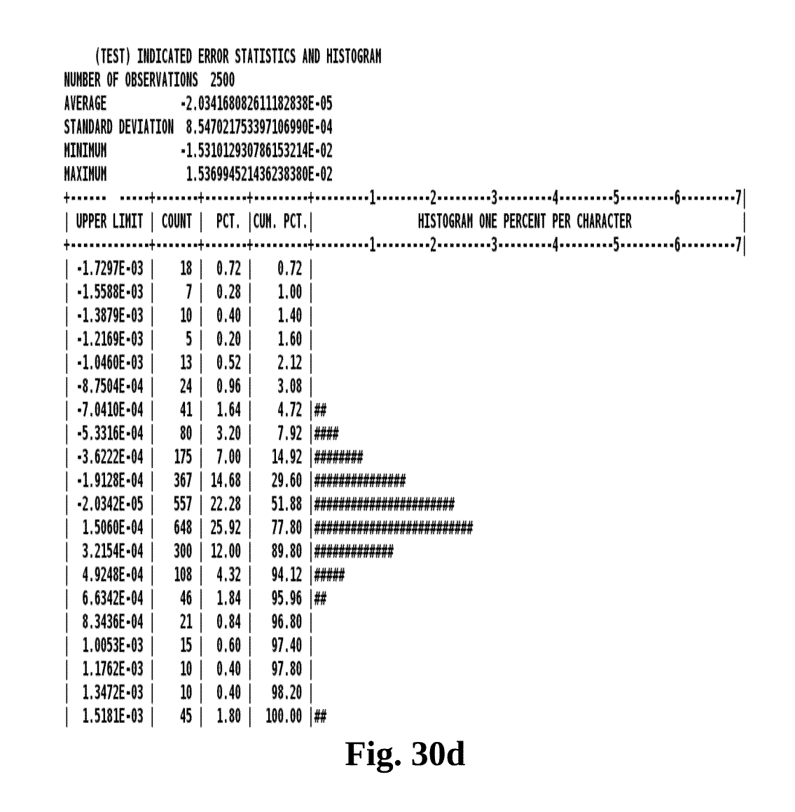

The standard deviations of both the RMS and indicated_error estimators correlate with the true error like that for the average errors plotted in FIG. 26, 27, and 28. For example, FIG. 30a, 30b, 30c and 30d are histograms for the nominally ½ arc second noise error results for the 2 axis error model. The standard deviation for all four error statistics, RMS, true, indicated_error and the true/indicated_error difference statistic are in the 8 to 9×10⁻⁴ range with the estimators correlating with the true error of nominally 8.4×10⁻⁴ with values of nominally 8.8 for the RMS and 8.1 for the indicated_error estimator. The histogram for the test statistic for the difference of the true and indicated_error shows a distribution of the observations consistent with a normally distributed random variable. This is significant as traditional statistical control methodologies can be applied using the indicated_error to detect shifts in both the average and the standard deviation. Therefore, as an attribute of the Euler angle sequence returned by the solution executive, the invention described herein provides a means for real time monitoring of the error characteristics of the sensors. As the method detects misalignment in the vector references it detects both noise errors and errors which may be caused by slew rate performance of the sensors used to develop the reference frame vector components. The RMS error computed by method 1520 (FIG. 15b) relies on the invention equations for the rotations about the reference vectors to provide an estimator of the sensor error whereas the indicated_error method 1560 (FIG. 15d) is applicable directly on the reference vectors.

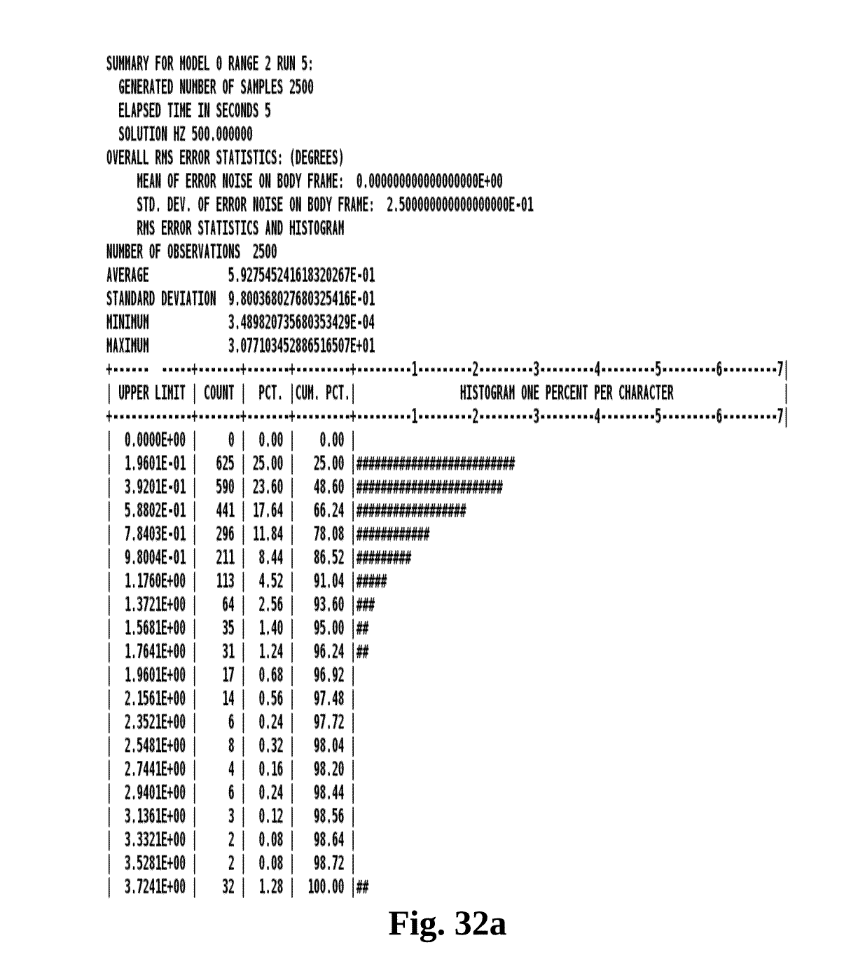

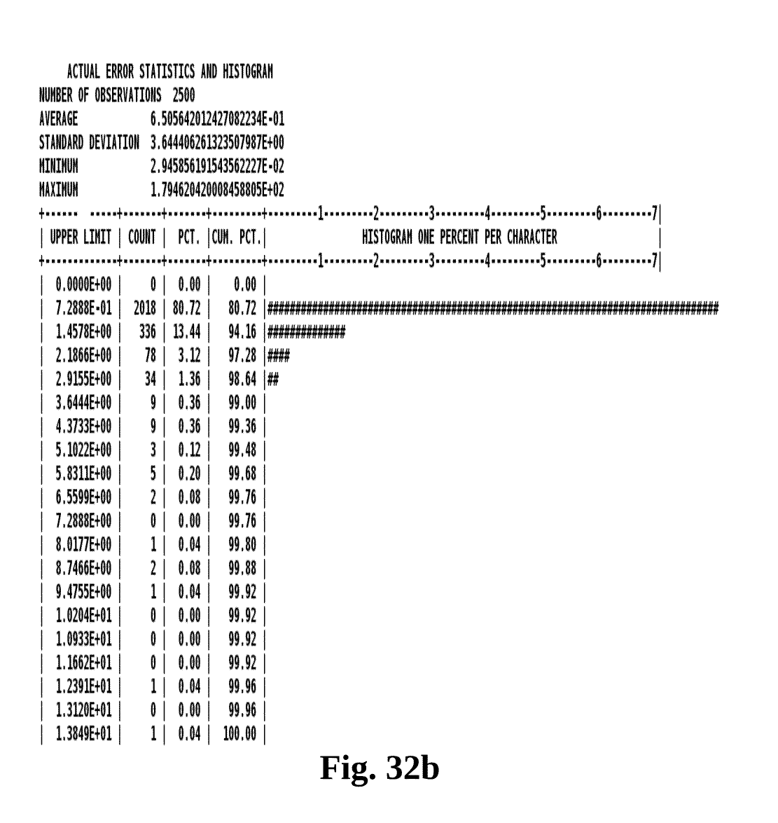

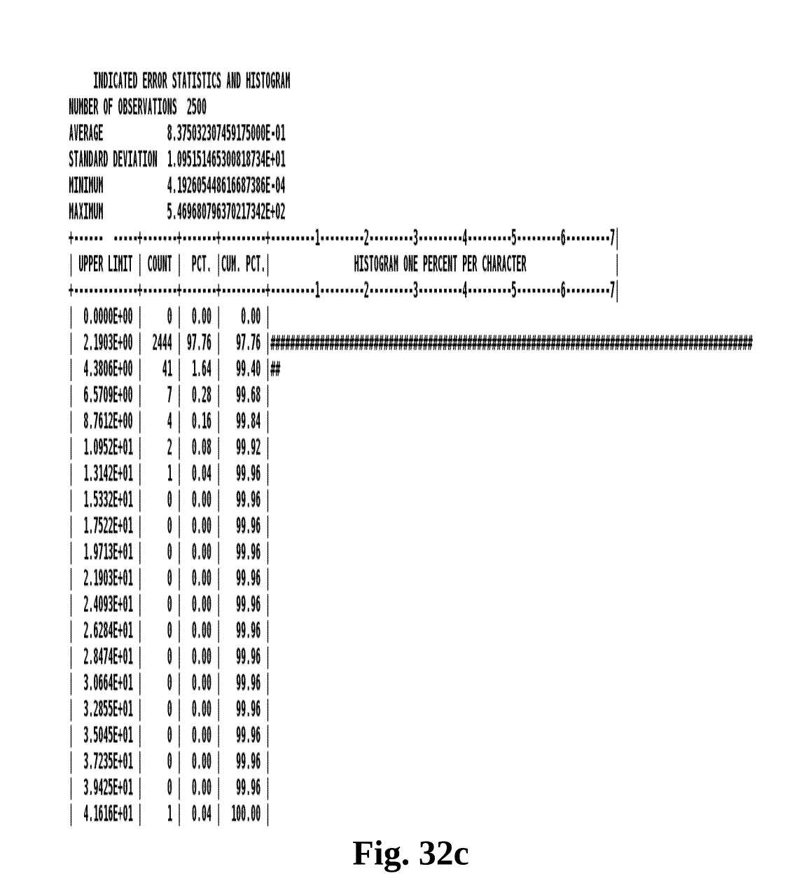

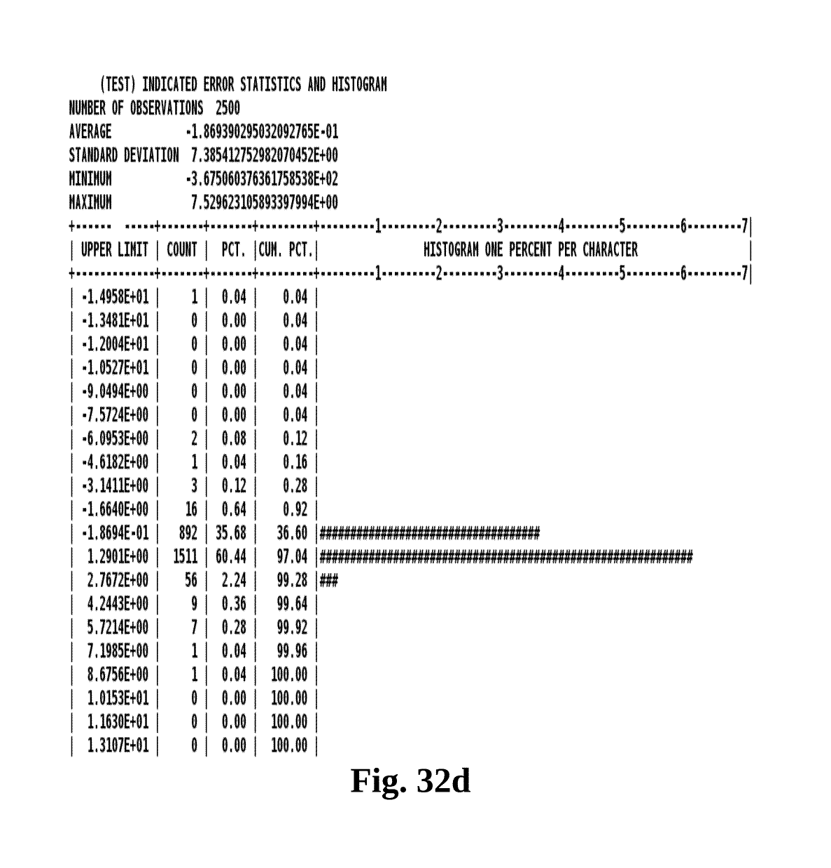

The correlation of the average and the standard deviation of the estimator values correlate linearly throughout the noise range, including up through the one degree o limit as shown in the sample histograms in FIG. 32a, 32b, 32c, and 32d for a ¼ degree a noise level.

### Hardware Considerations and Integration with Other Systems

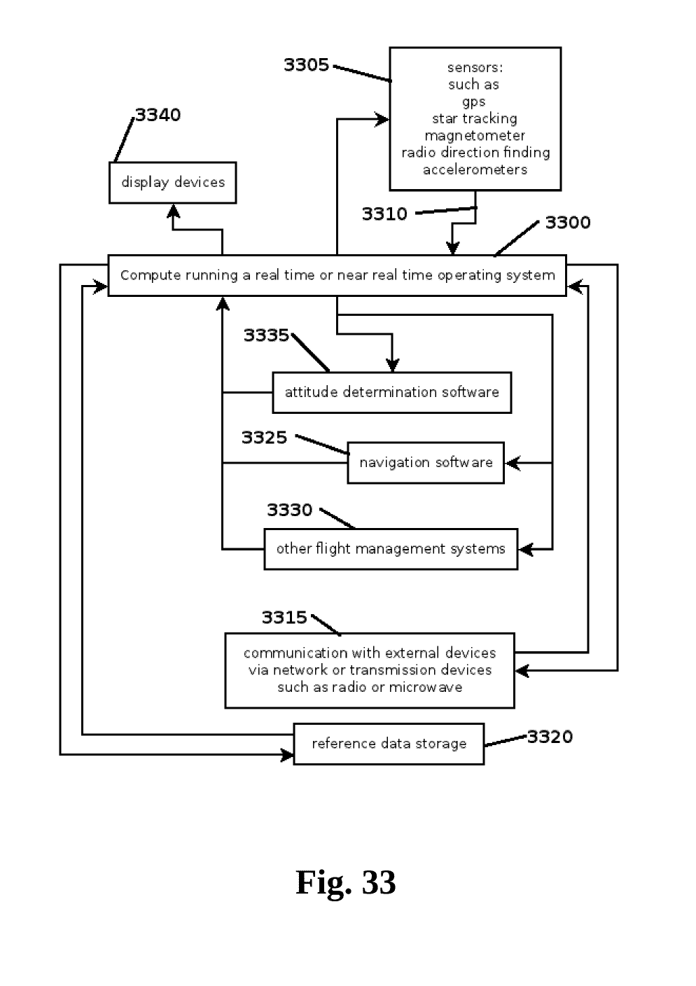

FIG. 33 is a block diagram of a real time, or near real time computing system configured for monitoring or controlling a vehicle. By real time, or near real time is understood to mean monitoring of a vehicle at a rate sufficient to act upon information processed by the computer to attain vehicle use objectives. For flight vehicles sensors typically must provide information in the hertz and ideally kilohertz frequency range and in some cases higher frequencies may be necessary to be useful.

Turning to FIG. 33, a computer 3300 running a real time or near real time operating system interacts with one or more sensors 3305 to receive sensory data inputs 3310. The computer 3300 may also interact with external communication device(s) 3315 such as transmitters to communicate with the vehicle (if the computer is remotely located), or to communicate with other systems which may include systems which transmit sensor based information to computer 3300. Furthermore the communication by computer 3300 with external systems may include receipt of flight related data including reference information which is subsequently stored in reference data storage 3320. The computer system which may or may not be located on the vehicle of interest, causes programs such as navigation software 3325 and other flight management system software 3330 to be periodically or continuously executed. It is in the context of such a system that the computer 3300 would cause the execution, periodically, or continuously of attitude determination software 3335. Furthermore, computer 3300 may as a result of execution of navigation software 3325, or other fight management software 3330, cause information resulting thereto to sent to one or more display devices 3340 where the display devices may or may not be located on the vehicle. Attitude determination from 3335 being used as inputs to the navigation software 3325 or other management software 3330 as well as inputs to systems directly or through 3325 and 3330 to autopilot systems. In displays systems an attitude determination often required for displaying attitude information in the form of roll and pitch as well as the current heading information to the pilot or vehicle operator.

In the context of this generalized hardware computer system architecture, the attitude determination software 3335 would be composed of the methods described for the instant invention. As such the computer 3300 would by external programs such as the navigation software 3325, or other systems 3330, interact with sensor(s) 3305 and/or communication devices 3315 to configure the reference vector information using internal or external reference data in storage 3320 to configure a call to said attitude software 3335 with the results in turn provided to navigation software 3325 and or other flight system software 3330 for purposes of updating a display 3340 and or communicating with other devices to report navigation information or manipulate controls on the vehicle by the interaction of computer 3300 with other hardware. The attitude software 3335 may be used as a primary or secondary attitude source where the requirement for more than one attitude source can arise from a need for backup means in the case of one system failing in total, or if one of the sources becomes unreliable from vehicle upsets which induce angular rotation rates or motion beyond the capability of mechanical or solid state gyro technologies, hereinafter saturation errors. In the case of a saturation error the attitude of the instant invention can be used as an attitude reference to re-erect the attitude reference of other flight instrumentation systems. The error measures 1520 and 1560 can be used as inputs to decision making systems to determine the relative reliability between current gyro based attitude determinations and vector based determinations from the instant invention.

It being understood in the art that the solution of a vehicle orientation can be determined with respect to multiple hardware configurations. The components of such systems being configurable using computers using real, or near real time operations systems, instrument displays including computer displays, memory devices associated with the computer system loaded with reference information for stellar object, satellites, transmitters or like sources amenable to use for determining vector references. Sensors amenable directly or by data fusion can run the gamut of GPS, star tracking, radio direction finding devices, accelerometers and magnetometers, and it is to be anticipated that future technology developments may present other sensor options for development of reference vector sources. The sensor(s) used to observe the orientation of the vehicle from either the local frame or the body frame of the vehicle can be located on either the vehicle or at a remote site.

A computer is necessary to determine the attitude in real time where the orientation state of the vehicle is to be presented in some form to a pilot or vehicle operator who may, or may not be located inside the aircraft. Furthermore, still, a computer is necessary to determine the attitude in real time if one or more other programs are used to track the navigational state of a vehicle, the inertial integration of the vehicle location requiring accurate determinations of the orientation. And, lastly a computer is necessary to in a real time manner, access reference information such as stellar object information to determine the reference vectors associated with vehicle orientation. It being understood the computing equipment may or may not be located on the vehicle.

With this hardware scope in mind the attitude determination according to the instant invention provides a means which can satisfy the real time needs for accurate vehicle orientation determination, in addition to providing a means for monitoring the error characteristics of the references used to determine the attitude. Thus the error estimators are a means for use by other flight system management functions including human based systems for surveillance of sensor functionality. The updating of flight system management functions including usage for correction of attitude sensing state for sensors such as gyros and related rate based sensors which are subject to both drift and saturation errors. As the method provides a means of determination of orientation independent of rate based sensor methods the method disclosed can provides a sole means for attitude determination in hardware configurations where there is no alternative source available for orientation determination.

The solver methods described herein teach the Newton-Raphson behavioral characteristics of the equations for the rotation of an object about a reference vector when pairs of equations are used to find a solution yaw angle and are not intended as limiting the invention to require computation of the additional solutions as either a low or high pitched solution will serve a basis for a solution.

At this point, having discussed and described the invention in detail with specific examples and statistical analysis of the inventions performance, those skilled in the art will recognize that the teachings herein are associated with a fundamentally new, novel method to provide a fast computer based solution for the re-occurring requirement of attitude determination. Accordingly, the invention should be given the broad scope of the claims attached hereto.

What is claimed is:

1. A computer implemented method for determining the attitude of a vehicle comprising the steps of: receiving input of paired reference vectors consisting of one pairing of a first local reference frame vector with a first body frame reference vector (first reference vectors) and a second local frame reference vector with a second body frame reference vector (second reference vectors); determining coefficient types D, yaw0, roll0, pitch0, K sr, yaw_low, and yaw_high coefficients from said reference vectors; determining from said coefficients whether a set of composite yaw limits common among the reference vectors exists from yaw range limitations for the first reference vectors and the second reference vectors; determining the attitude of a vehicle associated with the first reference vectors and second reference vectors by searching and identifying a yaw angle which minimizes a root mean square error among two sets of roll and pitch equations for the rotation of an object about a local reference frame vector where a composite yaw limit range exists; and determining the attitude of a vehicle associated with the first reference vectors and second reference vectors being at a yaw angle found to be associated with the minimum root mean square error among the yaw limit boundaries evaluated for both sets of roll and pitch equations for the rotation of an object about a local reference frame vector where a composite yaw limit range does not exist, and providing the corresponding Euler sequence angles associated with the minimum root mean square error to the calling program within a computer system.

2. The method of claim 1 wherein said root mean square error is provided to the calling program as a measure of misalignment associated with the reference vectors.

3. The method of claim 1 wherein an indicated_error associated with the Euler sequence angles is provided to the calling program as a measure of the misalignment associated with the reference vectors.

4. A method for determining the attitude of a vehicle comprising the steps of: receiving input of two sets of vector references; creation of a coefficients from said vector references with said coefficients being terms of equations for Euler angles associated with rotation of a vehicle about a reference vector (rotation equations); evaluation of the rotation equations for two of the three Euler angles by manipulation of the values of a first Euler angle to determine a point which minimizes the difference between the respective Euler angles relative to the differences between the vector references; and thereby determining the attitude of a vehicle.
